(19) United States
(12) Patent Application Publication
(10) Pub. No.: US 2012/0133241 A1
(43) Pub. Date: May 31, 2012

(54) SHORT-FLUX PATH MOTORS / GENERATORS

(76) Inventors: Mark T. Holtzapple, College Station, TX (US); George A. Rabroker, College Station, TX (US)

(21) Appl. No.: 13/300,394

(22) Filed: Nov. 18, 2011

Related U.S. Application Data
(63) Continuation of application No. 12/180,090, filed on Jul. 25, 2008, now abandoned.
(60) Provisional application No. 60/952,339, filed on Jul. 27, 2007.

(51) Int. Cl. H02K 1/14

(52) U.S. Cl. 310/254.1

(57) ABSTRACT

According to one embodiment of the present invention, an electric machine includes a stator and a rotor. The stator includes a stator pole including a first leg and a second leg, and a gap defined between the first and second legs. The rotor includes a rotor pole. The rotor is configured to rotate relative to the stator such that the rotor pole rotates through the gap defined between the first and second legs of the stator pole. The stator pole includes a laminar stator pole structure including multiple lamination layers.

### RELATED APPLICATION

This application claims the benefit under 35 U.S.C. §119(e) of U.S. Provisional Application No. 60/952,339, filed. Jul. 27, 2007, The contents of that application are incorporated herein in their entirety by this reference.

### TECHNICAL FIELD OF THE INVENTION

This invention relates in general to electric machines and, more particularly, to short-flux path motors/generators.

### BACKGROUND OF THE INVENTION

Electric machines using rotor/stator configurations (e.g., switched reluctance motors (SRM) and permanent magnet motors (PMM)) generally include components constructed from magnetic materials such as iron, nickel, or cobalt. In an SRM, a pair of opposing coils in the SRM may become electronically energized. The inner magnetic material is attracted to the energized coil causing an inner assembly to rotate while producing torque. Once alignment is achieved, the pair of opposing coils is de-energized and a next pair of opposing coils is energized. In a PMM, the inner assembly may include permanent magnets, which may provide both push and pull forces relative to the energized coils (as opposed to only pulling forces in an SRM).

### SUMMARY OF THE INVENTION

According to certain embodiment of the present disclosure, an electric machine includes a stator and a rotor. The stator includes a stator pole including a first leg and a second leg, and a gap defined between the first and second legs. The rotor includes a rotor pole. The rotor is configured to rotate relative to the stator such that the rotor pole rotates through the gap defined between the first and second legs of the stator pole. The stator pole includes a laminar stator pole structure including multiple lamination layers.

According to other embodiments of the present disclosure, an electric machine includes a housing, a stator having a stator pole including a first leg and a second leg, and a rotor including a rotor pole. The rotor is configured to rotate relative to the stator. At least one of the stator and the rotor is adjustably coupled to the housing to allow a distance between the stator pole and the rotor pole to be adjusted.

According to other embodiments of the present disclosure, an electric machine includes a first stator, a first rotor, a second stator, and a second rotor. The first stator has a first perimeter and a plurality of first stator poles arranged around the first perimeter, each first stator pole including a first leg and a second leg. The first rotor is configured to rotate relative to the first stator around a first axis. The second stator has a second perimeter and a plurality of second stator poles arranged around the second perimeter, each second stator pole including a first leg and a second leg. The second rotor is configured to rotate relative to the second stator around the first axis. The second stator is rotationally offset from the first stator about the first axis such that the second stator poles are offset from the first stator poles.

According to other embodiments of the present disclosure, an electric machine includes a stator and a rotor. The stator has a plurality of stator pairs arranged around a stator perimeter, each stator pair including two legs. The rotor has a plurality of rotor blades arranged around a rotor perimeter, each rotor blade including two legs. The rotor rotates relative to the stator. At least three stator pairs are energized simultaneously to generate magnetic circuits with at least three corresponding rotor blades.

According to other embodiments of the present disclosure, an electric machine includes a stator and a rotor. The stator has a plurality of stator pairs arranged around a stator perimeter, each stator pair including two legs. The rotor has a plurality of rotor blades arranged around a rotor perimeter, each rotor blade including two legs. All of the plurality of stator pairs are energized simultaneously and de-energized simultaneously, in an repeating manner, in order to cause the rotor to rotate relative to the stator.

According to other embodiments of the present disclosure, an electric machine includes a stator and a rotor. The stator includes a plurality of stator pairs, each stator pair including two legs defining a gap between the two legs. The rotor includes a plurality of rotor blades including a permanent magnet. The rotor is configured to rotate relative to the stator such that the rotor blade rotate through the gaps between the two legs of each stator pair.

According to other embodiments of the present disclosure, an electric machine includes a stator including a stator pole, a rotor including a rotor pole and configured to rotate relative to the stator, and a housing configured to house a fluid for cooling the stator. A first portion of the stator pole projects through a wall in the housing.

According to other embodiments of the present disclosure, an electric machine includes a stator having a stator pole, a rotor including a rotor pole and configured to rotate relative to the stator, and a plurality of slots formed in the stator or the rotor, the plurality of slots configured to reduce eddy currents during operation of the electric machine.

Certain embodiments of the invention may provide numerous technical advantages. For example, a technical advantage of some embodiments may include the capability to produce very high torque and power densities in motors and generators. Other technical advantages of other embodiments may include the capability to balance forces in short-flux path motor/generators to reduce cogging, vibration, and/or noise. Other technical advantages of other embodiments may include the capability to efficiently remove waste heat from electrical and magnetic circuits by evaporating or boiling a volatile fluid. Yet other technical advantages of other embodiments may include methods for laminating stators and rotors for increased magnetic flux and reduced eddy currents. Yet other technical advantages of other embodiments may include methods for increasing the area of overlap between a stator core and a rotor blade, which may increase torque for a given magnetomotive force Ni. Yet other technical advantages of other embodiments may include methods for interrelating U-shaped stators and U-shaped rotors to increase torque. Yet other technical advantages of other embodiments may include methods for adjusting the stator poles and/or rotor poles in an axial direction in order to adjust the area of overlap between the stator poles and rotor poles, which may be used to control the torque output for a given magnetomotive force Ni. Yet other technical advantages of other embodiments may include methods for configuring and controlling a permanent-magnet flat-blade rotor/U-shaped stator design. Yet other technical advantages of other embodiments may include methods for staggering stator sets to overcome noise, vibration, and/or “cogging” effects. Yet other technical advantages of other embodiments may include methods for cooling the electrical machine. Yet other technical advantages of other embodiments may include methods for penetrating a sealed housing wall with a magnetic circuit. Yet other technical advantages of other embodiments may include methods for reducing eddy currents in non-laminar metal, e.g., using slots. Yet other technical advantages of other embodiments may include methods for linking “magnetic legs” to reduce space, noise, vibration, and/or cogging effects.

Various embodiments according to the present disclosure may include none, any one, or any combination of technical advantages discussed above, and/or various other technical advantages not discussed above.

### BRIEF DESCRIPTION OF THE DRAWINGS

To provide a more complete understanding of the embodiments of the invention and features and advantages thereof, reference is made to the following description, taken in conjunction with the accompanying FIGURES, wherein like reference numerals represent like parts, in which:

FIG. 1A shows a schematic representation of an example conventional switched reluctance motor (SRM);

FIG. 1B is a dot representation of the example SRM of FIG. 1A;

FIG. 2 shows a schematic representation of a long flux path through the conventional switched reluctance motor (SRM) of FIG. 1A;

FIG. 3 shows in a chart the effect of MMF drop in the torque production of an example one-phase, one horsepower machine;

FIG. 4 shows a dot representation for an example switched reluctance motor (SRM), according to an embodiment of the invention;

FIGS. 5A and 5B illustrate an example rotor/stator configuration, according to an embodiment of the invention;

FIG. 6 shows an outer rotor assembly of an example rotor/stator configuration, according to an embodiment of the invention;

FIG. 7 shows an inner rotor assembly of an example rotor/stator configuration, according to an embodiment of the invention;

FIG. 8 shows an example stator/compressor case of an example rotor/stator configuration, according to an embodiment of the invention;

FIG. 9 shows a cutaway view of an example composite assembly of an example rotor/stator configuration, according to an embodiment of the invention; and

FIG. 10 shows the composite assembly of FIG. 9 without the cutaway;

FIG. 11 shows a side view of how a rotor can change shape when it expands due to centrifugal and thermal effects;

FIG. 12 shows an example rotor/stator configuration, according to another embodiment of the invention;

FIGS. 13A and 13B show an example rotor/stator configuration, according to another embodiment of the invention;

FIG. 14 shows an example rotor/stator configuration, according to another embodiment of the invention;

FIG. 15 shows an unaligned position, a midway position, and an aligned position;

FIG. 16 shows an energy conversion loop;

FIG. 17 shows an example rotor/stator configuration, according to another embodiment of the invention;

FIG. 18 shows an example rotor/stator configuration, according to another embodiment of the invention;

FIG. 19 shows an example rotor configuration, according to another embodiment of the invention;

FIG. 20 shows an example rotor/stator configuration, according to another embodiment of the invention;

FIGS. 21A and 21B show an example rotor/stator configuration, according to another embodiment of the invention;

FIG. 22 illustrates the formation of flux lines in an example SRM drive;

FIGS. 23 and 24 shows the placement of easily saturated materials or flux barriers under the surface of rotors;

FIG. 25 shows a chart of B-H curves for various alloys;

FIG. 26A shows a representation of a magnetic circuit in an example flat blade/U-shaped core rotor/stator configuration;

FIG. 26B shows a cross-section taken along line 26B-26B in FIG. 26A of a portion of a bundle of round wires in an example close-packed configuration;

FIG. 27 shows a relationship between magnetic field intensity and magnetic flux density for a 0.012-inch-thick M-5 grain-oriented electrical steel;

FIG. 28 show the relationship between magnetic field density and magnetic flux permeability for a 0.012-inch-thick M-5 grain-oriented electrical steel;

FIG. 29 shows that a force f is constant with respect to the fractional closure (x/b) of a flat bade relative to a U-shaped core, except for high area ratios (A_{g}^{o}/A_{c}) where the core starts to saturate;

FIG. 30 shows that the magnetic flux 4 increases linearly with the fractional closure (x/b) of a flat bade relative to a U-shaped core, except for high area ratios (A_{g}^{o}/A_{c}) when the core starts to saturate;

FIG. 31 shows that the core magnetic flux density B_{c} has a similar pattern as the magnetic flux φ relative to the fractional closure (x/b) of a flat bade relative to a U-shaped core;

FIG. 32 shows that the gap magnetic flux density B_{g} (which is the same as the blade magnetic flux density B_{b}) is nearly constant for each area ratio A_{g}^{o}/A_{c} and fractional closure (x/b) of a flat bade relative to a U-shaped core, except when the core starts to saturate at high area ratios;

FIG. 33 shows a representation of an alternative geometry of a rotor/stator configuration in which a U-shaped rotor blade slides past a U-shaped stator core;

FIG. 34 shows a representation of another alternative geometry of a rotor/stator configuration, which is representative of a rotor moving relative to a pair of opposite stator poles in a conventional switched reluctance motor;

FIGS. 35A and 35B illustrate examples of how the linear motion shown in FIGS. 26A and 33 can be converted to rotary motion;

FIGS. 36A and 36B show that the U-shaped stators in the configurations shown in FIGS. 26A and 33 may be similar, but rotated by 90 degrees relative to each other;

FIGS. 37A and 37B show an example orientation of lamination layers for a U-shaped blade/U-shaped core configuration and a flat blade /U-shaped core configuration, respectively, according to certain embodiments;

FIG. 38 shows an example orientation of lamination layers for a stator pair and a flat blade in a flat blade /U-shaped core rotor/stator configuration, according to certain embodiments;

FIG. 39 shows an example method of making a laminar stator by wrapping the laminations around a mandrel, according to certain embodiments;

FIG. 40A shows an example technique for cutting a laminar structure at a non-right angle to for a U-shaped stator having an area ratio A_{g}^{o}/A_{c}>1, according to certain embodiments;

FIGS. 40B and 40C show adjustment of a U-shaped stator in an axial direction relative to a flat blade in order to adjust the gap area A_{g} between the stator legs and the flat blade, which adjusts the torque generated for a given Ni, according to certain embodiments;

FIGS. 41A and 41B show various housing aspect ratios L/r ranging from 1.0 to 4.0, which are used in the subsequent analysis of various rotor/stator configurations;

FIG. 42 shows a rotation of a 6/4 (6 stators, 4 rotors) conventional switched reluctance motor;

FIG. 43 shows an example stator firing sequence for the conventional 6/4 switched reluctance motor of FIG. 42;

FIG. 44 shows a rotation of a 12/10 (12 stators, 10 rotors) conventional switched reluctance motor;

FIG. 45 shows an example stator firing sequence for the conventional 12/10 switched reluctance motor of FIG. 44;

FIG. 46 shows the stator width for a 6/4 switched reluctance motor;

FIG. 47 shows a “unit cell” for a stator pair of a conventional switched reluctance motor;

FIG. 48 shows the rotation of an example U-shaped blade/U-shaped core rotor/stator configuration with six stator pairs and four blades, according to certain embodiments;

FIG. 49 shows an example stator firing sequence for the example U-shaped blade/U-shaped core rotor/stator configuration of FIG. 48, according to certain embodiments;

FIG. 50 shows that the stator width c is

$$c = \frac{2 π r}{24}$$

in the U-shaped blade/U-shaped core configuration of FIG. 48;

FIG. 51 shows a “unit cell” for a first U-shaped stator pair for use in a U-shaped blade/U-shaped core rotor/stator configuration, and a second U-shaped stator pair offset from the first U-shaped stator pair, according to certain embodiments;

FIG. 52 shows the rotation of an example U-shaped blade/U-shaped core rotor/stator configuration including double the number of rotor blades and stator pairs as FIG. 48, according to certain embodiments;

FIG. 53 shows an example stator firing sequence for the example U-shaped blade/U-shaped core rotor/stator configuration of FIG. 52, according to certain embodiments;

FIG. 54 shows an example U-shaped blade/U-shaped core rotor/stator configuration having an equal number of rotor blades and stator poles (12/12), and where all stator poles may be energized/de-energized simultaneously, according to certain embodiments;

FIG. 55 shows an example stator firing sequence for the example U-shaped blade/U-shaped core rotor/stator configuration of FIG. 54, according to certain embodiments;

FIG. 56 shows how the stator poles of a U-shaped blade/U-shaped core rotor/stator configuration having an equal number of rotor blades and stator poles (16/16) can all be energized at the same time, according to certain embodiments;

FIG. 57 shows the rotation of an example flat blade/U-shaped core rotor/stator configuration in a 6/4 configuration, according to certain embodiments;

FIG. 58 shows an example stator firing sequence for the example 6/4 flat blade/U-shaped core rotor/stator configuration of FIG. 57, according to certain embodiments;

FIG. 59 shows the rotation of an example flat blade/U-shaped core rotor/stator configuration in a 12/8 configuration, according to certain embodiments;

FIG. 60 shows an example stator firing sequence for the example 12/8 flat blade/U-shaped core rotor/stator configuration of FIG. 58, according to certain embodiments;

FIGS. 61A, 61B, and 61C show that for certain embodiments of a flat blade/U-shaped core rotor/stator configuration, the stator width b is

$$b = \frac{2 π r}{8}$$

with a denominator of 8 for the 6/4 configuration, 16 for a 12/8 configuration, and 32 for a 24/16 configuration;

FIG. 62A shows a “unit cell” for a U-shaped stator pair for use in a flat blade/U-shaped core rotor/stator configuration, along with a second U-shaped stator pair of an adjacent set of stators, showing how a wire bundle can be wrapped around the legs of adjacent stator pairs to form a “magnetic leg,” according to certain embodiments;

FIG. 62B shows mechanically coupling unit cells together to create a series of “magnetic legs” that have a common core with the magnetic flux flowing in the same direction, according to certain embodiments;

FIG. 63A shows a “unit cell” for a U-shaped stator pair for use in a flat blade/U-shaped core rotor/stator configuration, which is similar to FIG. 62A, except the width of the core body is narrowed from b to b*, according to certain embodiments;

FIG. 63B shows an unfolded view of the unit cell of FIG. 63A, according to certain embodiments;

FIG. 64 shows the rotation of an example permanent-magnetic flat-blade motor including permanent magnet flat blades on the rotor, according to certain embodiments;

FIG. 65 shows an example stator energizing sequence for the flat-blade permanent magnet motor of FIG. 64, according to certain embodiments;

FIG. 66 shows an example system and method for cooling stators that pierce a housing wall of a cooling system housing, according to certain embodiments;

FIG. 67 shows a configuration of a stator pole including a non-laminar portion provided for piercing a housing wall of a cooling system, in order to resist leakage through the housing wall, according to certain embodiments;

FIG. 68 shows details of a non-laminar portion of a stator pole (e.g., as used in the configuration of FIG. 67), including slots configured to align with lamination layers of a laminar portion of the stator pole, according to certain embodiments; and

FIG. 69 shows details of a non-laminar leg portions of a U-shaped stator pole (e.g., as used in the configuration of FIG. 67), including slots configured to align with both (a) lamination layers of a laminar portion of the stator pole and (b) lamination layers or slots of a flat rotor blade configured to pass between the U-shaped stator leg portions; according to certain embodiments;

### DETAILED DESCRIPTION OF EXAMPLE EMBODIMENTS

It should be understood at the outset that although example implementations of embodiments of the invention are illustrated below, embodiments of the present invention may be implemented using any number of techniques, whether currently known or in existence. The present invention should in no way be limited to the example implementations, drawings, and techniques illustrated below. Additionally, the drawings are not necessarily drawn to scale.

Various electric machines such as motors and generators and type variations associated with such motors and generators may benefit from one or more of the embodiments described herein. Example type variations include, but are not limited to, switched reluctance motors (SRM), permanent magnet AC motors, brushless DC (BLDC) motors, switched reluctance generators (SRG), permanent magnet AC generators, and brushless dc generators (BLDCG). Although particular embodiments are described with reference to one or more type variations of motor and/or generators, it should be expressly understood that such embodiments may be utilized with other type variations of motors or generators. Accordingly, the description provided with certain embodiments described herein are intended only as illustrating examples type variations that may avail benefits of embodiments of the invention. For example, teachings of some embodiment of the invention increase the torque, power densities, and efficiency of electric motors, particularly switched reluctance motors (SRM) and permanent magnet AC motors (PMM). Such embodiments may also be used with brushless DC (BLDC) motors, for example. Some of same advantages described with reference to these embodiments may be realized by switched reluctance generators (SRG), permanent magnet AC generators, and brushless dc generators (BLDCG).

In conventional radial and axial SRMs, the magnetic flux flows through a long path through the whole body of a stator and rotor. Due to the saturation of iron, conventional. SRMs have a large drop in the magneto motive force (MMF) because the flux path is so large. One way to reduce the loss of MMF is to design thicker stators and rotors, which reduces the flux density. However, this approach increases the weight, cost, and size of the machine. Accordingly, teachings of embodiment of the invention recognize that a more desirable approach to reduce these losses is to minimize the flux path, which is a function of geometry and type of machine.

Teachings of some embodiments additionally introduce a new family of stator/pole interactions and configurations for SRMs and PMMs. In this family, stator poles have been changed from a conventional cylindrical shape to U-shaped pole pairs. This configuration allows for a shorter magnetic flux path, which in particular embodiments may improve the efficiency, torque, and power density of the machine.

To take full advantage of the isolated rotor/stator structures of this invention, sensorless SRM, PMM, and BLDC control methods may be utilized, according to particular embodiments.

The switched reluctance motor (SRM) has salient poles on both the stator and rotor. It has concentrated windings on the stator and no winding on the rotor. This structure is inexpensive and rugged, which helps SRMs to operate with high efficiency over a wide speed range. Further, its converter is fault tolerant. SRMs can operate very well in harsh environments, so they can be integrated with mechanical machines (e.g., compressors, expanders, engines, and pumps). However, due to the switching nature of their operation, SRMs need power switches and controllers. The recent availability of inexpensive power semiconductors and digital controllers has allowed SRMs to become a serious competitor to conventional electric drives.

There are several SRM configurations depending on the number and size of the rotor and stator poles. Also, as with conventional electric machines, SRMs can be built as linear-, rotary-, and axial-flux machines. In these configurations, the flux flows 180 electrical degrees through the iron. Due to saturation of iron, this long path can produce a large drop in MMF, which decreases torque density, power, and efficiency of the machines. Increasing the size of the stator and rotor back iron can avoid this MMF drop, but unfortunately, it increases the motor size, weight, and cost. Using bipolar excitation of phases can shorten the flux path, but they need a complex converter. Also, they are not applicable when there is no overlapping in conduction of phases.

In addition, many of the issues discussed above regarding switched reluctance motor (SRM) apply also to permanent magnet motors (PMM).

FIG. 1A shows a schematic representation of a conventional switched reluctance motor (SRM) 100. The SRM 100 of FIG. 1A includes a stator 110 and a rotor 140. The stator 110 includes eight stationary stator poles 120 (each with its own inductor coil 120) and the inner rotor 140 includes six rotating rotor poles 150 (no coils). The components of the SRM 100 are typically constructed from magnetic materials such as iron, nickel, or cobalt. In particular configurations, the materials of the SRM 100 can be laminar to reduce the effect of eddy currents. At any one time, a pair of opposing coils 130 is energized electrically. The inner magnetic material in the rotor poles 150 of the rotor 140 are attracted to the energized coil 130 causing the entire inner rotor 140 to rotate while producing torque. Once alignment is achieved, the pair of opposing coils 130 is de-energized and the next pair of opposing coils 130 is energized. This sequential firing of coils 130 causes the rotor 140 to rotate while producing torque. An illustration is provided with reference to FIG. 1B.

FIG. 1B is a dot representation of the SRM 100 of FIG. 1A. The white circles represent the stator poles 120 and the black circles represent the rotor poles 150. Stator poles 120A, 120B are currently aligned with rotor poles 150A, 150B. Accordingly, the coils associated with this alignment (coils associated with stator poles 120A, 120B) can be de-energized and another set of coils can be fired. For example, if the coils associated with the stator poles 120C and 120D are fired, rotor poles 150C, 150D will be attracted, rotating the rotor 140 counter-clockwise. The SRM 100 of FIG. 1 has inherent two-fold symmetry.

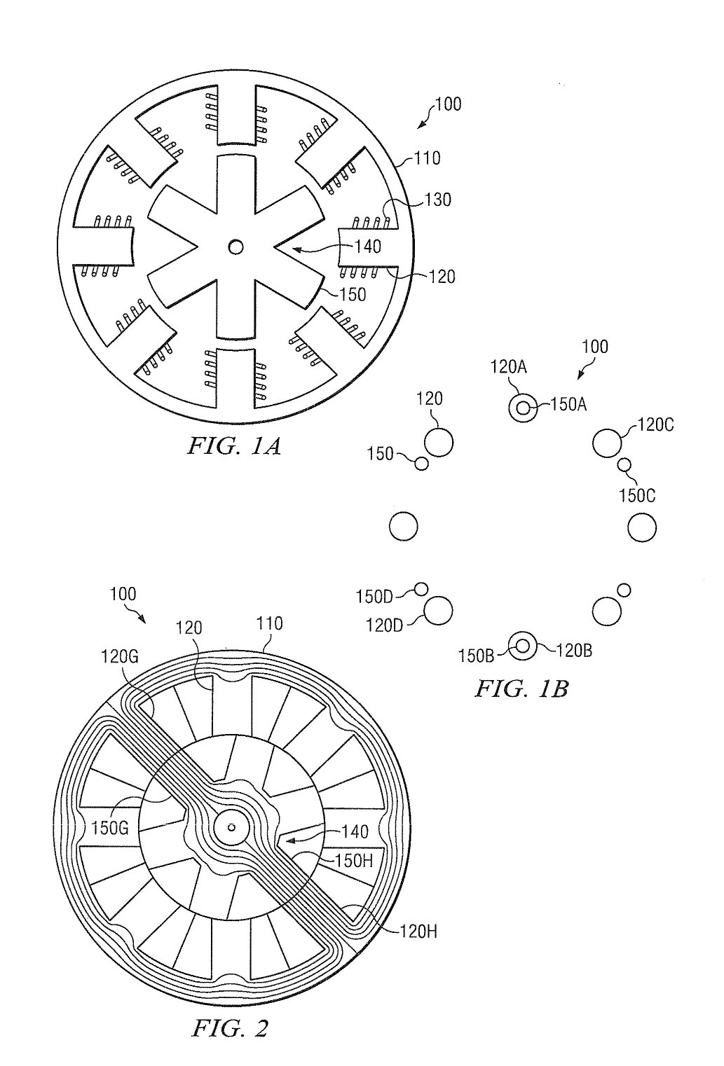

FIG. 2 shows a schematic representation of a long flux path through the conventional switched reluctance motor (SRM) 100 of FIG. 1A. In the SRM 100, magnetic fluxes must traverse 180 degree through both the stator 110 and the rotor 140—for example, through stator pole 120G, rotor pole 150G, rotor pole 150H, stator pole 120H, and inner rotor 140, itself. Such long flux paths can lead to the creation of undesirably eddies, which dissipate energy as heat. Additionally, due to the high flux density, the magneto motive force (MMF) drop will be very high, particularly if the stator 110 and rotor 140 back iron are thin.

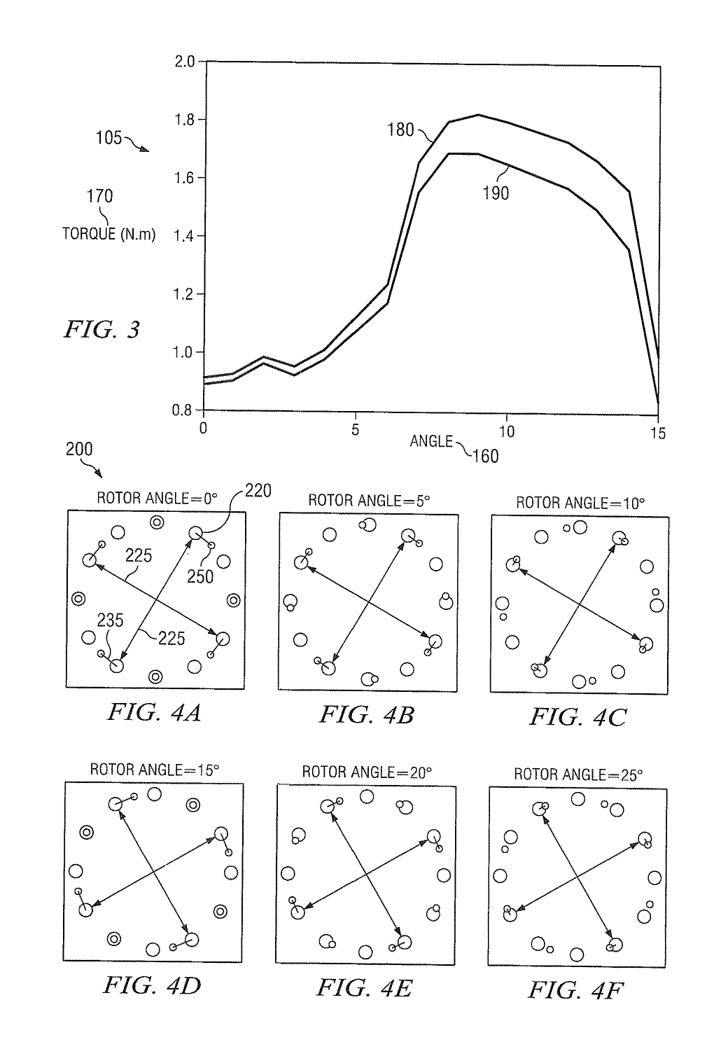

As an example of MMF drop, FIG. 3 shows in a chart 105 the effect of MMF drop in the torque production of a one-phase, one horsepower machine. In FIG. 3, output torque 170 is plotted against rotor angle 160. Line 180 show torque without the effect of saturation in the rotor 140 and stator 110 back iron and line 190 shows torque with the effect of saturation in rotor 140 and stator 110 back iron. As can be seen, the MMF drop in torque production can be more than 6%. Accordingly, teachings of some embodiments reduce the length of the flux path. Further details of such embodiments will be described in greater detail below.

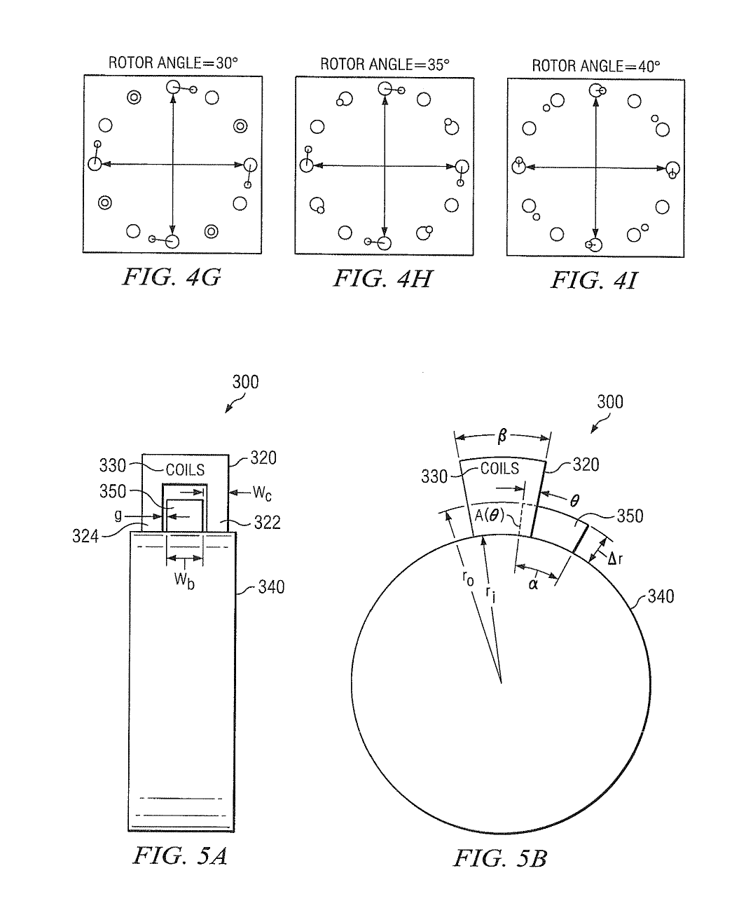

FIG. 4 shows a dot representation for a switched reluctance motor (SRM) 200, according to an embodiment of the invention. The SRM 200 of FIG. 4 may operate in a similar manner to the SRM described with reference to FIG. 1B. However, whereas the SRM 100 of FIG. 1B fire two coils associated with two stator pole 120 at a time, the SRM of FIG. 4 fires four coils associated with four stator poles 220 at a time. The increased firing of such coils/stator poles 220 increases the torque.

The SRM 200 of FIG. 4 has a rotor with eight rotor poles 250 and a stator with twelve stator poles 220. The active magnetized sets of stator poles 220 are denoted by arrowed lines 225 and the attractive forces through the flux linkages (e.g., between a rotor pole 250 and stator pole 220) are shown by the shorter lines 235 through a counterclockwise progression of 40° of rotor rotation. At 45°, the configuration would appear identical to the 0° configuration. As can be seen with reference to these various rotor angles, as soon as a alignment between four stator poles 220 and four rotor poles 250 occur, four different stator poles 220 are fired to attract the rotor poles 250 to the four different stator poles 220.

The switched reluctance motor 200 in FIG. 4 has four-fold symmetry. That is, at any one time, four stator poles 220 (the sets denoted by arrowed lines 225) are energized, which as referenced above, is twice as many as a conventional switched reluctance motor (e.g., SRM 100 of FIG. 1). Because twice as many stator poles 220 are energized, the torque is doubled.

In particular embodiments, adding more symmetry will further increase torque. For example, six-fold symmetry would increase the torque by three times compared to a conventional switched reluctance motor. In particular embodiments, increased symmetry may be achieved by making the rotor as blade-like projections that rotate within a U-shaped stator, for example, as described below with reference to the embodiments of FIGS. 5A and 5B. In other embodiments, increased symmetry may be achieved in other manners as described in more details below.

As used herein, the term “U-shaped” may refer to any shape defining a pair of legs or elongated portions, or any curved or non-linear shape defining a pair or ends generally extending in the same direction, including, for example, generally U-shaped, V-shaped, or C-shaped, or multi-pronged. “U-shaped” may also be referred to as “C-shaped” or “V-shaped.”

FIGS. 5A and 5B illustrate a rotor/stator configuration 300, according to an embodiment of the invention. For purposes of illustration, the embodiment of the rotor/stator configuration 300 of FIGS. 5A and 5B will be described as a switched reluctance motor (SRM). However, as briefly referenced above, in particular embodiments, the rotor/state configuration 300 may be utilized as other types of motors. And, in other embodiments, the rotor/state configuration 300 may be utilized in other types of electric machines such as generators.

In the rotor/state configuration 300 of FIGS. 5A and 5B, a blade-like rotor pole or blade 350, affixed to a rotating body 340, is shown passing through a U-shaped electromagnet core or U-shaped stator pole 320. In this configuration, the flux path is relatively short, compared to conventional SRMs. For example, the magnetic flux produced by a coil 330 fired on the U-shaped pole 320 would pass through one leg 322 of the U-shaped stator pole 320 through the blade 350 and to the other leg 324 of the U-shaped stator pole 320 in a circular-like path. In particular embodiments, this short path—in addition to diminishing the long path deficiencies described above—enables increased symmetry because the path does not traverse the center of the rotating body 340 and has little effect, if any, on other flux paths. Additionally, in particular embodiments, the short path enables use of the center of the rotating body 340 for other purposes. Further details of such embodiments will be described below. Furthermore, radial loads are applied to the rotor with this embodiment and axial loads on the rotor are balanced. Additionally, extra radius is afforded by the blade 350, thus increasing generated torque.

In particular embodiments, a rotor/stator configuration (e.g., the rotor/stator configuration 300 of FIGS. 5A and 5B) can be integrated with other features such as a gerotor compressor/expander and other embodiments described in the following United. States Patents and Patent Application Publications: Publication No. 2003/0228237; Publication No. 2003/0215345; Publication No. 2003/0106301; U.S. Pat. No. 6,336,317; and U.S. Pat. No. 6,530,211.

### Design Case Implementation

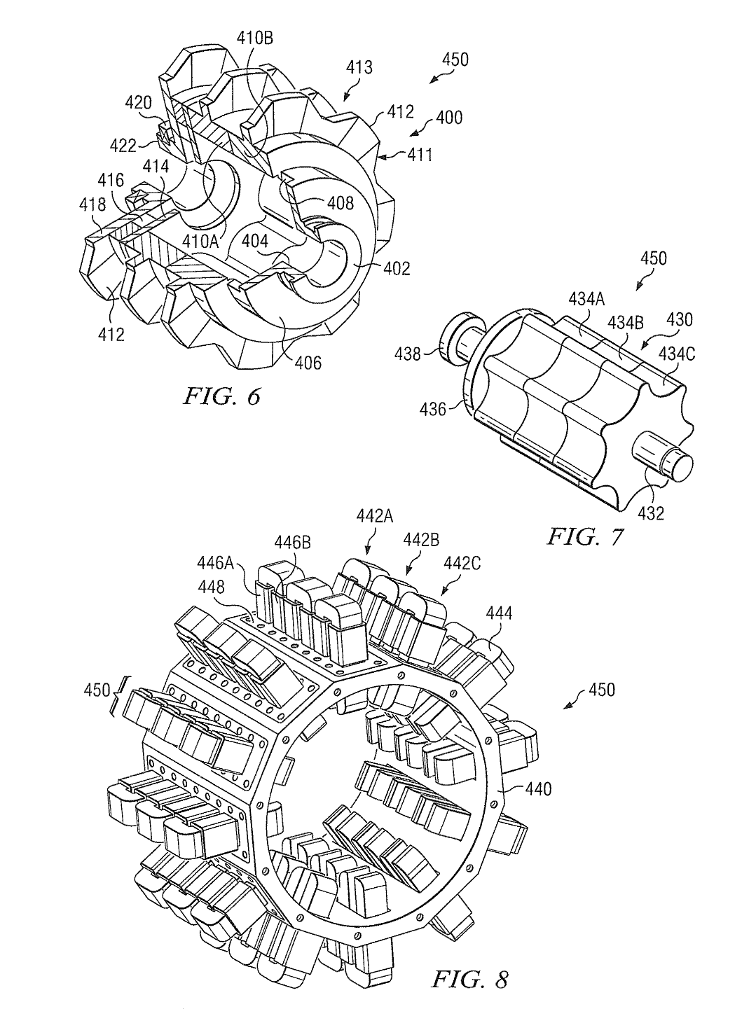

FIGS. 6-10 illustrate a rotor/stator configuration 450, according to an embodiment of the invention. The rotor/stator configuration 450 of FIGS. 6-10 is used with a compressor. However, as briefly referenced above, in particular embodiments, the rotor/stator configuration 450 may be utilized as other types of motors and other types of electric machines such as generators. The rotor/state configuration 450 of FIGS. 6-10 includes three stacked arrays of twelve stator poles 444 and eight rotor blades 412. The rotor/stator configuration 450 for the compressor in FIGS. 6-10 may operate in a similar manner to the rotor/state configuration 300 described above with reference to FIGS. 5A and 5B. FIG. 6 shows an outer rotor assembly 400 of the rotor/stator configuration 450, according to an embodiment of the invention. The outer rotor assembly 400 in FIG. 6 includes a bearing cap 402, a bearing sleeve 404, a port plate 406, inlet/outlet ports 408, two rotor segments 410A/410B with rotor blades 412 mounted, a seal plate 414 to separate the dry compression region from the lubricated gear cavity, a representation of the outer gear 416 (internal gear), an end plate 418 with blades 412 mounted, an outer rear bearing 420, and another bearing cap 422. In this embodiment, the outer compressor rotor serves as the rotor for the SRM.

In this embodiment, there are eight outer rotor lobes 411 with eight blades 412 in each radial array 413 of rotor poles. In particular embodiments, such symmetry may be necessary to minimize centrifugal stress/deformation. In this configuration, ferromagnetic materials utilized for the operation of the rotor/stator configuration 450 may only be placed in the blades 412 of the radial array 413.

FIG. 7 shows an inner rotor assembly 430 of the rotor/stator configuration 450, according to an embodiment of the invention. The inner rotor assembly 430 of FIG. 7 includes an inner shaft 432, a stack of three (seven lobed) inner rotors 434A/434B/434C, a spur gear 436, and an inner rear bearing 438.

Details of operation of the inner rotor assembly 430 with respect to the outer rotor assembly 400, according to certain embodiments of the invention, as well as with other configuration variations are described in further detail in one or more of the following United States Patents and/or Patent Application Publications: Publication No. 2003/0228237; Publication No. 2003/0215345; Publication No. 2003/0106301; U.S. Pat. No. 6,336,317; and U.S. Pat. No. 6,530,211.

FIG. 8 shows a stator/compressor case 440 of the rotor/stator configuration 450, according to an embodiment of the invention. The stator/compressor case 440 of FIG. 8 in this embodiment includes three stacks 442A, 442B, 442C of twelve stator poles 444, spaced at equal angles. Although the stator poles 444 could be mounted to the case 440 in many ways, an external coil embodiment is shown in FIG. 8. There are two coils 446A, 446B per stator pole 444, which are mounted in sets of three into a nonferromagnetic base plate 448, forming a bolt-in pole cartridge 450. In particular embodiments, the coils 446A, 446B may be copper coils. In other embodiments, the coils 446A, 446B may be made of other materials. In particular embodiments, the number of coils 446 on a given stator pole 444 can be increased above two, thereby reducing the voltage that must be supplied to each coil. During operation of particular embodiments, all poles in four cartridges 450 (90° apart) may be magnetized simultaneously. The magnetization occurs sequentially causing the outer rotor assembly 400 of FIG. 6 to rotate.

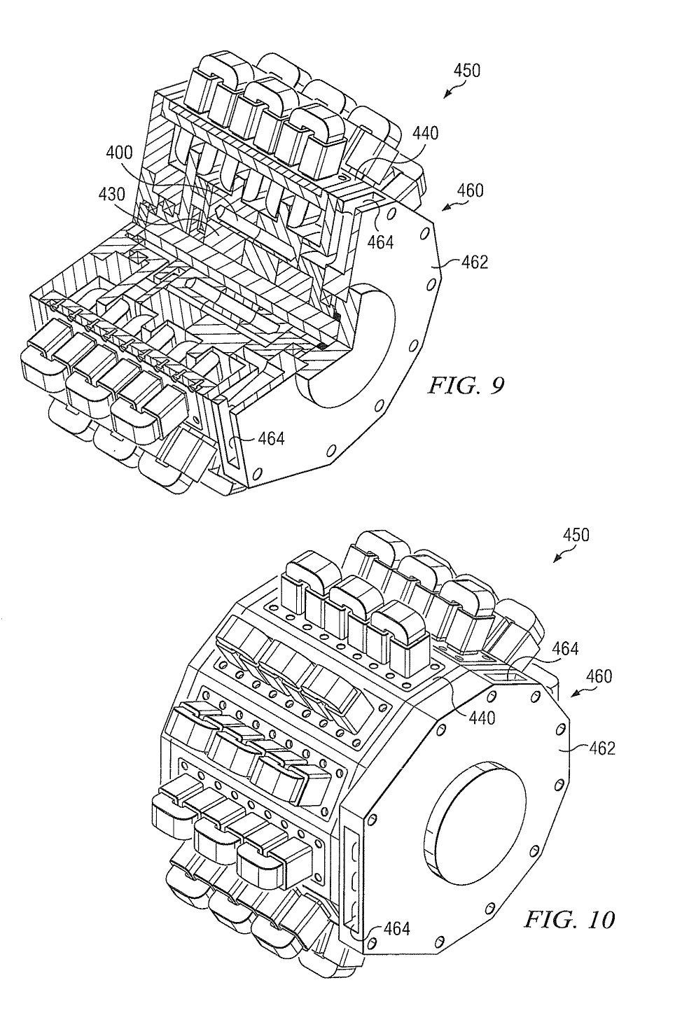

FIG. 9 shows a cutaway view of a composite assembly 460 of a rotor/stator configuration 450, according to an embodiment of the invention. The composite assembly 460 shows an integration of the outer assembly 400, the inner assembly 430, and the stator/compressor case 440 of FIGS. 6-8 as well as end plates 462 providing bearing support and gas inlet/outlet porting through openings 464. FIG. 10 shows the composite assembly 460 without the cutaway.

In certain embodiments, during operation, the rotor may expand due to centrifugal and thermal effects. To prevent contact between the rotor poles and stator poles, a large air gap is typically used. However, it is known that the torque is strongly affected by the air gap: a smaller gap results in more torque. Accordingly, there are advantages to reducing the gap as small as possible. Teachings of some embodiments recognize configurations for maintaining small gap during thermal and centrifugal expansion of a rotor.

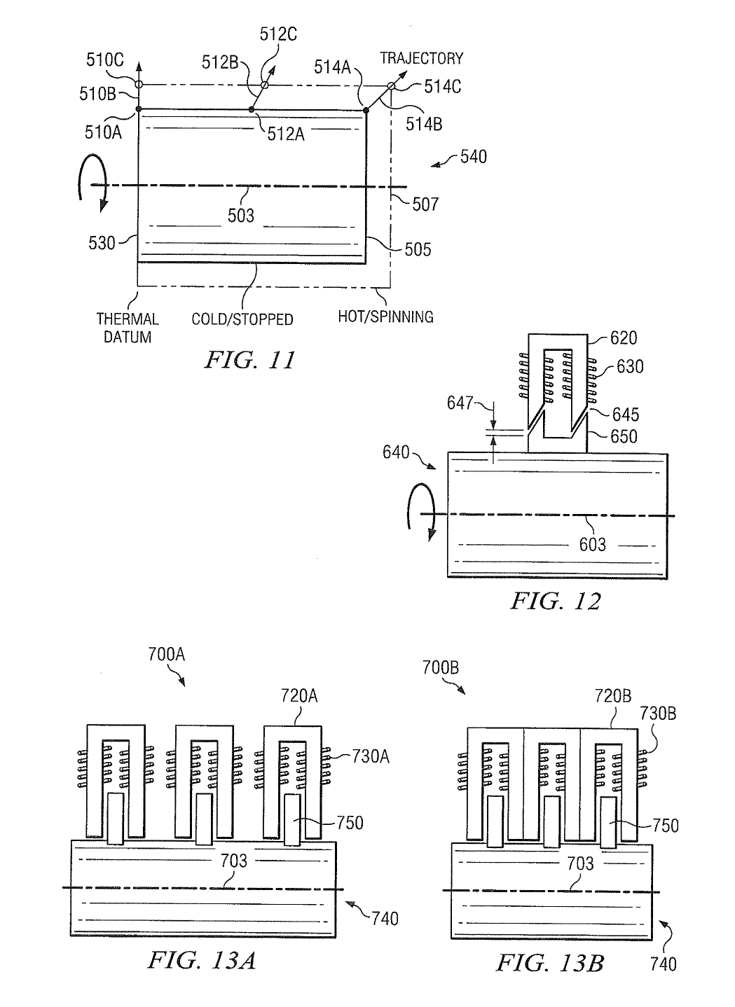

FIG. 11 shows a side view of how a rotor 540 changes shape when it expands due to centrifugal and thermal effects. The rotor 540 has an axis of rotation 503. The solid line 505 represents the rotor 540 prior to expansion and the dotted line 507 represents the rotor 540 after expansion. Dots 510A, 512A, and 514A represent points on the rotor 540 at the cold/stopped position and dots 510C, 512C, and 514C represent the same points on the rotor 540 at the hot/spinning position. The left edge or thermal datum 530 does not change because it is held in place whereas the right edge is free to expand. The trajectories 510B, 512B, and 514B of dots is purely radial at the thermal datum 530 and becomes more axial at distances farther from the thermal datum 530.

FIG. 12 shows a rotor/stator configuration 600, according to an embodiment of the invention. The rotor/stator configuration 600 includes a rotor 640 that rotates about an axis 603. The rotor 640 includes rotor poles 650 that interact with stator poles 620, for example, upon firing of coils 630. The rotor/stator configuration 600 of FIG. 12 may operate in a similar manner to the rotor/stator configuration 300 of FIGS. 5A and 5B, except for an interface 645 between the rotor pole 650 and the stator pole 620. In the rotor/stator configuration 600 of FIG. 12, an angle of interface 645 between the rotor pole 650 and stator pole 620 is the same as the trajectory of a dot on the surface of the rotor 540 shown in FIG. 11. By matching these angles, the surface of the rotor pole 650 and the surface of the stator pole 620 slide past each other without changing an air gap 647, even as the rotor 640 spins and heats up. This design allows for very small air gaps to be maintained even at a wide variety of rotor temperatures. In particular embodiments, the housing that holds the stator pole 620 may be assumed to be maintained at a constant temperature. Various different angles of interface 645 may be provided in a single configuration for a rotor pole 650/stator pole 620 pair, dependent upon the trajectory of the dot on the surface of the rotor 640.

FIGS. 13A and 13B show a rotor/stator configuration 700A, 700B, according to another embodiment of the invention. The rotor/stator configurations 700A, 700B include rotors 740 that rotate about an axis 703. The rotor/stator configurations 700A, 700B of FIGS. 13A and 13B may operate in a similar manner to the rotor/stator configuration 300 of FIGS. 5A and 5B, including rotor poles 750, stator poles 720A, 720B, and coils 730A, 730B. The rotor/stator configuration 700A of FIG. 13A show three U-shaped stators 720A, operating as independent units. The rotor/stator configuration 700B of and FIG. 13B shows a single E-shaped stators 710B operating like three integrated U-shaped stators 720A. This E-shaped stator 720B allows for higher torque density. Although an E-shaped stator 720B is shown in FIG. 13B, other shapes may be used in other embodiments in integrating stator poles into a single unit.

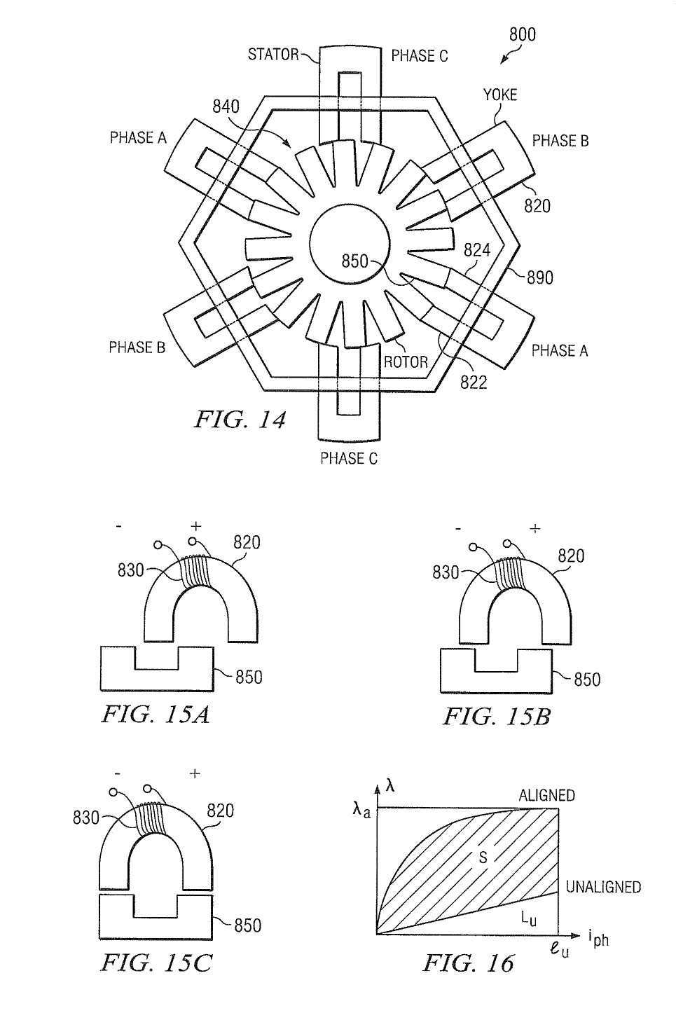

FIG. 14 shows a rotor/stator configuration 800, according to another embodiment of the invention. In a similar manner to that described above with other embodiments, the rotor/stator configuration 800 of FIG. 14 may be utilized with various types of electric machines, including motors and generators. The rotor/stator configuration 800 of FIG. 14 may operate in a similar manner to the rotor/stator configuration 300 of FIGS. 5A and 5B, including rotor poles 850 and U-shaped stator poles 820. However, the stator poles 820 have been axially rotated ninety degrees such that the rotor poles 850 do not transverse between a gap of the U-shape stator poles 820. Similar to FIGS. 5A and 5B, the flux path is relatively short. For example, the magnetic flux produced by a coil fired on the U-shaped pole 820 would pass through one leg 822 of the pole 820 through the rotor pole 850 through a periphery of the rotor through another rotor pole 850 and to the other leg 824 of the pole 820 in a circular-like path.

The rotor/stator configuration 800 of FIG. 14 is shown with three phases A, B, and C and two pairs of stator poles 820 per each phase. In this embodiment, stator poles 820 are U-shaped iron cores with coils that are inserted into a non-ferromagnetic yoke 890. In other embodiments the stator poles 820 may be made of materials other than iron and may have other configurations. The stator poles 820 in particular embodiments may be electrically and magnetically isolated from each other. The rotor 840 in the embodiment of FIG. 14 may operate like a rotor of a conventional SRM; however, unlike a conventional SRM, the pitches of the rotor pole 850 and stator pole 820 are the same.

The magnetic reluctance of each phase changes with position of the rotor 840. As shown in FIG. 15, when a rotor pole 850 is not aligned with two stator poles 820, the phase inductance is at a minimum and this position may be called an unaligned position. When the rotor pole 850 is aligned with the stator pole 820, the magnetic inductance is at a maximum and this position may be called an aligned position. Intermediate between the aligned position and unaligned position is an intermediate position. SRM torque is developed by the tendency of the magnetic circuit to find the minimum reluctance (maximum inductance) configuration.

The configuration of FIG. 14 is such that whenever the rotor 840 is aligned with one phase, the other two phases are half-way aligned, so the rotor 840 can move in either direction depending which phase will be excited next.

For a phase coil with current i linking flux, the co-energy W′can be found from the definite integral:

$${W}^{′} = {\int }_{0}^{i} λ d i \qquad ( 1 )$$

The torque produced by one phase coil at any rotor position is given by:

$$T = {[ \frac{\partial {W}^{′}}{\partial θ} ]}_{i = constamt} \qquad ( 2 )$$

The output torque of an SRM is the summation of torque of all phases:

$${T}_{m} = {\sum }_{j = 1}^{N} T ( {i}_{j} , θ ) \qquad ( 3 )$$

If the saturation effect is neglected, the instantaneous torque can be given as:

$$T = \frac{1}{2} {i}^{2} \frac{d L}{d θ} \qquad ( 4 )$$

From Equation 4, it can be seen that to produce positive torque (motoring torque) in SRM, the phase has to be excited when the phase bulk inductance increases, which is the time that the rotor moves towards the stator pole. Then it should be unexcited when it is in aligned position. This cycle can be shown as a loop in flux linkage (λ)—phase current (iₚₕ) plane, which is called energy conversion loop as shown in FIG. 16. The area inside the loop (S) is equal to the converted energy in one stroke. So the average power (Pₐᵥₑ) and the average torque of the machine (Tₐᵥₑ) can be calculated as follows:

$$\begin{matrix}{P}_{ave} = \frac{{N}_{p} {N}_{r} {N}_{s} S ω}{4 π} & ( 5 ) \\ {T}_{ave} = \frac{{N}_{p} {N}_{r} {N}_{ph} S}{4 π} & ( 6 )\end{matrix}$$

where, Nₚ, Nᵣ, Nₚₕ, ω are the number of stator pole pairs per phase, number of rotor poles, number of stator phases, and rotor speed, respectively.

By changing the number of phases, stator pole pitch, and stator phase-to-phase distance angle, different types of short-flux-path SRMs can be designed.

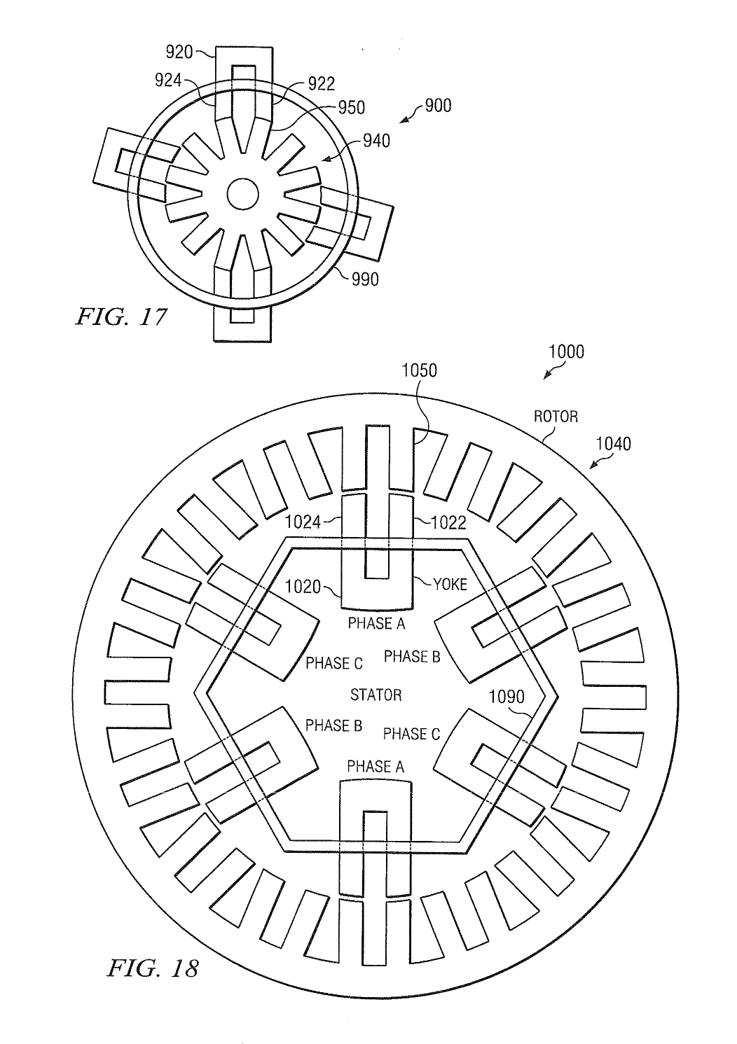

FIG. 17 shows a rotor/stator configuration 900, according to another embodiment of the invention. The rotor/stator configuration 900 of FIG. 17 is a two-phase model, which operates in a similar manner to the model described with reference to FIG. 14. The configuration 900 of FIG. 17 includes rotor 940; rotor poles 950; stator poles 920; legs 922, 924; and yoke 990.

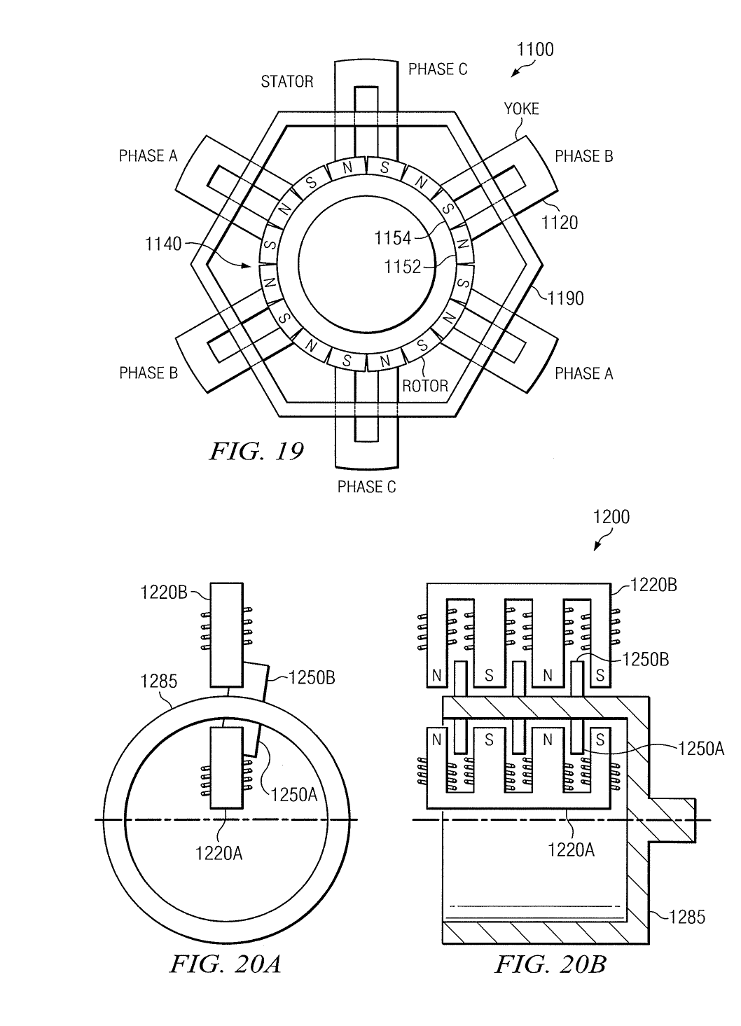

FIG. 18 shows a rotor/stator configuration 1000, according to another embodiment of the invention. In a similar manner to that described above with other embodiments, the rotor/stator configuration 1000 of FIG. 18 may be utilized with various types of electric machines, including motors and generators. The rotor/stator configuration 1000 of FIG. 18 may operate in a similar manner to rotor/stator configuration 1000 of FIG. 14, including U-shaped stator poles 1020, rotor poles 1050, a non-ferromagnetic yoke 1080, and phases A, B, and C. However, in the rotor/stator configuration 1000 of FIG. 18, the rotor poles 1050 are placed radially outward from the stator poles 1020. Accordingly, the rotor 1040 rotates about the stator poles 1020. Similar to FIG. 14, the flux path is relatively short. For example, the magnetic flux produced by a coil fired on the U-shaped stator pole 1020 would pass through one leg 1022 of the stator pole 1020 through the rotor pole 1050 and to the other leg 1024 of the stator pole 820 in a circular-like path. As one example application of the rotor/stator configuration 1000 according to a particular embodiment, the rotor/stator configuration 1000 may be a motor in the hub of hybrid or electric (fuel cell) vehicles, and others. In this embodiment, the wheel is the associated with the rotor 1040, rotating about the stators 1020. This rotor/stator configuration 1000 may additionally be applied to permanent magnet motors, for example, as shown in FIG. 19.

FIG. 19 shows a rotor configuration 1100, according to another embodiment of the invention. The rotor/stator configuration 1100 of FIG. 14 may operate in a similar manner to rotor/stator configuration 1100 of FIG. 14, including U-shaped stator poles 1120, a non-ferromagnetic yoke 1190, and phases A, B, and C, except that a rotor 1140 contains alternating permanent magnet poles 1152, 1154.

FIG. 20 shows a rotor/stator configuration 1200, according to another embodiment of the invention. In a similar manner to that described above with other embodiments, the rotor/stator configuration 1200 of FIG. 20 may be utilized with various types of electric machines, including motors and generators. The rotor/stator configuration 1200 of FIG. 20 integrates several concepts described with reference to other embodiments, including blades 1250A, 1250B from FIGS. 5A and 5B; E-shaped stator poles 1220A, 1220B from FIG. 13B; stator poles 1220B radially inward of rotor poles 1250B from FIGS. 6-10; and stator poles 1220A radially outward of rotor poles 1250B from FIG. 18. The stator poles 1220A are rigidly mounted both on the inside and outside of a drum 1285, which allows torque to be applied from both the inside and outside thereby increasing the total torque and power density. In particular embodiments, the rotor poles 1250A, 1250B may be made of a ferromagnetic material, such as iron, which is a component of a switched reluctance motor. In other embodiments, the rotor poles 1250A, 1250B could be permanent magnets with the poles parallel to the axis of rotation, which would be a component of a permanent magnet motor.

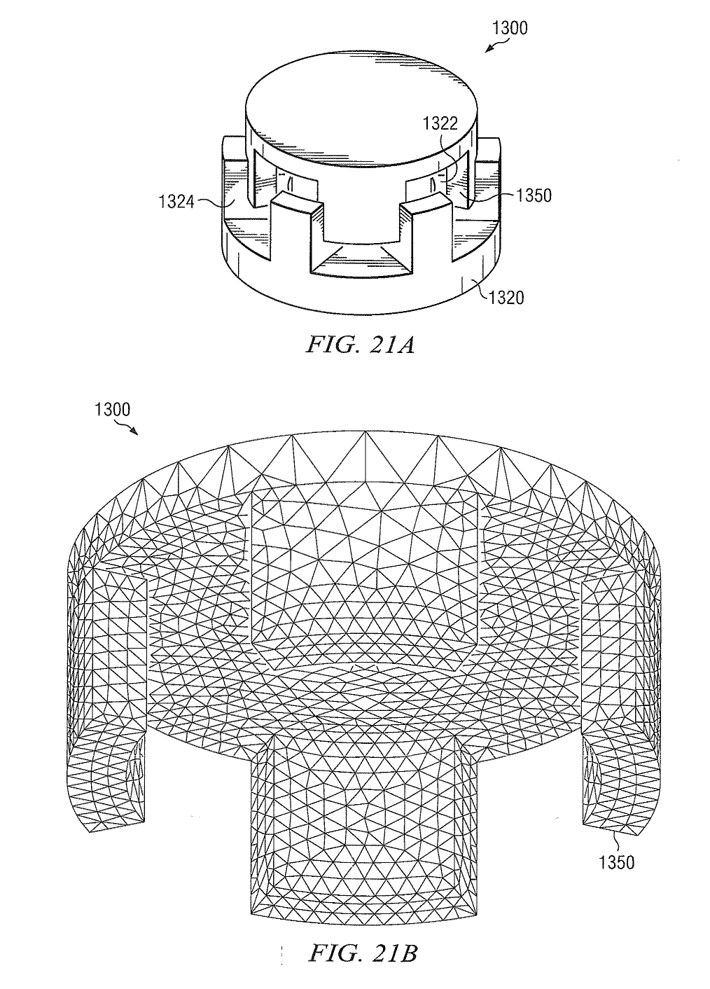

FIGS. 21A and 21B show a rotor/stator configuration 1300, according to another embodiment of the invention. In a similar manner to that described above with other embodiments, the rotor/stator configuration 1200 of FIGS. 21A and 21B may be utilized with various types of electric machines, including motors and generators. The rotor/stator configuration 1300 of FIGS. 21A and 21B may operate in a similar manner to the rotor/stator configuration 1300 of FIGS. 5A and 5B, including rotor poles 1350 and U-shaped stator poles 1320. However, the rotor poles 1350 and U-shaped stator poles 1320 have been rotated ninety degrees such that rotor poles 1350 rotate between a leg 1322 of the stator pole 1320 that is radially inward of the rotor pole 1350 and a leg 1324 of the stator pole 1320 that is radially outward of the rotor pole 1350. In the embodiment of the rotor/stator configuration 1300 of FIGS. 21A and 21B, it can be seen that the axial and radial fluxes co-exist.

In this embodiment and other embodiments, there may be no need for a magnetic back-iron in the stator. Further, in this embodiment and other embodiments, the rotor may not carry any magnetic source. Yet further, in particular embodiments, the back iron of the rotor may not need to be made of ferromagnetic material, thereby creating flexibility design of the interface to the mechanical load.

In this embodiment and other embodiments, configuration may offer higher levels of power density, a better participation of stator and the rotor in force generation process and lower iron losses, thereby offering a good solution for high frequency applications. In various embodiments described herein, the number of stator and rotor poles can be selected to tailor a desired torque versus speed characteristics. In particular embodiments, cooling of the stator may be very easy. Further, the modular structure of certain embodiments may offer a survivable performance in the event of failure in one or more phases.

### Optimization of the Magnetic Forces

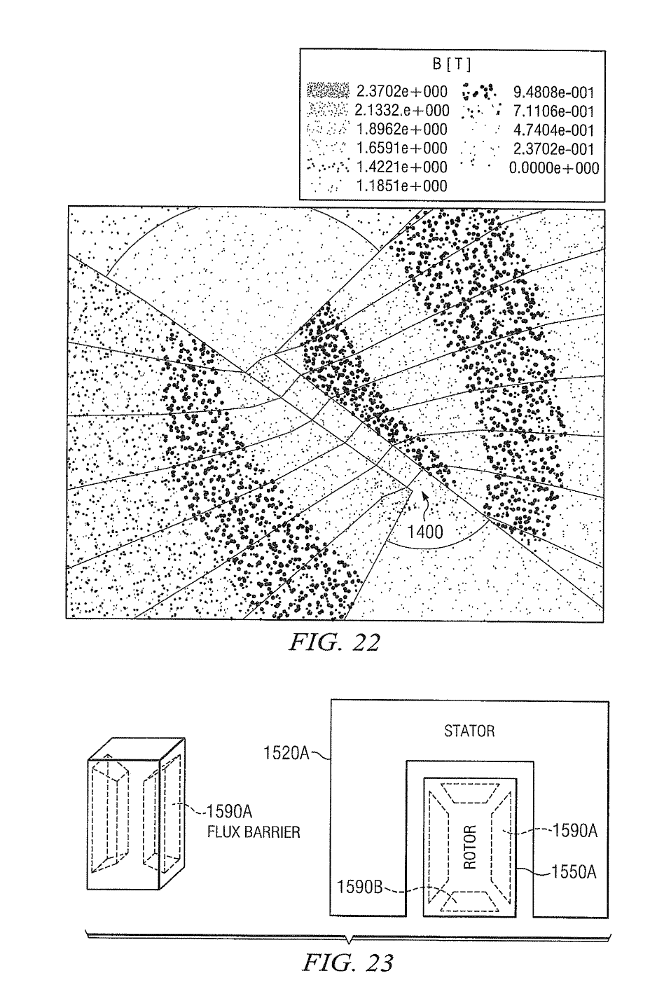

FIGS. 22-25 illustrate an optimization of magnetic forces, according to embodiments of the invention. The electromagnetic force on the surface of a rotor has two components, one that is perpendicular to the direction of motion and one that is tangent to the direction of motion. These components of the force may be referred to as normal and tangential components of the force and can be computed from magnetic field quantities according to the following equations:

$${f}_{n} = \frac{1}{2 {μ}_{0}} ( {B}_{n}^{2} - {B}_{t}^{2} ) \\ {f}_{t} = \frac{1}{{μ}_{0}} {B}_{n} {B}_{t} \qquad ( 7 )$$

For an optimal operation, the tangential component of the force needs to be optimized while the normal component of the force has to be kept at a minimal level or possibly eliminated. This, however, is not the case in conventional electromechanical converters. To the contrary, the normal force forms the dominant product of the electromechanical energy conversion process. The main reason for this can be explained by the continuity theorem given below. As the flux lines enter from air into a ferromagnetic material with high relative permeability the tangential and normal components of the flux density will vary according to the following equations:

$${B}_{n , air} = {B}_{n , iron} \\ {B}_{t , air} = \frac{1}{{μ}_{r , iron}} {B}_{t , iron} \qquad ( 8 )$$

The above equations suggest that the flux lines in the air gap will enter the iron almost perpendicularly and then immediately change direction once enter the iron. This in turn suggests that in a SRM and on the surface of the rotor we only have radial forces.

FIG. 22 illustrates the formation of flux lines in a SRM drive. The flux density, B, is shown in Teslas (T). The radial forces acting on the right side of the rotor (also referred to as fringing flux—indicated by arrow 1400) create radial forces (relative to the rotor surface) that create positive propelling force for the rotor. This is the area that needs attention. The more fluxes are pushed to this corner, the better machine operates. This explains why SRM operates more efficient under saturated condition. This is because due to saturation, the effective air gap of the machine has increased and more flux lines are choosing the fringing path.

To enhance the migration of flux lines towards the fringing area, one embodiment of the invention uses a composite rotor surface. In the composite rotor surface, the top most part of the of the rotor is formed by a material that goes to saturation easier and at a lower flux density, thereby reinforcing the fringing at an earlier stage of the electromechanical energy conversion process. In particular embodiments, the shape of the flux barrier or the shape of the composite can be optimized to take full advantage of the magnetic configuration. In another embodiment, flux barriers can be introduced in the rotor to discriminate against radial fluxes entering the rotor normally and push more flux lines towards the fringing area. FIGS. 23, 24 and 25 illustrate these embodiments.

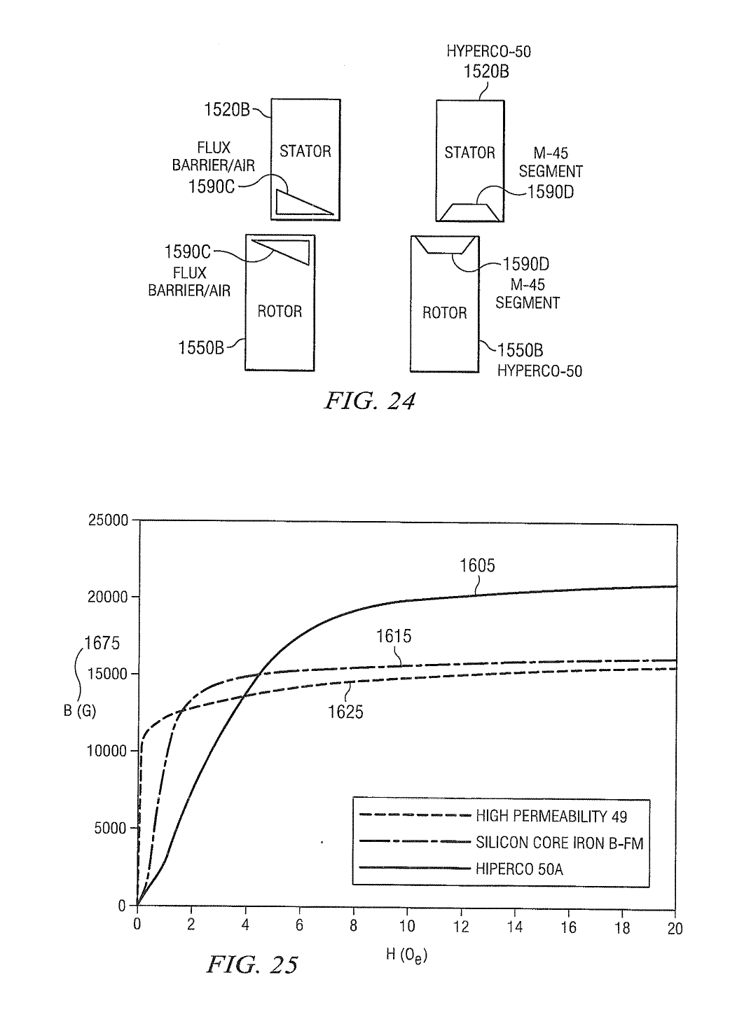

FIGS. 23 and 24 show the placement of easily saturated materials or flux barriers 1590A, 1590B, 1590C, and 1590D under the surface of rotors 1550A, 1550B, and stators 1520A, 1520B, Example materials for easily saturated materials or flux barriers 1590 include, but are not limited to M-45. Example ferromagnetic materials for the rotors 1550 and stators 1520 include, but are not limited HyperCo-50. The shape, configuration, and placement of the easily saturated materials or flux barriers may change based on the particular configurations of the rotors and stators.

FIG. 25 shows a chart 1600 of B-H curve for various alloys. The chart 1600 of FIG. 25 charts magnetic flux density 1675, B, against magnetic field 1685, H, for alloys 1605, 1615, and 1625.

### Theory for Analyzing Various Rotor/Stator Configurations

Various different rotor/stator configurations are disclosed herein. One type of rotor/stator configuration disclosed herein may be referred to at “U-shaped core/flat blade” rotor/stator configurations. Some examples of the U-shaped core/flat blade configuration are shown and discussed above with reference to FIGS. 5-13 and 20-21. In this configuration, the cores (or stator poles) are generally U-shaped with a pair of legs, and the blades (or rotor poles) pass through a gap defined between the legs of the U-shaped cores. Such blades may be referred to as “flat” blades.

Another type of rotor/stator configuration disclosed herein may be referred to as “U-shaped blade/U-shaped core” rotor/stator configurations. Some examples of the U-shaped blade/U-shaped core configuration are shown and discussed above with reference to FIGS. 14-18. In this configuration, both the cores (or stator poles) and the blades (or rotor poles) are generally U-shaped. The U-shaped cores include a pair of legs, and the U-shaped blades include a pair of legs. The U-shaped cores in this configuration are axially rotated 90 degrees as compared to the U-shaped core/flat blade configuration. Thus, unlike in the U-shaped core/flat blade configuration, the blades in the U-shaped blade/U-shaped core configuration do not pass through a gap between the legs of each U-shaped core. Instead, the ends of the two legs of each U-shaped blade slide just past the ends of the two legs of each U-shaped core, e.g., as shown in FIGS. 14, 15, 17, and 18.

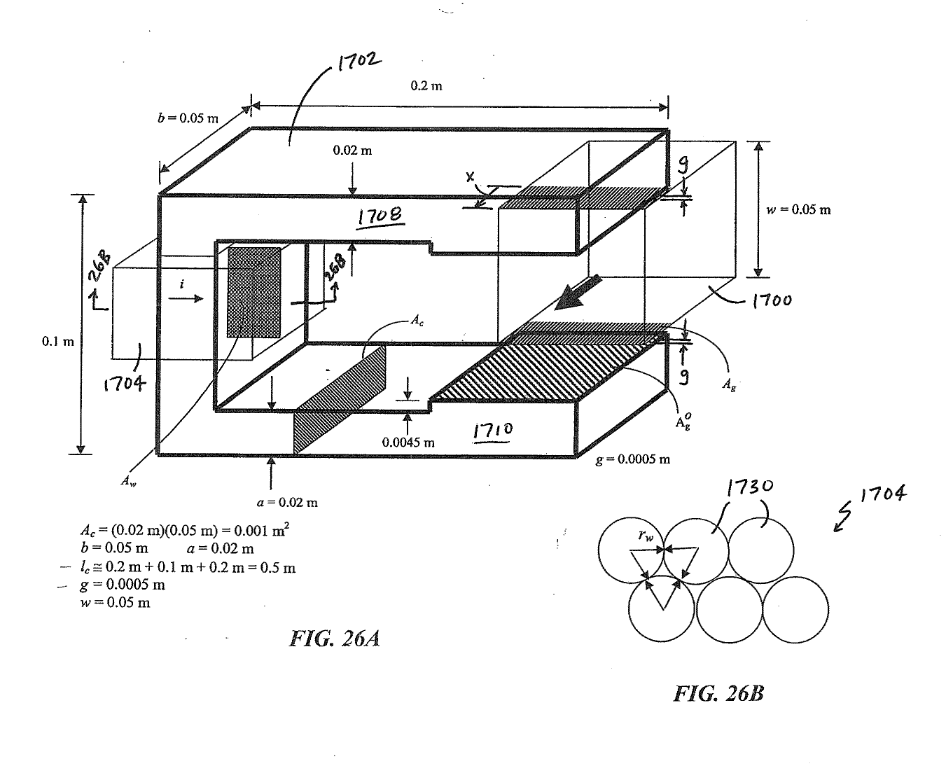

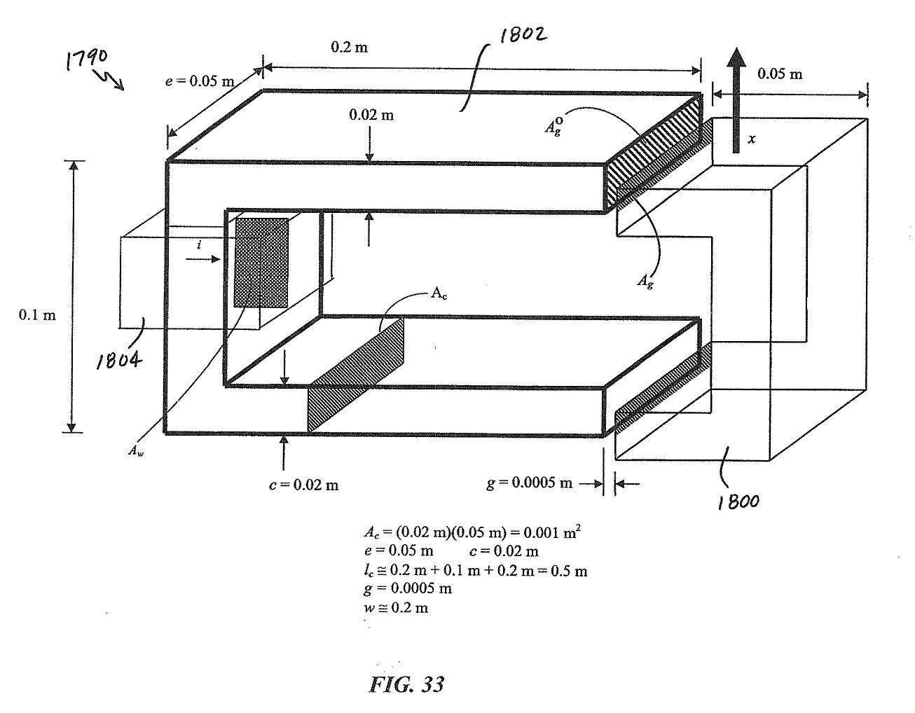

Presented below are methods for calculating the theoretical torque and other performance characteristics provided by various rotor/stator configurations. In particular, FIGS. 26-32, along with the corresponding text and equations below, provide theory and calculations for determining the torque and other performance characteristics provided by various U-shaped core/flat blade rotor/stator configurations. Similarly, FIGS. 33-41, along with the corresponding text and equations below, provide theory and calculations for determining the torque and other performance characteristics provided by various U-shaped core/flat blade rotor/stator configurations.

### “Flat Blade/U-Shaped Core” Rotor/Stator Configurations

FIG. 26A illustrates a magnetic circuit created in a Flat blade/U-shaped core rotor/stator configuration when a flat blade 1700 enters a magnetized U-shaped core 1702 having an energized wire coil 1704. U-shaped core 1702 includes a first leg 1708 and a second leg 1710, and flat blade 1700 passes through the gap defined between legs 1708 and 1710. The magnetomotive force F of the magnetic circuit is:

F=Ni=F_{c}+F_{g}+F_{b} (9)

where
F=magnetomotive force (A·turn)
F_{c}=magnetomotive force dissipated in core 1702 (A·turn)
F_{g}=magnetomotive force dissipated in the air gaps between core 1702 and flat blade 1700 (A·turn)
F_{b}=magnetomotive force dissipated in flat blade 1700 (A·turn)
N=number of turns in coil 1704
i=current (A)
   The dissipation of magnetomotive force in each section of the magnetic circuit follows:

F=Ni=H_{c}l_{c}+H_{g}2g+H_{b}w (10)

where
H_{c}=magnetic field intensity in core 1702 (A·turn/m)
H_{g}=magnetic field intensity in the air gaps between core 1702 and flat blade 1700 (A·turn/m)
H_{b}=magnetic field intensity in flat blade 1700 (A·turn/m)
l_{c}=length of core 1702 re (m)
g=length of each of the two air gaps between core 1702 and flat blade 1700 (m)
w=width of flat blade 1700 (m)
   The magnetic flux density is related to the magnetic field intensity as follows:

B=μH (11)

where
B=magnetic flux density (Wb/m² or tesla)
μ=magnetic permeability (Wb/(A·turn·m))

All or portions of blade 1700 and core 1702 may be formed from any suitable materials. In certain applications, metals with high magnetic permeability may be preferred. As an example only, blade 1700 and/or core 1702 may be formed from 0.012-inch-thick M-5 grain-oriented electrical steel.

Various example dimensions are shown in FIG. 26A. It should be understood that these are example values only, and that the components shown in FIG. 26A may be formed with any other suitable dimensions.

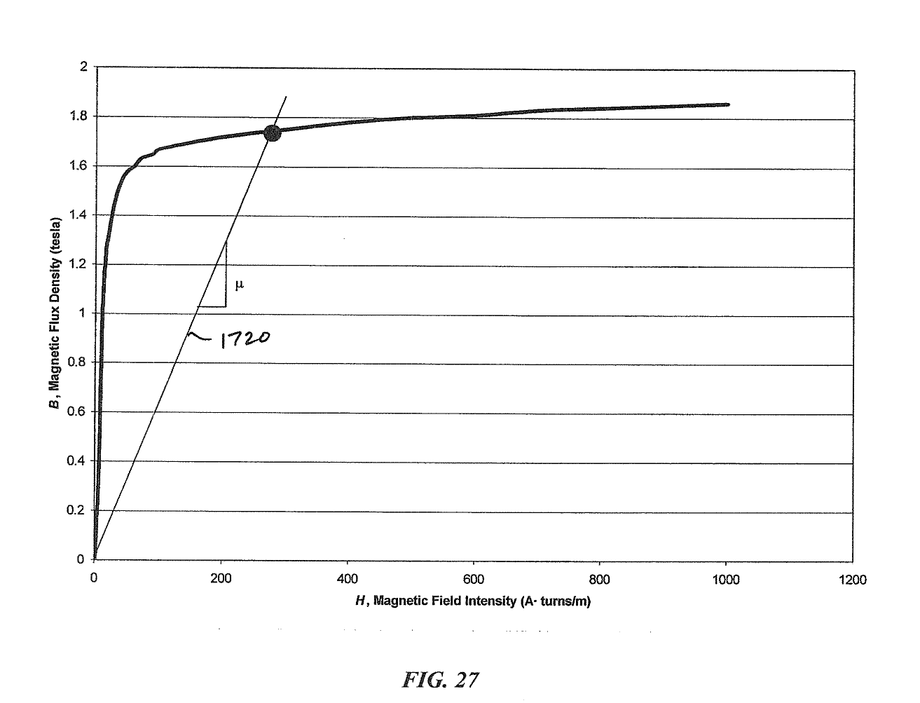

FIG. 27 is a graph illustrating the relationship between B and H for an example material: 0.012-inch-thick M-5 grain-oriented electrical steel. The magnetic permeability (g) is the slope of the line 1720.

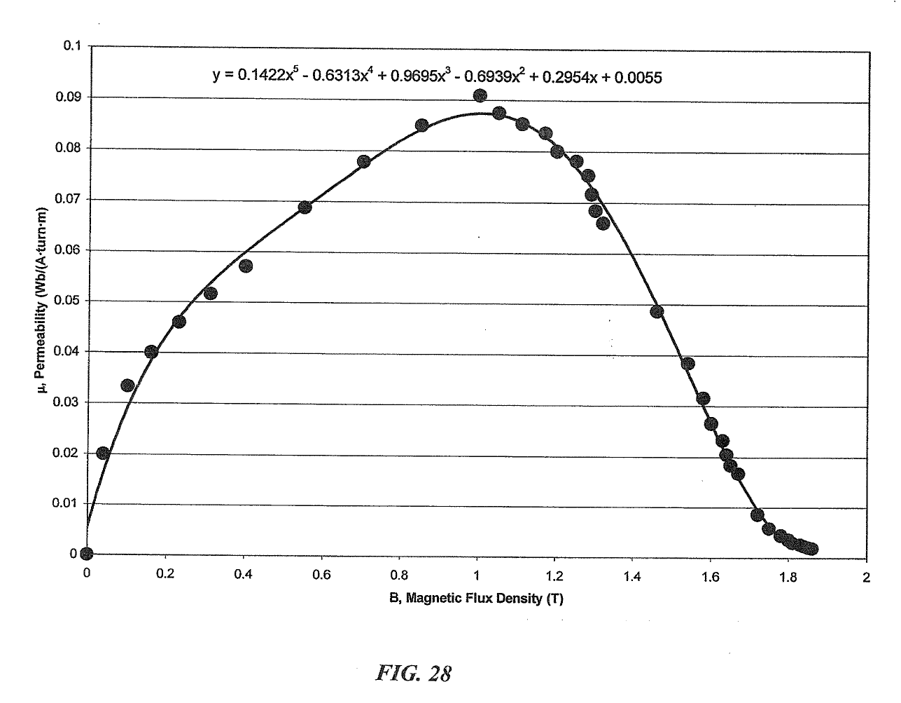

FIG. 28 is a graph illustrating the magnetic permeability μ as a function of B for 0.012-inch-thick M-5 grain-oriented electrical steel. Substituting Equation 11 into Equation 10 gives:

$$F = Ni = \frac{{B}_{c} {l}_{c}}{{μ}_{c}} + \frac{{B}_{g} 2 g}{{μ}_{o}} + \frac{{B}_{b} w}{{μ}_{b}} \qquad ( 12 )$$

where
μc=magnetic permeability in core 1702 (Wb/(A·turn·m))
μₒ=magnetic permeability in the air
   =magnetic permeability of free space=4π×10⁻⁷ Wb/(A·turn·m)
μ_{b}=magnetic permeability in flat blade 1700 (Wb/(A·turn·m))

The magnetic flux φ is the same everywhere in the circuit and follows:

φB_{c}A_{c}=B_{g}A_{g}=B_{b}A_{b} (13)

where
φ=magnetic flux (Wb)
A_{c}=cross-sectional area of core 1702 (m2), as indicated at leg 1710 in FIG. 26A
A_{g}=area of the air gap (i.e., the area of overlap) between core 1702 and flat blade 1700 at an instant of time (m2)
A_{b}=area of flat blade 1700 through which the magnetic flux passes at an instant of time (m²)

If the flat blade width w is small, the magnetic field lines do not have enough space to spread out so the magnetic flux density of the air gap and flat blade 1700 are about the same, thus allowing the following approximation to be made:

A_{b}≈A_{g} (14)

Using this relationship, the magnetic flux density can be calculated in each portion of the magnetic circuit.

$${B}_{c} = \frac{φ}{{A}_{c}} \\ {B}_{g} = \frac{φ}{{A}_{g}} \\ {B}_{b} = \frac{φ}{{A}_{b}} \qquad ( 15 )$$

Substituting the relationships in Equations 15 into Equation 12 gives the following:

$$F = Ni = \frac{φ {l}_{c}}{{μ}_{c} {A}_{c}} + \frac{φ2 g}{{μ}_{o} {A}_{g}} + \frac{φ w}{{μ}_{b} {A}_{b}} = φ ( \frac{{l}_{c}}{{μ}_{c} {A}_{c}} + \frac{2 g}{{μ}_{o} {A}_{g}} + \frac{w}{{μ}_{b} {A}_{b}} ) \\ φ = \frac{Ni}{( \frac{{l}_{c}}{{μ}_{c} {A}_{c}} + \frac{2 g}{{μ}_{o} {A}_{g}} + \frac{w}{{μ}_{b} {A}_{b}} )} \qquad ( 16 )$$

The terms in the brackets are the reluctance R (A·turn/Wb) of each portion of the magnetic circuit.

F=Ni=φ+(R_{c}+R_{g}+R_{b}) (17)

where

$${R}_{c} = \frac{{l}_{c}}{{μ}_{c} {A}_{c}} = reluctance of core 1702 ( A \cdot turn / Wb ) \\ {R}_{g} = \frac{2 g}{{μ}_{o} {A}_{g}} = reluctance of the two air gaps between core 1702 and blade 1700 ( A \cdot turn / Wb ) \\ {R}_{b} = \frac{w}{{μ}_{b} {A}_{b}} = reluctance of flat blade 1700 ( A \cdot turn / Wb ) \qquad ( 18 )$$

The work required to supply the energy to a magnetic field is:

$${W}_{fld} = \frac{1}{2} L ( x ) {i}^{2} \qquad ( 19 )$$

where
W_{fld}=work required to supply energy to the magnetic field (J)
L(x)=instantaneous inductance (Wb·turn/A), which is a function of the position x of blade 1700 relative to core 1702 as blade 1700 moves through the gap between legs 1708 and 1710 (i.e., the length of overlap between blade 1700 and core 1702), indicated as distance “x” in FIG. 26A.
   As the flat blade moves laterally through the air gap between legs 1708 and 1710 of core 1702, the inductance of the circuit increases, thus allowing the magnetic flux to increase. The inductance is:

$$L ( x ) = \frac{{N}^{2}}{{R}_{c} + {R}_{g} + {R}_{b}} \qquad ( 20 )$$

Substituting the expressions in Equations 18 gives:

$$L ( x ) = \frac{{N}^{2}}{\frac{{l}_{c}}{{μ}_{c} {A}_{c}} + \frac{2 g}{{μ}_{o} {A}_{g}} + \frac{w}{{μ}_{b} {A}_{b}}} \qquad ( 21 )$$

The areas may be expressed relative to the core area A_{c} as follows:

$$L ( x ) = \frac{{N}^{2}}{\frac{{l}_{c}}{{μ}_{c} {A}_{c}} + \frac{2 {gA}_{c}}{{μ}_{o} {A}_{g} {A}_{c}} + \frac{{wA}_{c}}{{μ}_{b} {A}_{b} {A}_{c}}} = \frac{{N}^{2} {A}_{c}}{\frac{{l}_{c}}{{μ}_{c}} + \frac{2 {gA}_{c}}{{μ}_{o} {A}_{g}} + \frac{{wA}_{c}}{{μ}_{b} {A}_{b}}} \qquad ( 22 )$$

Using the approximation shown in Equation 14, the following equation results:

$$L ( x ) = \frac{{N}^{2} {A}_{c}}{\frac{{l}_{c}}{{μ}_{c}} + \frac{2 {gA}_{c}}{{μ}_{o} {A}_{g}} + \frac{{wA}_{c}}{{μ}_{b} {A}_{g}}} = \frac{{N}^{2} {A}_{c}}{\frac{{l}_{c}}{{μ}_{c}} + \frac{{A}_{c}}{{A}_{g}} ( \frac{2 g}{{μ}_{o}} + \frac{w}{{μ}_{b}} )} \qquad ( 23 )$$

The instantaneous air gap A_{g}, which is the instantaneous area of overlap between blade 1700 and core 1702 as blade 1700 moves through the gap between legs 1708 and 1710, is:

$${A}_{g} = \frac{x}{b} {A}_{g}^{o} \qquad ( 24 )$$

where
A_{g}^{o}=area of the closed air gap (i.e., at a position of maximum overlap between blade 1700 and core 1702) (m²)
b=width of flat blade 1700 (m)
x=position of flat blade 1700 relative to core 1702 as blade 1700 moves through the gap between legs 1708 and 1710 (i.e., the length of overlap between blade 1700 and core 1702), indicated as distance “x” in FIG. 26A (m).
   Equation 24 may be substituted into Equation 23 to provide:

$$L ( x ) = \frac{{N}^{2} {A}_{c}}{\frac{{l}_{c}}{{μ}_{c}} + \frac{{A}_{c}}{{A}_{g}^{o}} \frac{b}{x} ( \frac{2 g}{{μ}_{o}} + \frac{w}{{μ}_{b}} )} \qquad ( 25 )$$

Equation 25 may be substituted into Equation 19 to give the work required to build the magnetic field:

$${W}_{fld} = \frac{1}{2} \frac{{N}^{2} {A}_{c}}{\frac{{l}_{c}}{{μ}_{c}} + \frac{{A}_{c}}{{A}_{g}^{o}} \frac{b}{x} ( \frac{2 g}{{μ}_{o}} + \frac{w}{{μ}_{b}} )} {i}^{2} = \frac{1}{2} \frac{{( Ni )}^{2} {A}_{c}}{\frac{{l}_{c}}{{μ}_{c}} + \frac{{A}_{c}}{{A}_{g}^{o}} \frac{b}{x} ( \frac{2 g}{{μ}_{o}} + \frac{w}{{μ}_{b}} )} \qquad ( 26 )$$

The following definitions

$$A ≡ \frac{1}{2} {( Ni )}^{2} {A}_{c} \\ B ≡ \frac{{l}_{c}}{{μ}_{c}} ≅ 0 ( if the core is not saturated ) \\ C ≡ \frac{{A}_{c}}{{A}_{g}^{o}} b ( \frac{2 g}{{μ}_{o}} + \frac{w}{{μ}_{b}} ) ≅ \frac{{A}_{c}}{{A}_{g}^{o}} b ( \frac{2 g}{{μ}_{o}} ) ( if the blade is not saturated ) \qquad ( 27 )$$

may be substituted into Equation 26 to provide:

$${W}_{fld} = \frac{A}{B + \frac{C}{x}} \qquad ( 28 )$$

The force f acting on the flat blade as the magnetic flux increases follows:

$$f = - \frac{\partial {W}_{fld}}{\partial x} \qquad ( 29 )$$

Taking the derivative of Equation 28 gives

$$f = - A \frac{\frac{C}{{x}^{2}}}{{( B + \frac{C}{x} )}^{2}} \qquad ( 30 )$$

If the core and flat blade are not saturated (where saturated=maximum magnetic flux through the circuit) then Equation 30 simplifies to:

$$f = - \frac{A}{C} = - \frac{\frac{1}{2} {( Ni )}^{2} {A}_{c}}{\frac{{A}_{c}}{{A}_{g}^{o}} b ( \frac{2 g}{{μ}_{o}} )} = - ( \frac{{μ}_{o}}{4 g} ) {( Ni )}^{2} \frac{{A}_{c}}{b} ( \frac{{A}_{g}^{o}}{{A}_{c}} ) \qquad ( 31 )$$

Equation 31 indicates that as long as core 1702 is not saturated, the force acting on flat blade 1700 will be constant and independent of the position x of flat blade 1700. Further, for a given core area A_{c} and magnetomotive force Ni, the force increases with a smaller gap g, increases with larger close air gap area A_{g}^{o}, and decreases with greater flat blade width b.

Using the following procedure, the equations above allow the calculation of the force in a flat blade, allowing for saturation of the core:

1. Specify the following: A_{c}, A_{g}^{o}/A_{c}, b, l_{c}, w, g, Ni, x.

2. Guess φ.

3. Calculate B_{c}, B_{g}, and B_{b} (Equations 15).

4. Calculate μ_{c} and μ_{b} (e.g., see FIG. 28).
For example, μ=0.1422B⁵−0.6313B⁴+0.9695B³−0.6939B²+0.2954B+0.0055 for 0.012 M-5 grain-oriented electrical steel, valid up to B=1.9 Wb/m²

5. Calculate φ (Equation 16).

6. Iterate Steps 2 to 5 until convergence.

7. Calculate A, B, and C (Equations 27).

8. Calculate f ((Equation 30).

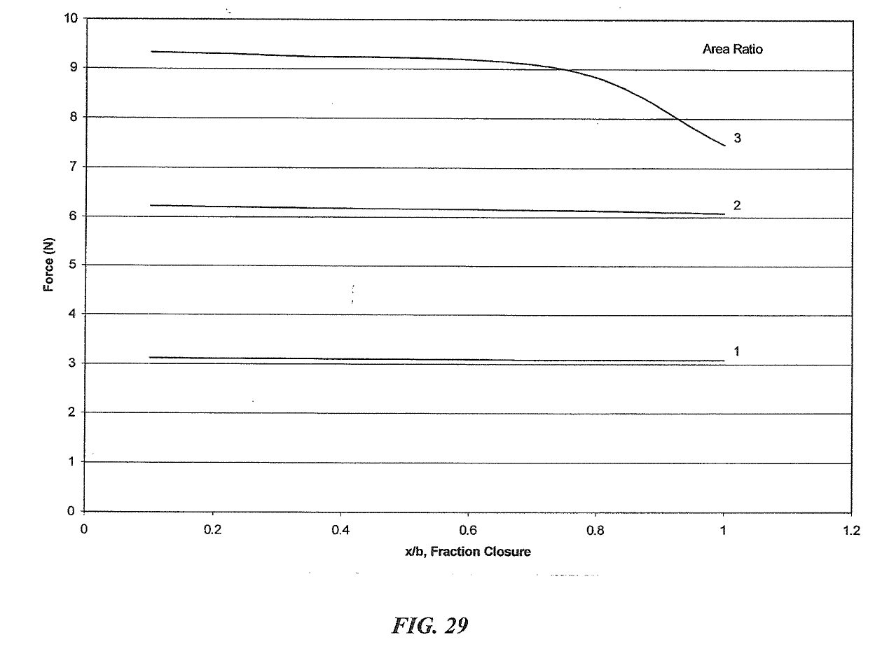

FIG. 29 is a graph illustrating force f versus the fractional closure (x/b) of the flat blade, for three different area ratios A_{g}^{o}/A_{c} in an example Flat blade/U-shaped core stator/rotor configuration. The parameters x, b, A_{g}^{o}, and A_{c} are defined above with reference to FIG. 26A. x/b is the fractional closure, or overlap, of the flat blade as the flat blade moves through the gap between the two legs of the U-shaped core. A_{g}^{o}/A_{c} is the ratio of the surface area of the end of a stator leg that interfaces with the flat blade to the cross-section of that stator leg, as shown in FIG. 26A.

As shown in FIG. 29, the force f is constant with respect to the fractional closure (x/b) of the flat blade, except for relatively high area ratios A_{g}^{o}/A_{c} (e.g., area ratio=3) when the core starts to saturate. A relatively high area ratio A_{g}^{o}/A_{c} may be defined as an area ratio A_{g}^{o}/A_{c} where saturation may have a significant effect on the force as the fractional closure (x/b) increases, e.g., area ratio=3, as shown in FIG. 29.

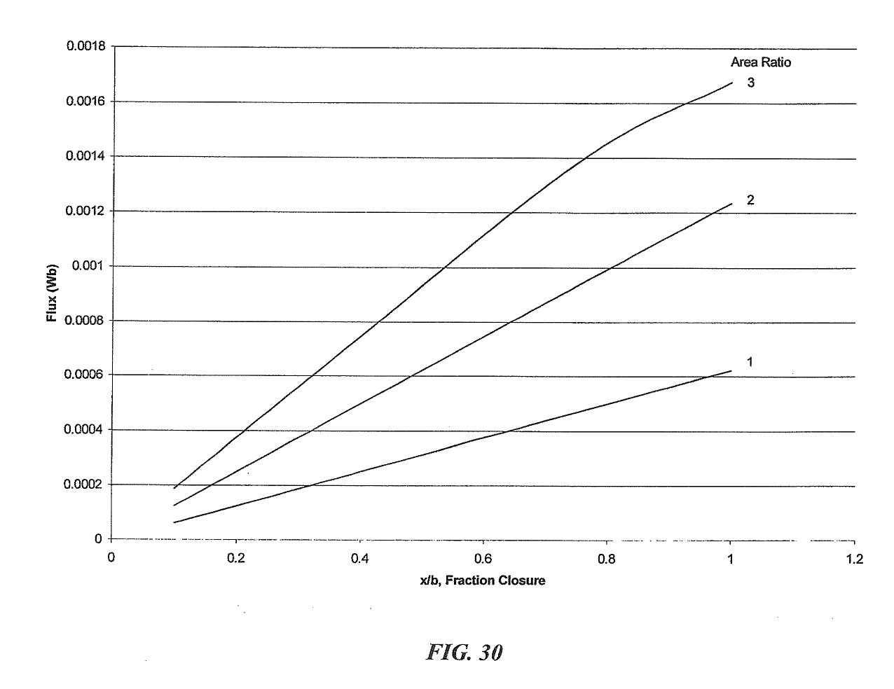

FIG. 30 is a graph illustrating magnetic flux φ versus the fractional closure (x/b) of the flat blade, for three different area ratios A_{g}^{o}/A_{c} in an example Flat blade/U-shaped core stator/rotor configuration. The graph indicates that the magnetic flux φ increases linearly with fractional closure, except for relatively high area ratios A_{g}^{o}/A_{c} (e.g., area ratio=3) when the core starts to saturate.

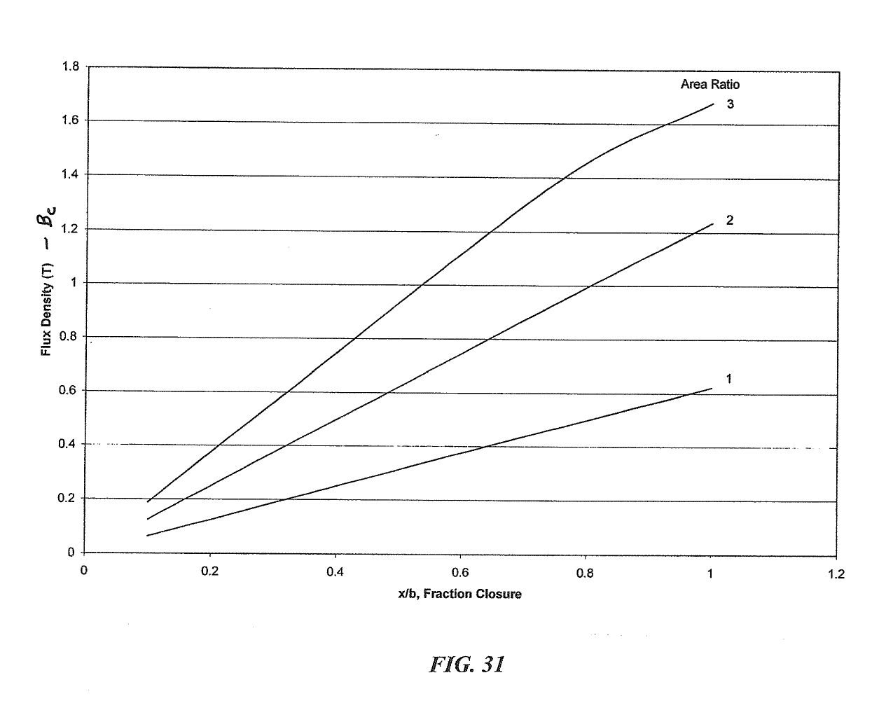

FIG. 31 is a graph illustrating magnetic flux density B_{c} versus the fractional closure (x/b) of the flat blade, for three different area ratios A_{g}^{o}/A_{c} in an example Flat blade/U-shaped core stator/rotor configuration. The graph indicates that the core magnetic flux density B_{c} has a similar pattern as φ, which is expected because the two quantities are related by the core area A_{c}, which is constant.

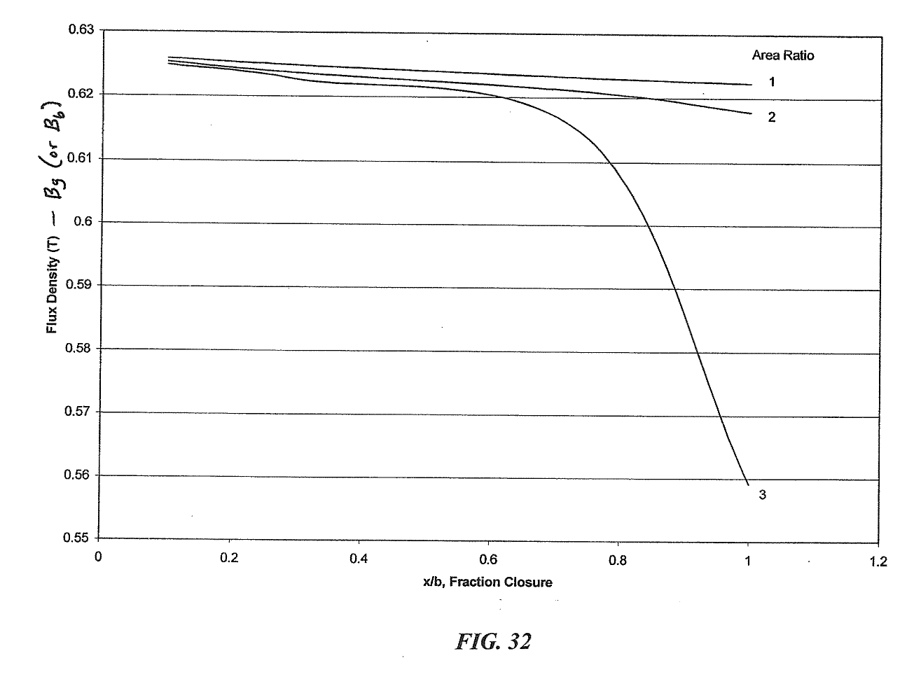

FIG. 32 is a graph illustrating magnetic flux density in both the blade and in the gap, B_{g} and B_{b}, versus the fractional closure (x/b) of the flat blade, for three different area ratios A_{g}^{o}/A_{c} in an example Flat blade/U-shaped core stator/rotor configuration. The graph indicates that the gap and blade magnetic flux density B_{g} and B_{b} are nearly constant for each area ratio A_{g}^{o}/A_{c} and fractional closure, except for relatively high area ratios A_{g}^{o}/A_{c} (e.g., area ratio=3) when the core starts to saturate.

The graphs shown in FIGS. 29-32 were generated based on an example Flat blade/U-shaped core stator/rotor configuration. The illustrated data corresponding to the area ratios of 1, 2, and 3 corresponds to that example configuration. Different configurations (e.g., different geometries, dimensions, materials, coil turns (N), current, etc.) will yield different results for similar area ratios. Thus, what is a “relatively high area ratio” (i.e., where saturation has a significant effect on the force and/or flux densities) depends on the particular configuration. For example, an area ratio of 3 may not be affected by saturation—and thus not a “relatively high area ratio”—in other configurations.

In some embodiments, for a torque-dense electric motor, the core should saturate (i.e., maximum B) just as the air gap is fully closed by the blade (i.e., when x/b=1). This strategy may take maximum advantage of the flux carrying capacity of the core. As shown in FIG. 31, only an area ratio of 3 caused the core to saturate with the Ni used in that configuration (500 A·turns). With all other parameters held constant, the core of the smaller area ratios (1 and 2) can be saturated by increasing Ni; however, this comes at the expense of an increased wire bundle area. An advantage of using an increased area ratio is that it can cause saturation of the core with a small Ni, and hence increase the force acting on the blade. This increased force with a small Ni must come from somewhere—it comes from an increase in voltage that delivers the current. Thus, when the area ratio increases, it allows for a smaller Ni, and a larger voltage.

To maximize the torque from an electric motor, the core should saturate near x/b=1 (full closure of the air gap between the blade and core). For the condition of saturation at closure (x/b=1):

φₘₐₓ=B_{c,max}A_{c} (32)

The maximum magnetic flux occurs with the maximum allowable magnetomotive force (Ni)ₘₐₓ. From Equation 16 for a flat blade:

$${φ}_{max} = \frac{{( Ni )}_{max}}{( \frac{{l}_{c}}{{μ}_{c} {A}_{c}} + \frac{2 g}{{μ}_{o} {A}_{g}^{o}} + \frac{w}{{μ}_{b} {A}_{g}^{o}} )} \qquad ( 33 )$$

where A_{g}=A_{b}=A_{g}^{o}@x/b=1. Substituting Equation 32 into Equation 33 gives:

$${B}_{c , max} {A}_{c} = \frac{{( Ni )}_{max}}{( \frac{{l}_{c}}{{μ}_{c} {A}_{c}} + \frac{2 g}{{μ}_{o} {A}_{g}^{o}} + \frac{w}{{μ}_{b} {A}_{g}^{o}} )} = \frac{{( Ni )}_{max} {A}_{c}}{( \frac{{l}_{c}}{{μ}_{c}} + \frac{2 g}{{μ}_{o}} ( \frac{{A}_{c}}{{A}_{g}^{o}} ) + \frac{w}{{μ}_{b}} ( \frac{{A}_{c}}{{A}_{g}^{o}} ) )} \\ {B}_{c , max} = \frac{{( Ni )}_{max}}{( \frac{{l}_{c}}{{μ}_{c}} + \frac{2 g}{{μ}_{o}} ( \frac{{A}_{c}}{{A}_{g}^{o}} ) + \frac{w}{{μ}_{b}} ( \frac{{A}_{c}}{{A}_{g}^{o}} ) )} = \frac{{( Ni )}_{max}}{( \frac{{l}_{c}}{{μ}_{c}} + ( \frac{2 g}{{μ}_{o}} + \frac{w}{{μ}_{b}} ) ( \frac{{A}_{c}}{{A}_{g}^{o}} ) )} \\ {( Ni )}_{max} = {B}_{c , max} ( \frac{{l}_{c}}{{μ}_{c}} + ( \frac{2 g}{{μ}_{o}} + \frac{w}{{μ}_{b}} ) ( \frac{{A}_{c}}{{A}_{g}^{o}} ) ) \qquad ( 34 )$$

The following example shows example parameter values, some of which are taken from FIG. 26A:

$$g = 0.0005 m$$

$${μ}_{o} = 4 π \times {10}^{- 7} Wb / ( A \cdot turn \cdot m )$$

$${μ}_{c} = 0.0036 Wb / ( A \cdot turn \cdot m ) ( @ 1.8 T )$$

$${μ}_{b} = 0.0072 Wb / ( A \cdot turn \cdot m ) ( @ 0.6 T )$$

$${A}_{g}^{o} / {A}_{c} = 3$$

$$w = 0.2 m$$

$${l}_{c} = 0.5 m$$

$$\begin{matrix}\frac{{l}_{c}}{{μ}_{c}} + ( \frac{2 g}{{μ}_{o}} + \frac{w}{{μ}_{b}} ) ( \frac{{A}_{c}}{{A}_{g}^{o}} ) = \frac{{l}_{c}}{{μ}_{c}} + \frac{2 g}{{μ}_{o}} \frac{{A}_{c}}{{A}_{g}^{o}} + \frac{w}{{μ}_{b}} \frac{{A}_{c}}{{A}_{g}^{o}} \\ = \frac{0.5 m}{0.0036 Wb / ( A \cdot turn \cdot m )} + \\ \frac{2 ( 0.0005 m )}{4 π \times {10}^{- 7} Wb / ( A \cdot turn \cdot m )} \frac{1}{3} + \\ \frac{0.2 m}{0.0072 Wb / ( A \cdot turn \cdot m )} \frac{1}{3} \\ = ( 139 + 265 + 9.3 ) \frac{A \cdot turn \cdot {m}^{2}}{Wb}\end{matrix}$$

In this example, the reluctance of the blade is small, the reluctance of the air gap is large, and the reluctance of the core is significant. It should be understood that these values are examples only, and that any other suitable values may be used.
Equation 34 may be reformulated as:

$${( Ni )}_{max} = {B}_{c , max} \frac{1}{p} \frac{2 g}{{μ}_{o}} \qquad ( 35 )$$

where p for the example above is:

$$p ≡ \frac{\frac{2 g}{{μ}_{o}}}{( \frac{{l}_{c}}{{μ}_{c}} + ( \frac{2 g}{{μ}_{o}} + \frac{w}{{μ}_{b}} ) ( \frac{{A}_{c}}{{A}_{g}^{o}} ) )} = \frac{265 \frac{A \cdot turn \cdot {m}^{2}}{Wb}}{( 139 + 265 + 9.3 ) \frac{A \cdot turn \cdot {m}^{2}}{Wb}} = 0.641 \qquad ( 36 )$$

Substituting Equation 35 into Equation 31 gives:

$$f = - ( \frac{{μ}_{o}}{4 g} ) {( {B}_{c , max} \frac{1}{p} \frac{2 g}{{μ}_{o}} )}^{2} \frac{{A}_{c}}{b} ( \frac{{A}_{g}^{o}}{{A}_{c}} ) = - \frac{g}{{μ}_{o}} {( \frac{{B}_{c , max}}{p} )}^{2} \frac{{A}_{c}}{b} ( \frac{{A}_{g}^{o}}{{A}_{c}} ) \qquad ( 37 )$$

The power density of a motor is determined by its average torque and speed. The analysis presented above describes the torque ability of a motor. The volumetric torque density can be calculated as follows:

$$\frac{{T}_{ave}}{V} = \frac{{r}_{f} {f}_{ave}}{π {r}_{o}^{2} {L}^{*}} = \frac{{r}_{f} {n}_{pairs} {θ}_{on} f}{π {r}_{o}^{2} {L}^{*}} \qquad ( 38 )$$

where
r_{f}=radius where force is applied (m)
nₚₐᵢᵣₛ=number of stator pairs
θₒₙ=fraction of the time that a stator pair is on
f=force on a stator pair (and rotor) (N)
rₒ=outer radius of motor (m)

L*=length of unit cell (m)
where the “unit cell” is the repeated unit along the length of the motor. (This concept of the “unit cell” is explained below in greater detail.) Substituting Equation 37 gives:

$$\frac{{T}_{ave}}{V} = \frac{{r}_{f} {n}_{pairs} {θ}_{on}}{π {r}_{o}^{2} {L}^{*}} \frac{g}{{μ}_{o}} {( \frac{{B}_{c , max}}{p} )}^{2} \frac{{A}_{c}}{b} ( \frac{{A}_{g}^{o}}{{A}_{c}} ) \qquad ( 39 )$$

FIG. 26B is a cross-sectional view of round wires 1730 of coil 1704 in a close-packed wire coil configuration, taken along line 26B-26B shown in FIG. 26A. The packing factor P for individual wires 1730 of cross-sectional area Aᵢ is related to the cross-sectional area of the wire bundle forming the coil, A_{w}, as follows:

$$P = \frac{{A}_{i}}{{A}_{w}} = \frac{\frac{1}{2} π {r}_{w}^{2}}{\sqrt{3} {r}_{w}^{2}} = \frac{π}{2 \sqrt{3}} = 0.907 \qquad ( 40 )$$

The number of turns in a wire bundle is:

$$N = P \frac{{A}_{w}}{{A}_{i}} \qquad ( 41 )$$

An individual wire of cross-sectional area Aᵢ has a maximum current capacity iₘₐₓ, which is determined by the electrical conductivity, the heat transfer coefficient, and the allowable temperature rise.

$$\hat{i} = \frac{{i}_{max}}{{A}_{i}} \\ {i}_{max} = \hat{i} {A}_{i} \qquad ( 42 )$$

For 10-gauge copper wire (as an example only), standard tables recommend the following:

$$\hat{i} = \frac{30 A}{5.26 {mm}^{2}} \times {( \frac{1000 mm}{m} )}^{2} = 5.7 \times {10}^{6} A / {m}^{2} \\ ( 10 - gauge wire )$$

Multiplying Equation 41 by Equation 42 gives:

$${( Ni )}_{max} = ( \hat{i} {A}_{l} ) P \frac{{A}_{w}}{{A}_{i}} = \hat{i} {PA}_{w} \qquad ( 43 )$$

Comparison of Equation 43 with Equation 35 shows that the wire bundle cross-sectional area A_{w} is:

$${( Ni )}_{max} = \hat{i} {PA}_{w} = {B}_{c , max} \frac{1}{p} \frac{2 g}{{μ}_{o}} \\ {A}_{w} = \frac{{B}_{c , max}}{\hat{i} P} \frac{1}{p} \frac{2 g}{{μ}_{o}} \qquad ( 44 )$$

### “U-Shaped Blade/U-Shaped Core” Rotor/Stator Configurations

FIG. 33 illustrates a U-shaped blade/U-shaped core rotor/stator configuration 1790 in which a U-shaped blade 1800 slides past a magnetized. U-shaped core 1802 having an energized wire coil 1804, e.g., as shown in FIGS. 14, 15, 17, and 18.

Various example dimensions are shown in FIG. 33. It should be understood that these are example values only, and that the components shown in FIG. 33 may be formed with any other suitable dimensions.

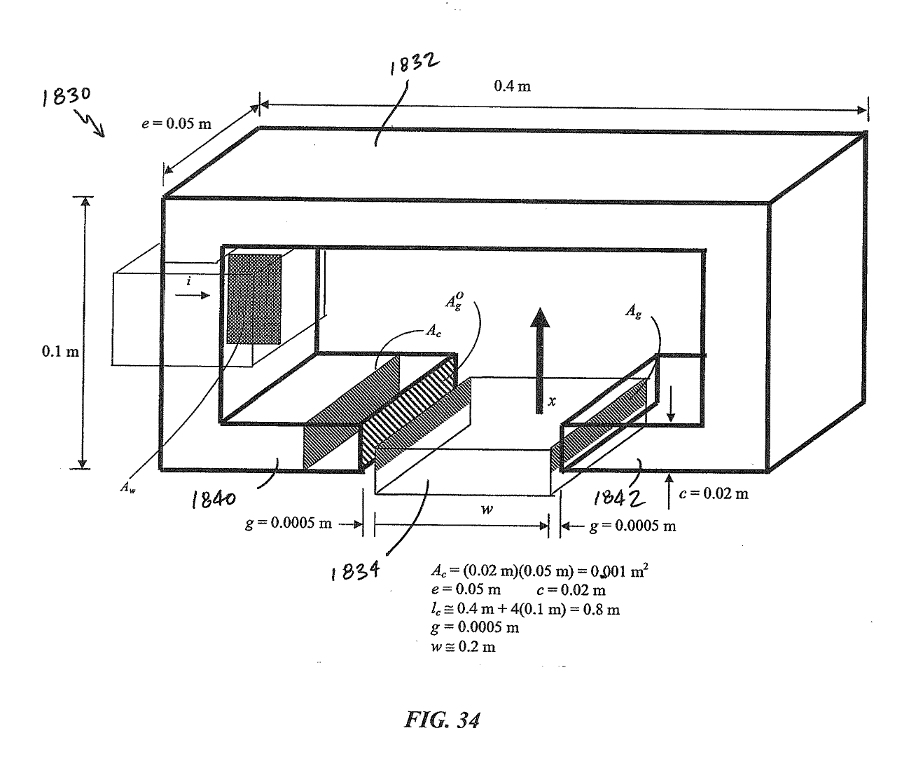

FIG. 34 illustrates a rotor/stator configuration 1830 that is representative of a conventional switched reluctance motor (e.g., as shown in FIGS. 1-2). The configuration includes a U-shaped core (stator) 1832 including first and second legs 1840 and 1842, and a blade (rotor) 1834. In this model, the U-shaped core 1832 represents one half of the stator assembly shown in FIGS. 1-2. Thus, core legs 1840 and 1842 represent opposite stator poles that are simultaneously charged, e.g., stator poles 120G and 120H shown in FIG. 2. Blade 1834 represents rotor 140 shown in FIGS. 1-2, including rotor poles 150G and 150H. The rotation of rotor 140 relative to stator poles 120G and 120H in FIGS. 1-2 may be modeled as linear translation (as indicated by arrow “x” in FIG. 34), as the movement by rotor poles 150G and 150H by stator poles 120G and 120H may be approximated as linear translation.

Various example dimensions are shown in FIG. 34. It should be understood that these are example values only, and that the components shown in FIG. 34 may be formed with any other suitable dimensions.

The analysis of the geometries shown in FIGS. 33 and 34 is very similar to the analysis presented above for the Flat blade/U-shaped core rotor/stator configuration shown in FIG. 26A, except that the flux path through the blades in the configurations of FIGS. 33 and 34 is much longer than in the flat blade configuration of FIG. 26A. In particular, in the U-shaped blade/U-shaped core configuration shown in FIG. 33, the flux path must flow along the complete U-shaped length of the blade. And in the conventional SRM configuration shown in FIG. 34, the flux path must flow across the full length of the rotor (from rotor pole to opposite rotor pole) and around one half of the stator yoke, as shown in FIG. 2.

As a consequence of this increased flux path distance in the configurations of FIGS. 33 and 34, the field lines have the opportunity to spread out over the entire width of the blades, which affects its reluctance. Also, in such configurations, the cross-sectional area of the core, closed air gap, and blades are typically the same, as shown in FIGS. 33 and 34.

A_{c}=A_{g}^{o}=A_{b} (45)

The inductance of the magnetic circuit in such configurations is as follows:

$$L ( x ) = \frac{{N}^{2}}{\frac{{l}_{c}}{{μ}_{c} {A}_{c}} + \frac{2 g}{{μ}_{o} {A}_{g}} + \frac{w}{{μ}_{b} {A}_{c}}} \qquad ( 46 )$$

where
w=flux path the blade (m)
   The instantaneous air gap between the core and blade is:

$${A}_{g} = \frac{x}{c} {A}_{g}^{o} = \frac{x}{c} {A}_{c} \qquad ( 47 )$$

which may be substituted into Equation 46:

$$L ( x ) = \frac{{N}^{2}}{\frac{{l}_{c}}{{μ}_{c} {A}_{c}} + \frac{2 g}{{μ}_{o} \frac{x}{c} {A}_{c}} + \frac{w}{{μ}_{b} {A}_{c}}} = \frac{{N}^{2} {A}_{c}}{\frac{{l}_{c}}{{μ}_{c}} + \frac{2 g}{{μ}_{o} \frac{x}{c}} + \frac{w}{{μ}_{b}}} \qquad ( 48 )$$

The work required to build the magnetic field follows:

$${W}_{fld} = \frac{1}{2} \frac{{N}^{2} {A}_{c}}{\frac{{l}_{c}}{{μ}_{c}} + \frac{2 g}{{μ}_{o} \frac{x}{c}} + \frac{w}{{μ}_{b}}} {i}^{2} = \frac{1}{2} \frac{{( Ni )}^{2} {A}_{c}}{\frac{{l}_{c}}{{μ}_{c}} + \frac{c}{x} ( \frac{2 g}{{μ}_{o}} ) + \frac{w}{{μ}_{b}}} \qquad ( 49 )$$

The following definitions:

$$A ≡ \frac{1}{2} {( Ni )}^{2} {A}_{c} \\ B ≡ \frac{{l}_{c}}{{μ}_{c}} + \frac{w}{{μ}_{b}} ≅ 0 ( if the core and blade are not saturated ) \\ C ≡ \frac{2 gc}{{μ}_{o}} \qquad ( 50 )$$

may be substituted into Equation 49:

$${W}_{fld} = \frac{A}{B + \frac{C}{x}} \qquad ( 51 )$$

The force f acting on the blade as the magnetic flux increases follows:

$$f = - \frac{\partial {W}_{fld}}{\partial x} \qquad ( 52 )$$

Taking the derivative of Equation 51 gives:

$$f = - A \frac{\frac{C}{{x}^{2}}}{{( B + \frac{C}{x} )}^{2}} \qquad ( 53 )$$

If the core and blade are not saturated then Equation 53 simplifies to:

$$f = - \frac{A}{C} = - \frac{\frac{1}{2} {( Ni )}^{2} {A}_{c}}{c ( \frac{2 g}{{μ}_{o}} )} = - ( \frac{{μ}_{o}}{4 g} ) {( Ni )}^{2} \frac{{A}_{c}}{c} \qquad ( 54 )$$

In certain embodiments, to maximize the torque from an electric motor, the core should saturate near x/c=1 (full closure of the air gap between the blade and the core). For the condition of saturation at closure (x/c=1):

φₘₐₓ=B_{c,max}A_{c} (55)

The maximum magnetic flux occurs with the maximum allowable magnetomotive force (Ni)ₘₐₓ.

$${φ}_{max} = \frac{{( Ni )}_{max}}{( \frac{{l}_{c}}{{μ}_{c} {A}_{c}} + \frac{2 g}{{μ}_{o} {A}_{c}} + \frac{w}{{μ}_{b} {A}_{c}} )} \qquad ( 56 )$$

Assume μ_{b}=μ_{c} at x/c=1 (i.e., the core and blade materials are the same). Substituting Equation 55 into Equation 56 gives:

$${B}_{c , max} {A}_{c} = \frac{{( Ni )}_{max}}{( \frac{{l}_{c}}{{μ}_{c} {A}_{c}} + \frac{2 g}{{μ}_{o} {A}_{c}} + \frac{w}{{μ}_{b} {A}_{c}} )} = \frac{{( Ni )}_{max} {A}_{c}}{( \frac{{l}_{c}}{{μ}_{c}} + \frac{2 g}{{μ}_{o}} + \frac{w}{{μ}_{b}} )} \\ {B}_{c , max} = \frac{{( Ni )}_{max}}{( \frac{{l}_{c}}{{μ}_{c}} + \frac{2 g}{{μ}_{o}} + \frac{w}{{μ}_{b}} )} \qquad ( 57 )$$

Equation 57 may be reformulated as

$${( Ni )}_{max} = {B}_{c , max} \frac{1}{p} \frac{2 g}{{μ}_{o}} \qquad ( 58 )$$

where p is:

$$p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} \qquad ( 59 )$$

Substituting Equation 58 into Equation 54 gives:

$$f = - ( \frac{{μ}_{o}}{4 g} ) {( {B}_{c , max} \frac{1}{p} \frac{2 g}{{μ}_{o}} )}^{2} \frac{{A}_{c}}{c} = - \frac{g}{{μ}_{o}} {( \frac{{B}_{c , max}}{p} )}^{2} \frac{{A}_{c}}{c} \qquad ( 60 )$$

The volumetric torque density can be calculated as follows:

$$\frac{{T}_{ave}}{V} = \frac{{r}_{f} {f}_{ave}}{π {r}_{o}^{2} {L}^{*}} = \frac{{r}_{f} {n}_{pairs} {θ}_{on} f}{π {r}_{o}^{2} {L}^{*}} = \frac{{r}_{f} {n}_{pairs} {θ}_{on}}{π {r}_{o}^{2} {L}^{*}} \frac{g}{{μ}_{o}} {( \frac{{B}_{c , max}}{p} )}^{2} \frac{{A}_{c}}{c} \qquad ( 61 )$$

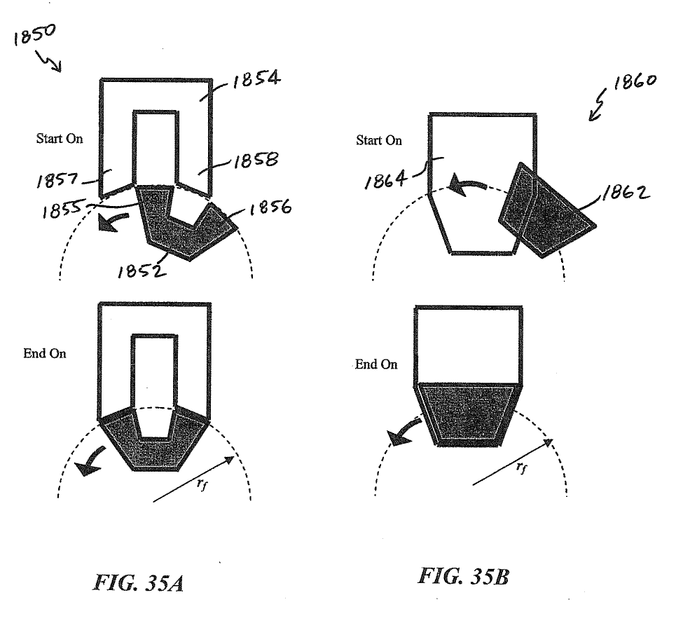

FIGS. 35A and 35B illustrate two examples of how the linear motion described in FIGS. 26A and 33 can be converted to rotary motion. FIG. 35A illustrates a U-shaped blade/U-shaped core rotor/stator configuration 1850 including a U-shaped blade 1852 positioned on a rotor that rotates relative to a U-shaped stator 1854. The U-shaped blade 1852 includes a pair of legs 1855 and 1856, and the U-shaped core 1854 includes a pair of legs 1857 and 1858. The core is charged (indicated at “Start On”) when the blade legs 1855 and 1856 approach the core legs 1857 and 1858, and turned off (indicated at “End. On”) when the blade legs 1855 and 1856 are aligned with the core legs 1857 and 1858.

FIG. 35B illustrates a flat blade/U-shaped core rotor/stator configuration 1860 including a flat blade 1862 positioned on a rotor that rotates relative to a U-shaped core 1864. Flat blade 1862 passes between two legs of U-shaped core 1864, e.g., as shown in FIGS. 5-13 and 26A. Core 1864 is charged (indicated at “Start On”) when blade 1862 is at some predefined angular orientation relative to core 1864, and turned off (indicated at “End On”) when blade 1862 is aligned with core 1864.

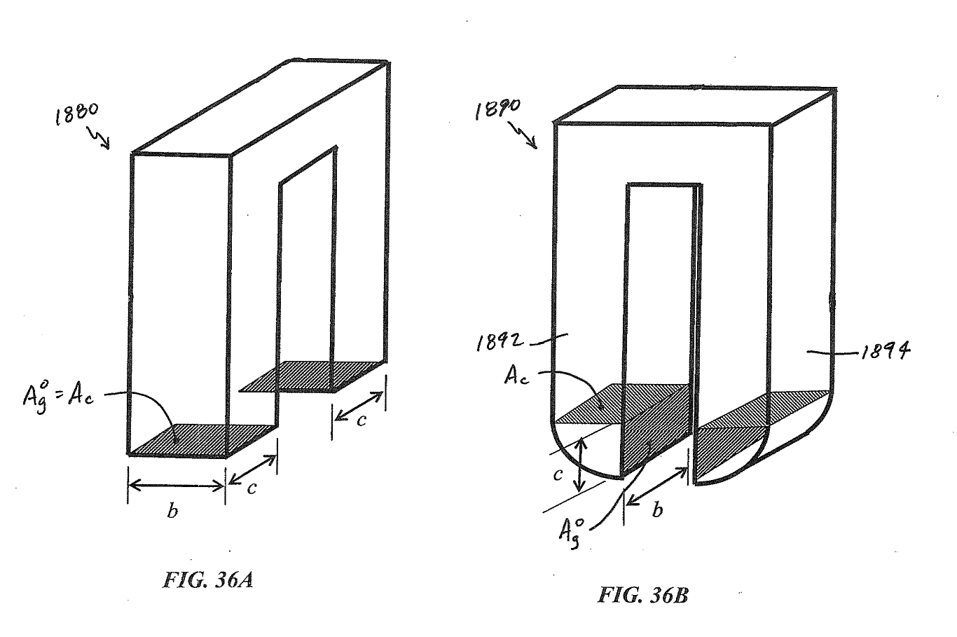

FIGS. 36A and 36B illustrate the orientation of the U-shaped cores, or stators, in the configurations of FIGS. 33 and 26A, respectively. The geometries are generally similar, except rotated relative to each other by 90 degrees. In particular,

FIG. 36A illustrates a U-shaped core 1880 of the U-shaped blade/U-shaped core configuration of FIG. 33, wherein a U-shaped blade passes by the two ends of U-shaped core 1880, but not between the two legs of U-shaped core 1880. In contrast, FIG. 36B illustrates a U-shaped core 1890 of the flat blade/U-shaped core configuration of FIG. 26A, wherein a flat blade passes through legs 1892 and 1894 of U-shaped core 1890.

Laminations of Stator and/or Rotor Components

In some embodiments, all or certain portions of the stator and/or rotor may be formed in a laminar manner, which may act to channel the magnetic flux in the direction of the laminar layers, thus reducing undesirable eddy currents.

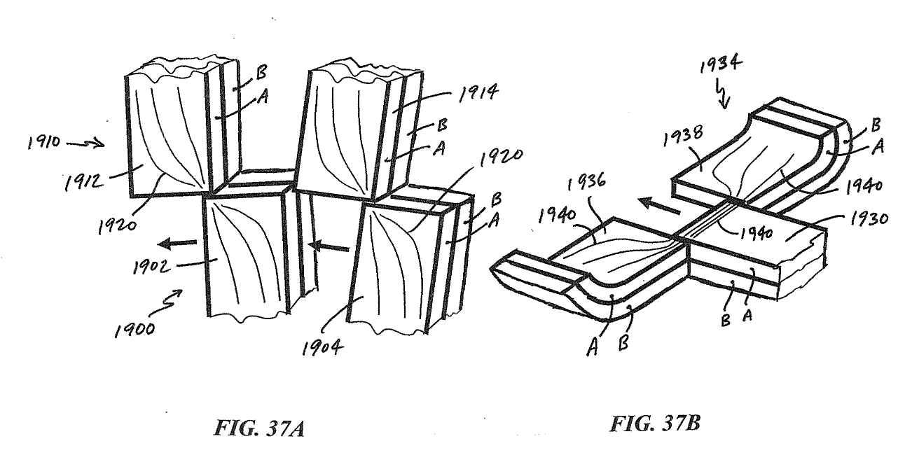

FIGS. 37A and 37B illustrate example orientations for laminating blade and core components for various rotor/stator configurations disclosed herein, according to certain embodiments. FIG. 37A illustrates a U-shaped blade/U-shaped core configuration including a U-shaped blade 1900 including first and second legs 1902 and 1904, and a U-shaped core 1910 including first and second legs 1912 and 1914. Each of blade legs 1902 and 1904 and core legs 1912 and 1914 may be formed with laminations aligned in parallel planes. Although FIG. 37A shows two lamination layers A and B, it should be understood that any suitable number of layers may be used. FIG. 37A also illustrates magnetic flux lines 1920 flowing between lamination layer A of stator leg 1912 and rotor leg 1902, and between lamination layer A of stator leg 1914 and rotor leg 1904.

FIG. 37B illustrates a flat blade/U-shaped core configuration including a flat blade 1930 and a U-shaped core 1934 including first and second legs 1936 and 1938. As discussed above, in such configurations the flat blade 1930 passes in the direction of the arrow through the gap defined between first and second legs 1936 and 1938 of U-shaped core 1934. Blade 1930 and core legs 1936 and 1938 may be formed with laminations aligned as shown in FIG. 37B. Although FIG. 37B shows two lamination layers A and B, it should be understood that any suitable number of layers may be used. FIG. 37B also illustrates magnetic flux lines 1940 in lamination layer A flowing between stator legs 1936 and 1938 through blade 1930.

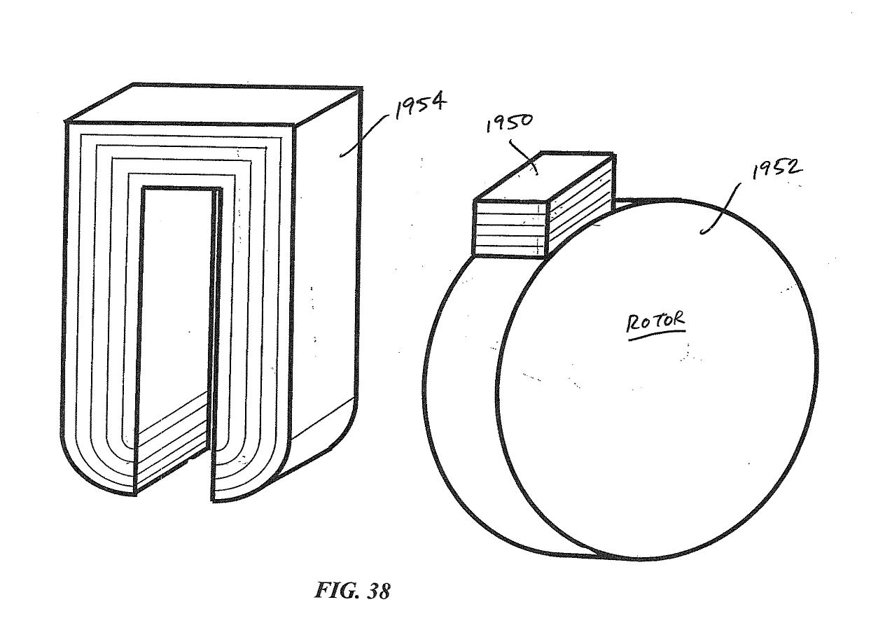

FIG. 38 illustrates an example orientation for laminating blade and core components for a flat blade/U-shaped core rotor/stator configuration, according to certain embodiments. FIG. 38 is generally similar to FIG. 37B, but shows the full U-shaped core, the rotor to which the flat blade is connected, and additional lamination layers. As shown in FIG. 38, a flat blade 1950 connected to a rotor 1952, and a U-shaped core 1954 may include multiple lamination layers aligned in a similar manner as shown in FIG. 37B.

In this example, flat blade 1950 has a laminar structure in which the layers are generally formed in planes perpendicular to a plane about which rotor 1952 rotates (i.e., a plane defined by a pattern traced by a point on flat blade 1950 as rotor 1952 rotates). Also, U-shaped core 1954 has a laminar structure that generally bends around the U-shaped length of the core. In this example, the laminar structure turns inward toward the end portion of each stator leg. Thus, with such configuration, the lamination layers of flat blade 1950 are aligned generally parallel with the lamination layers exposed at the ends of the two stator legs when flat blade 1950 passes between the stator legs. Thus, the magnetic flux may be channeled through flat blade 1950 from one stator leg to the other, and eddy currents may be reduced.

In this example, flat blade 1950 and U-shaped core 1954 each include five lamination layers. Again, it should be understood that any suitable number of layers may be used.

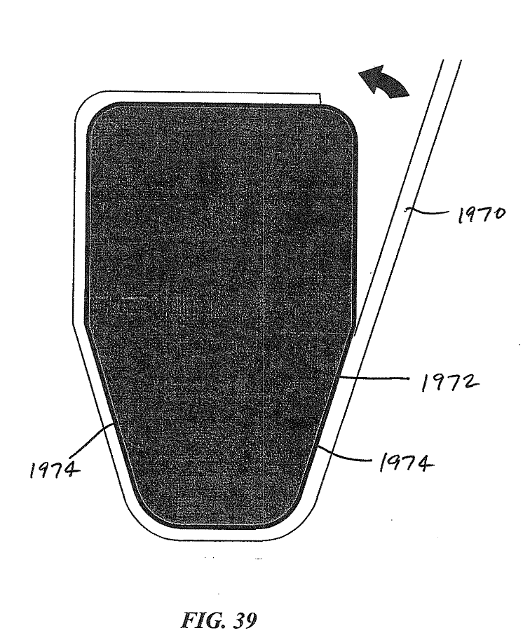

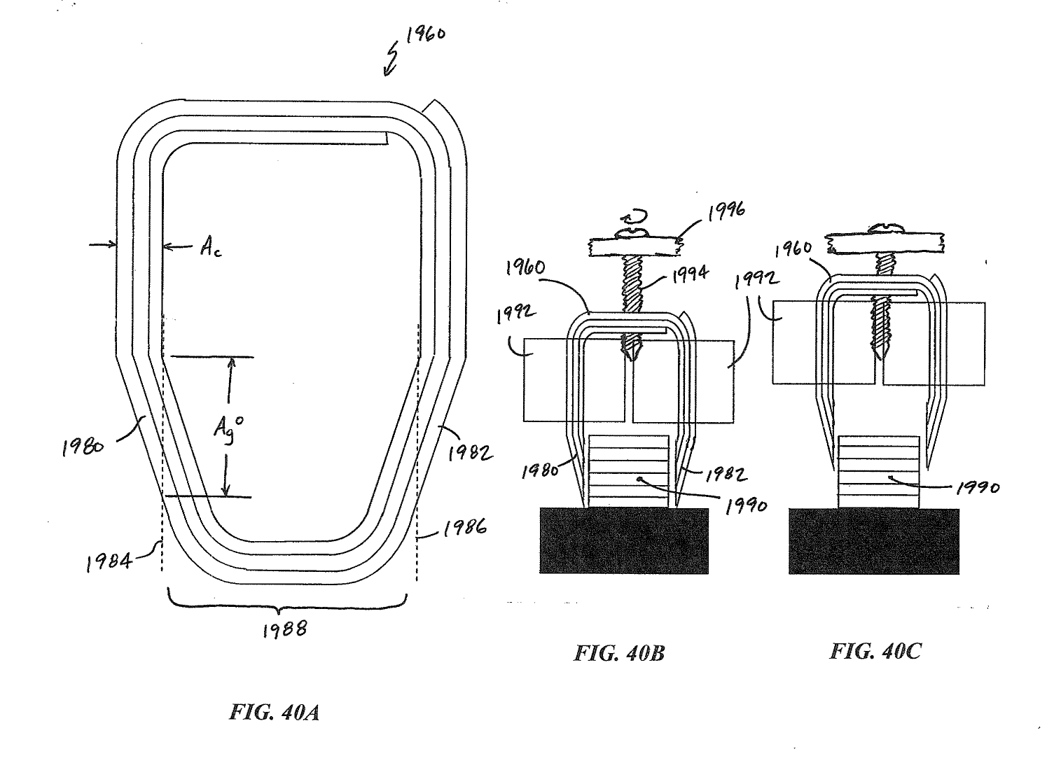

FIGS. 39 and 40A-40C illustrate an example technique for forming and utilizing a laminar U-shaped stator 1960 having an area ratio A_{g}^{o}/A_{c}>1, according to certain embodiments. FIG. 39 illustrates a laminar material 1970 being wrapped around a mandrel 1972. Mandrel 1972 may have one or more angled portions 1974, which facilitate the formation of a U-shaped stator 1960 having an area ratio A_{g}^{o}/A_{c}>1, as discussed below.

The laminar material 1970 may be wrapped around mandrel 1972 any desired number of times to form any desired number of lamination layers. For example, as shown in FIG. 40A, laminar material 1970 may be wrapped around mandrel 1972 to form three layers. The layered structure may then be cut to define the two stator legs 1980 and 1982 and the gap between the stator legs 1980 and 1982. For example, the layered structure may then be cut along lines 1984 and 1986, and the remaining portion 1988 may be removed. In some embodiments, e.g., as shown in FIG. 40A, the layered structure may be cut at a non-right angle in order to create an exposed area A_{g}^{o} that is larger than the cross-sectional area A_{c} of the stator legs. In this manner, U-shaped stator 1960 having an area ratio A_{g}^{o}/A_{c}>1 may be formed.

FIGS. 40B and 40C illustrate the laminar U-shaped stator pair 1960 in use in a flat blade/U-shaped core rotor/stator configuration including a laminar flat blade 1990 configured to pass between legs 1980 and 1982 of U-shaped stator pair 1960, and a pair of wire coils 1992 wrapped around stator pair 1960. U-shaped stator pair 1960 may be axially adjusted toward or away from blade 1990 (e.g., toward or away from a center point about which the rotor rotates) in order to adjust a distance between a point on stator pair 1960 and a point on rotor blade 1990. By adjusting the distance between stator pair 1960 and rotor blade 1990, the maximum area of overlap between stator pair 1960 and blade 1990 (e.g., during full closure) may be controlled. U-shaped stator pair 1960 may be adjusted in any suitable manner, e.g., using a screw 1994 connected to a stator yoke or support structure 1996, or any other suitable adjustment mechanism.

In alternative embodiments, the position of rotor blade 1990 may be axially adjusted toward or away from stator pair 1960 (e.g., toward or away from a center point about which the rotor rotates) in order to adjust a distance between a point on stator pair 1960 and a point on rotor blade 1990. In such embodiments, rotor blade 1990 may be adjusted in any suitable manner, e.g., using a screw connected to a rotor yoke or support structure, or any other suitable adjustment mechanism.

In other embodiments, the positions of both stator pair 1960 and rotor blade 1990 may be independently adjusted.

FIG. 40B shows U-shaped stator pair 1960 adjusted such that blade 1990 fully overlaps with the exposed area of stator legs 1980 and 1982, which maximizes A_{g}. This configuration may allow for the maximum flux density in core 1960, which maximizes the torque for a given Ni. FIG. 40C shows U-shaped stator pair 1960 adjusted outward in the radial direction (e.g., using screw 1994), which reduces A_{g} and reduces the torque for a given Ni. In this manner, the position of each U-shaped stator pair 1960 in the motor may be mechanically adjusted to alter the torque output of the electric motor for a given Ni, as desired.

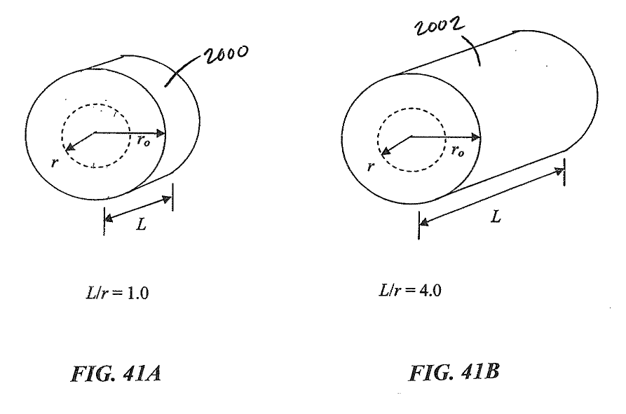

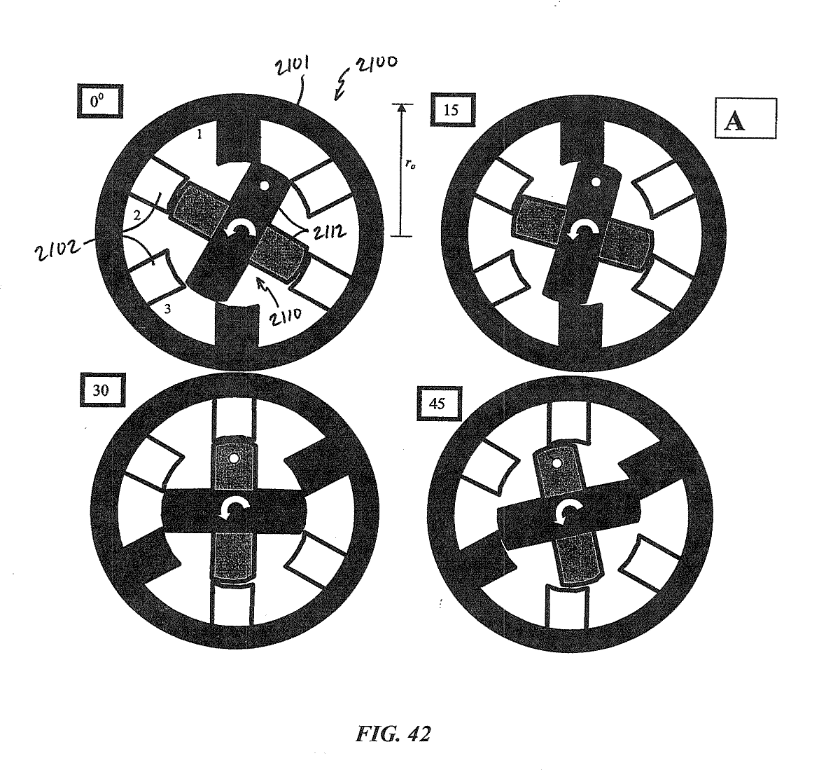

FIG. 41 illustrates two different rotor/stator motor housings 2000 and 2002 having housing aspect ratios L/r of 1.0 and 4.0, respectively. Housing aspect ratios L/r ranging from 1.0 to 4.0 are used in the analysis presented below. The following example dimensions are used to illustrate these aspect ratios:
r=0.50 m
r₀=varies as required
L=0.50 m
L=2.0 m

### Analysis of Various Rotor/Stator Configuration Options

Various rotor/stator configuration options are analyzed and compared below. In particular, the torque density and power density generated by various rotor/stator configuration options are calculated and compared as described below.

### Rotor/Stator Configuration Option A: Traditional Switched Reluctance Motor (SRM)

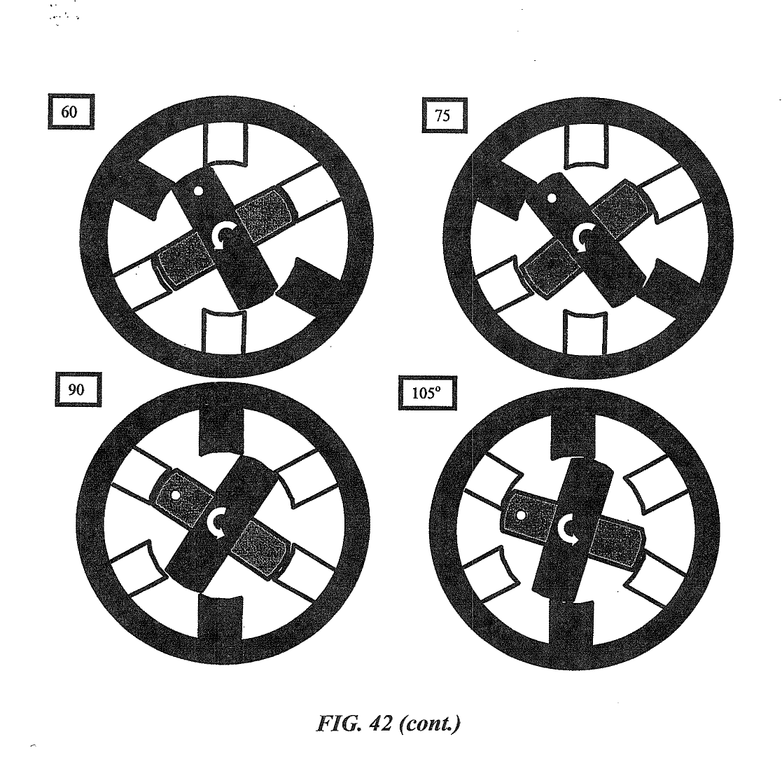

FIG. 42 illustrates a traditional 6/4 switched reluctance motor 2100 including a stator 2101 with six stator poles 2102 and a rotor 2110 with four rotor poles 2112. Opposite stator pole pairs are energized sequentially (currently energized stator poles are indicated with dark shading) and the rotor 2110 completes the magnetic circuit. As magnetic flux increases in the magnetic circuit, rotary torque is produced that drives rotor 2130. FIG. 42 illustrates eight positions of rotor 2110 at 15 degree increments to show the rotation of rotor 2110.

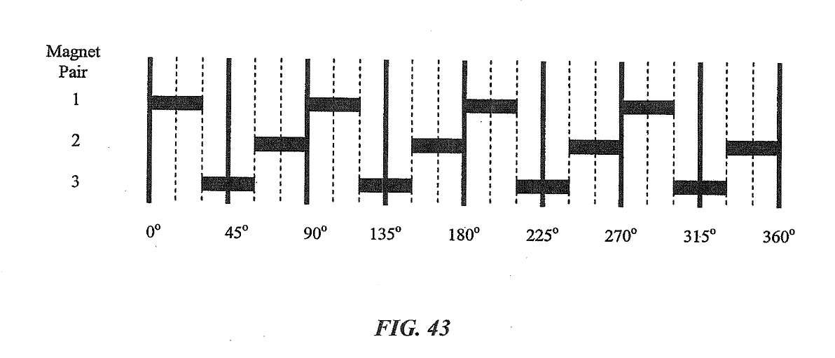

FIG. 43 corresponds to FIG. 42 and illustrates the sequence that each of the three stator pairs 1-3 is fired throughout the 360 degree rotation of rotor 2110. Each stator pair is on for 2/6 of the time (θₒₙ=0.3333), and there are three stator pairs (nₚₐᵢᵣₛ=3). One drawback to the traditional SRM is that only one pair of stators can be energized at any given time.

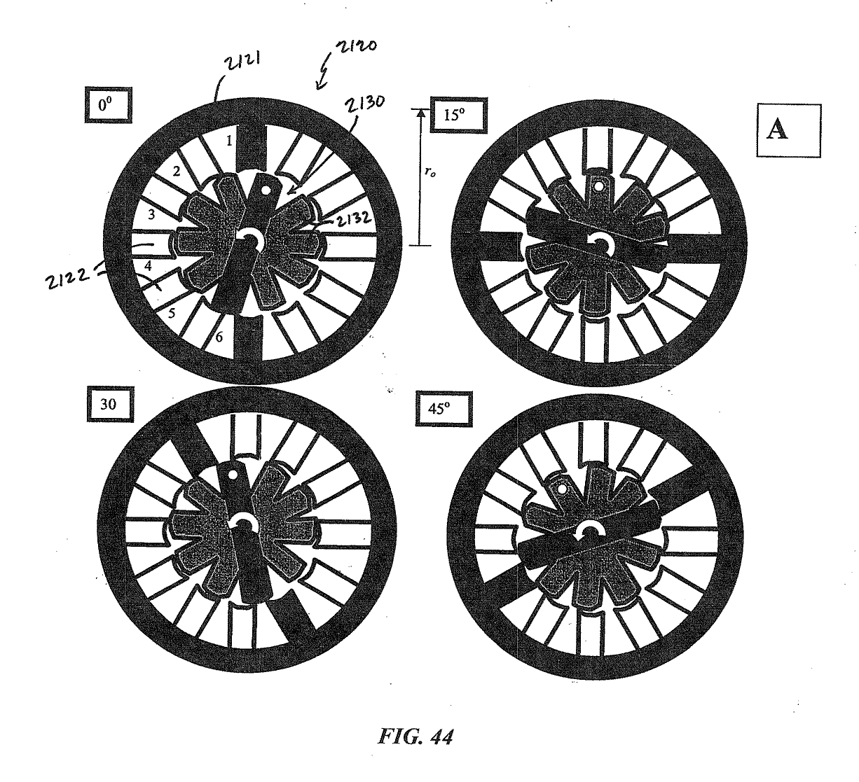

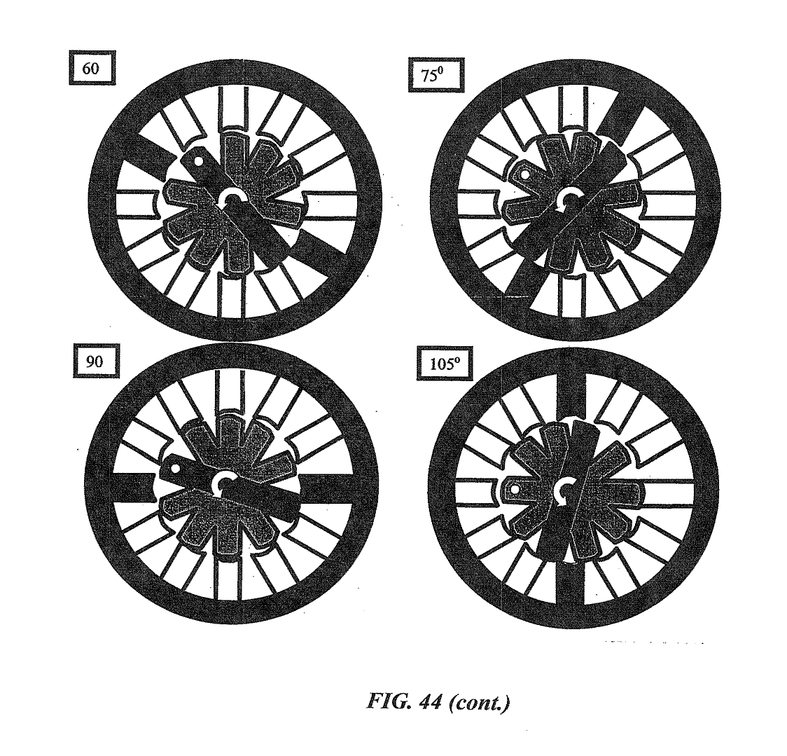

FIG. 44 illustrates a traditional 12/10 switched reluctance motor 2120 including a stator 2121 with 12 stator poles 2122 and a rotor 2130 with 10 rotor poles 2132. As with the 6/4 motor 2100, opposite stator pole pairs in the 12/10 motor are energized sequentially (currently energized stator poles are indicated with dark shading) and rotor 2130 completes the magnetic circuit. As magnetic flux increases in the magnetic circuit, rotary torque is produced that drives rotor 2130. FIG. 44 illustrates eight positions of rotor 2130 at 15 degree increments to show the rotation of rotor 2130.

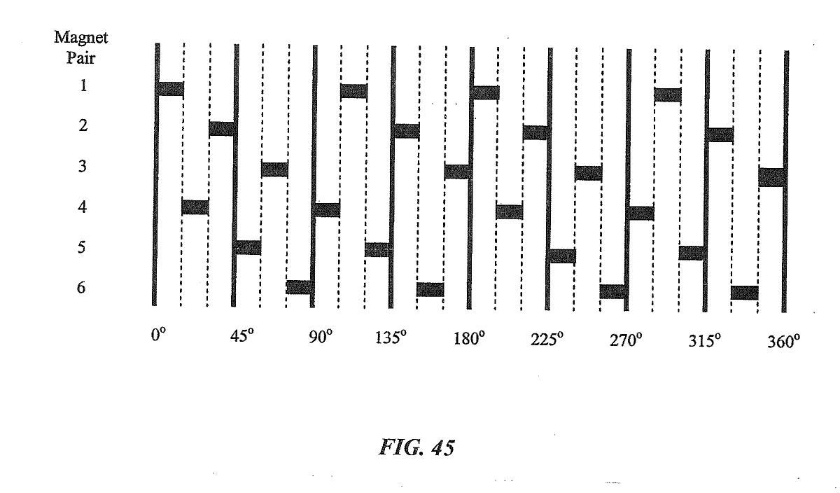

FIG. 45 corresponds to FIG. 44 and illustrates the sequence that each of the six stator pairs 1-6 is fired throughout the 360 degree rotation of rotor 2130. Each stator pair is on for ⅙ of the time (θₒₙ=0.166667) and there are six stator pairs (nₚₐᵢᵣₛ=6). Notice that in general, the product θₒₙnₚₐᵢᵣₛ=1.

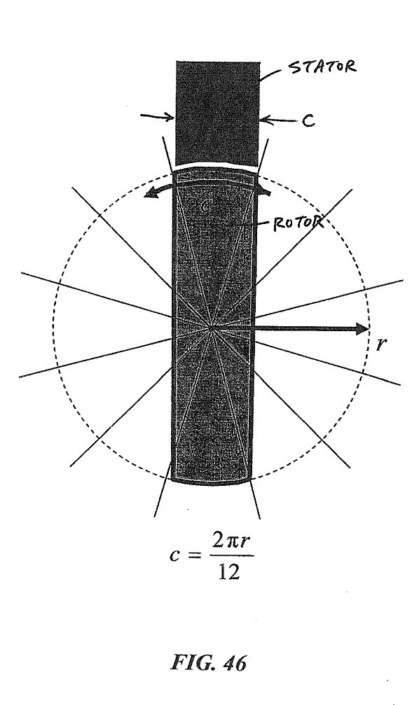

FIG. 46 illustrates a geometry of a 6/4 switched reluctance motor. As shown, for a 6/4 switched reluctance motor, the rotor and stator width c may be defined as:

$$c = \frac{2 π r}{12} \qquad ( 62 )$$

For 12/10 and 24/22 switched reluctance motors, the denominators are 24 and 48, respectively (instead of 12).

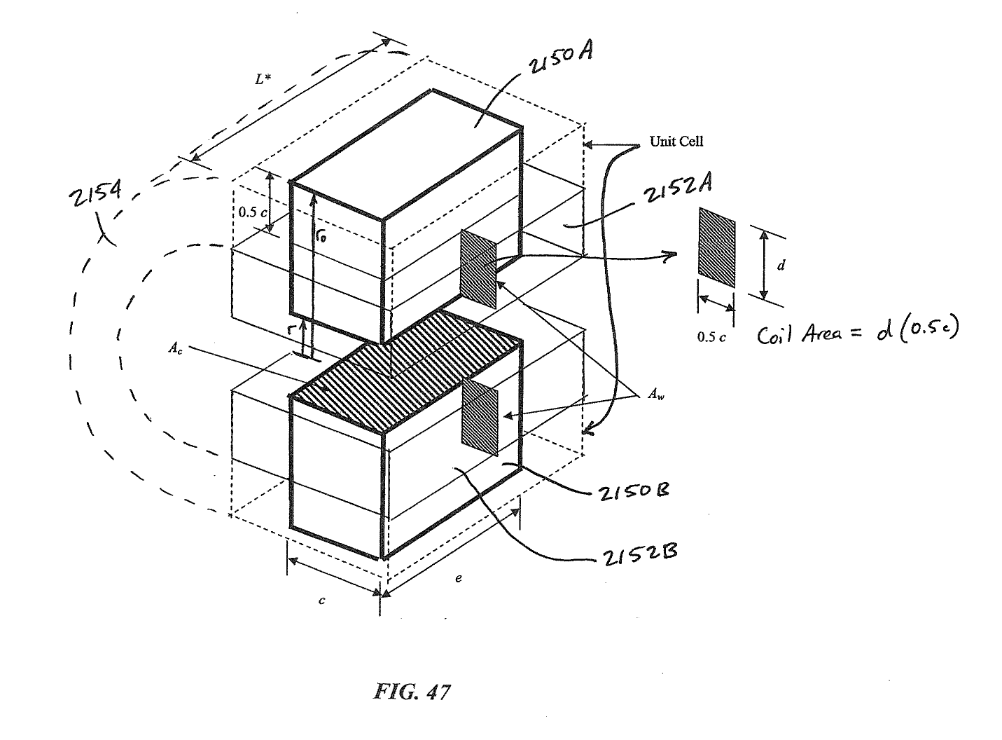

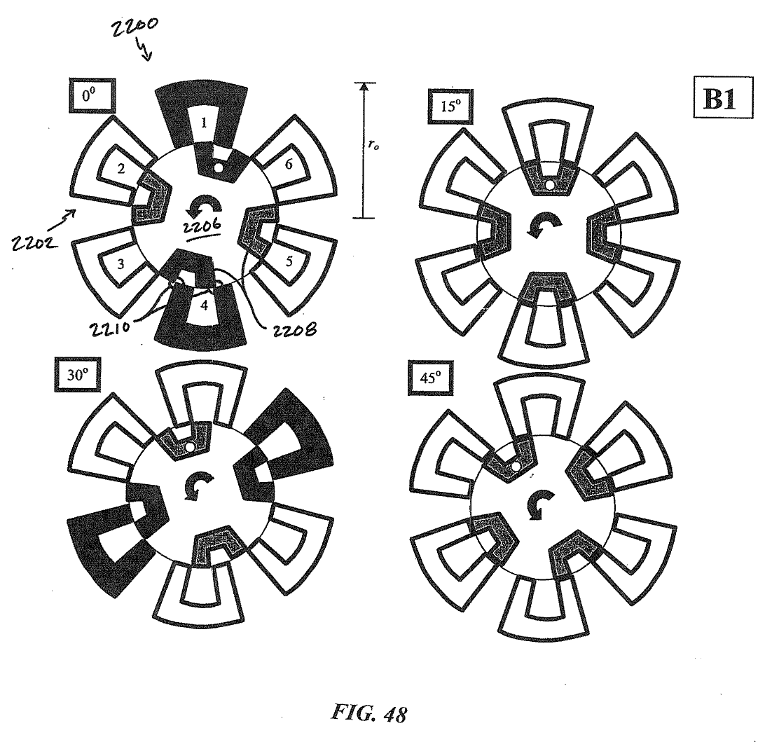

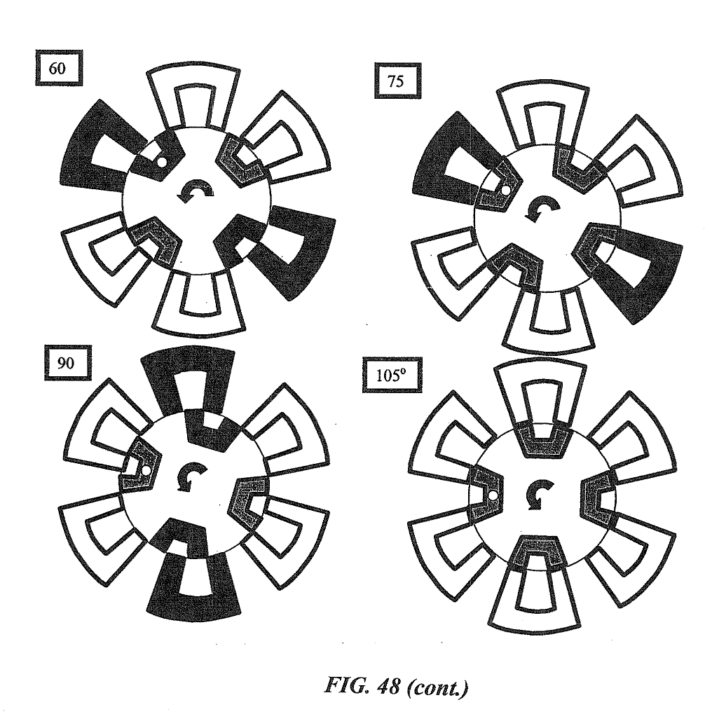

FIG. 47 illustrates a “unit cell” for a stator pair of a standard switched reluctance motor (e.g., as shown in FIGS. 1-2, 42, and 44). As used herein, a “unit cell” is the minimum geometry that includes the features of a stator pair for generating a magnetic circuit. For example, in a standard SRM configuration (i.e., a long-flux configuration), a “unit cell” includes a pair of stator poles on opposite sides of the rotor, as well as the wire bundles (coils) for energizing the pair of stator poles. In contrast, as discussed below, for short-flux configurations including U-shaped stator pairs, a “unit cell” includes a single U-shaped stator pair, along with the wire bundles (coils) for energizing the U-shaped stator pair. The “unit cell” allows for a fair comparison of different rotor/stator configuration options.

As shown in FIG. 47, the “unit cell” for the standard SRM configuration includes a pair of opposite stator poles 2150A and 2150B including the wire bundles (coils) 2152A and 2152B needed to provide the magnetomotive force. FIG. 47 also indicates one-half of the circular stator yoke 2154 (in dashed lines) to provide context for the stator pair. The semi-circular half yoke is not part of the unit cell.

The area of the core A_{c} relative to the surface area of the rotor Aᵣ at radius r follows:

$$\begin{matrix}\frac{{A}_{c}}{{A}_{r}} = \frac{ce}{2 ( c + 2 ( 0.5 c ) ) ( e + 2 ( 0.5 c ) )} = \frac{ce}{2 ( 2 c ) ( e + c )} \\ = \frac{e}{4 ( e + c )} \\ = \frac{e \frac{1}{c}}{4 ( e + c ) \frac{1}{c}} \\ = \frac{e / c}{4 ( e / c + 1 )}\end{matrix} \qquad ( 63 )$$

The core area A_{c} can be calculated as:

$${A}_{c} = ( \frac{{A}_{c}}{{A}_{r}} ) {A}_{r} = ( \frac{e / c}{4 ( e / c + 1 )} ) 2 π {rL}^{*} \qquad ( 64 )$$

where
r=radius of rotor (m)
L*=length of unit cell (m)
   Substituting Equation 64 into Equation 61 provides:

$$\frac{{T}_{ave}}{V} = \frac{{r}_{f} {n}_{pairs} {θ}_{on}}{π {r}_{0}^{2} L *} \frac{g}{{μ}_{o}} {( \frac{{B}_{c , max}}{p} )}^{2} \frac{( \frac{e / c}{4 ( e / c + 1 )} ) 2 π {rL}^{*}}{c} \qquad ( 65 )$$

For this geometry, r=r_{f}

$$\frac{{T}_{ave}}{V} = {n}_{pairs} {θ}_{on} \frac{{r}^{2}}{{r}_{o}^{2}} \frac{g}{{μ}_{o}} {( \frac{{B}_{c , max}}{p} )}^{2} \frac{1}{c} \frac{e / c}{2 ( e / c + 1 )} \qquad ( 66 )$$

where p is:

$$p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} = \frac{\frac{2 g}{{μ}_{o}}}{( \frac{π {r}_{o} + 2 d}{{μ}_{c}} + \frac{2 g}{{μ}_{o}} + \frac{2 r}{{μ}_{b}} )} \qquad ( 66 a )$$

FIG. 47 shows that the outer radius rₒ is related to the height of the wire bundle d as follows:

rₒ=r+d+0.5c (67)

From Equation 44, an expression for d follows:

$$d = \frac{{A}_{w}}{0.5 c} = \frac{1}{0.5 c} \frac{{B}_{c , max}}{\hat{i} P} \frac{1}{p} \frac{2 g}{{μ}_{o}} \qquad ( 68 )$$

The length of a unit cell is the same as the overall length of the motor:

L*=L (69)

FIG. 47 shows that length e:

e=L*−2(0.5c) (70)

### Rotor/Stator Configuration Option B1: U-Shaped Blade/U-Shaped Core

FIG. 48 illustrates rotor/stator configuration Option B1, which is a U-shaped blade/U-shaped core configuration, according to certain embodiments. The illustrated example is a 12/8 configuration, analogous to a standard 6/4 switched reluctance motor. The rotor/stator configuration 2200 includes a stator 2202 with six U-shaped stator pairs 1-6 and a rotor 2206 with four U-shaped blades 2208. Opposite stator pairs 1-6 are energized sequentially (currently energized stators are indicated with dark shading) and the relevant U-shaped blades 2208 complete the magnetic circuits. FIG. 48 illustrates eight positions of rotor 2206 at 15 degree increments to show the rotation of rotor 2206. In some embodiments, each U-shaped stator pair 1-6 is turned on (i.e., energized) when there is a slight overlap between (a) the leading corners of the two legs of the U-shaped rotor blade 2208 coming into alignment with that particular stator and (b) the two legs of the particular stator. These areas of overlap between stator pair 1 and the approaching U-shaped rotor blade 2208 are indicated in FIG. 48 at 2210.

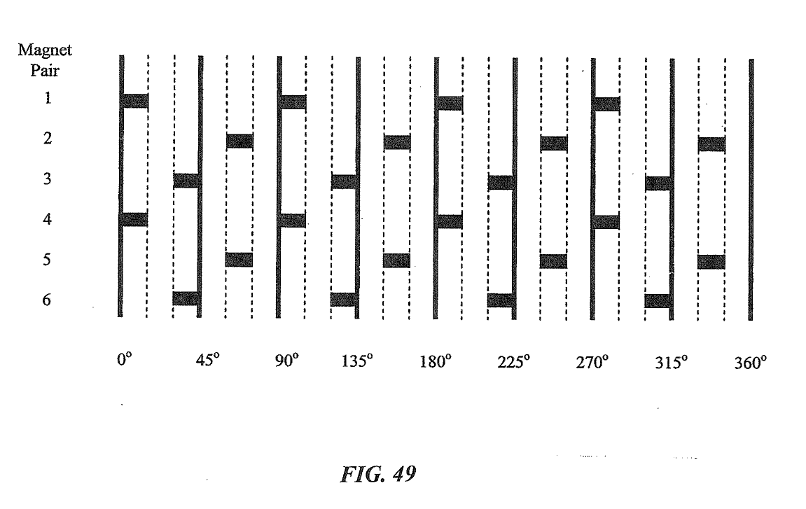

FIG. 49 corresponds to FIG. 48 and illustrates the sequence that each of the six U-shaped stator pairs 1-6 is fired throughout the 360 degree rotation of rotor 2206. Each stator pair is on for ⅙ of the time (θₒₙ=0.16666), and there are six stator pairs (nₚₐᵢᵣₛ=6). As shown in FIG. 49, during every other interval, none of the stator pairs are firing.

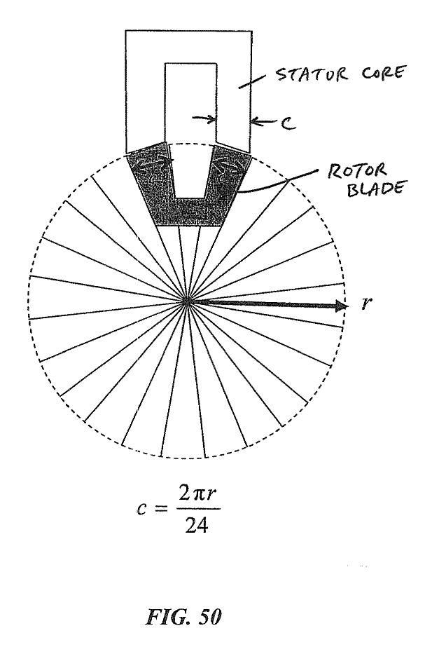

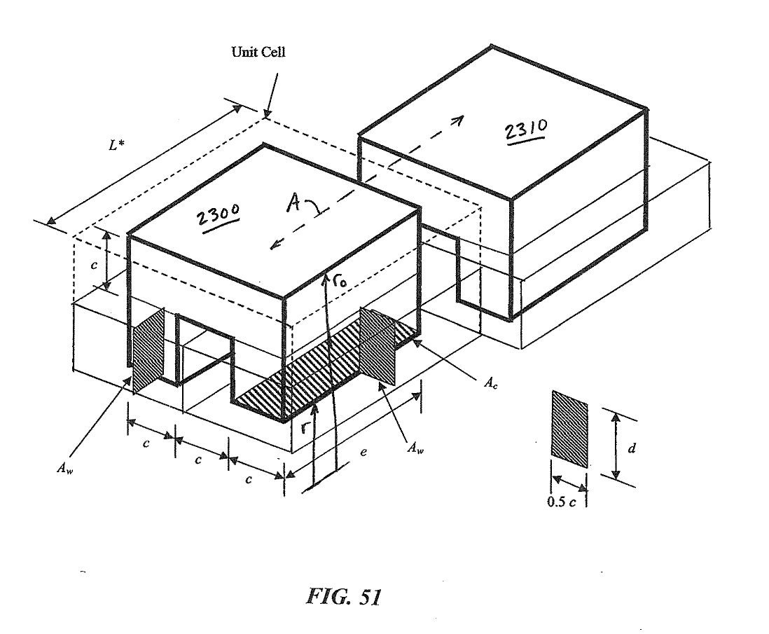

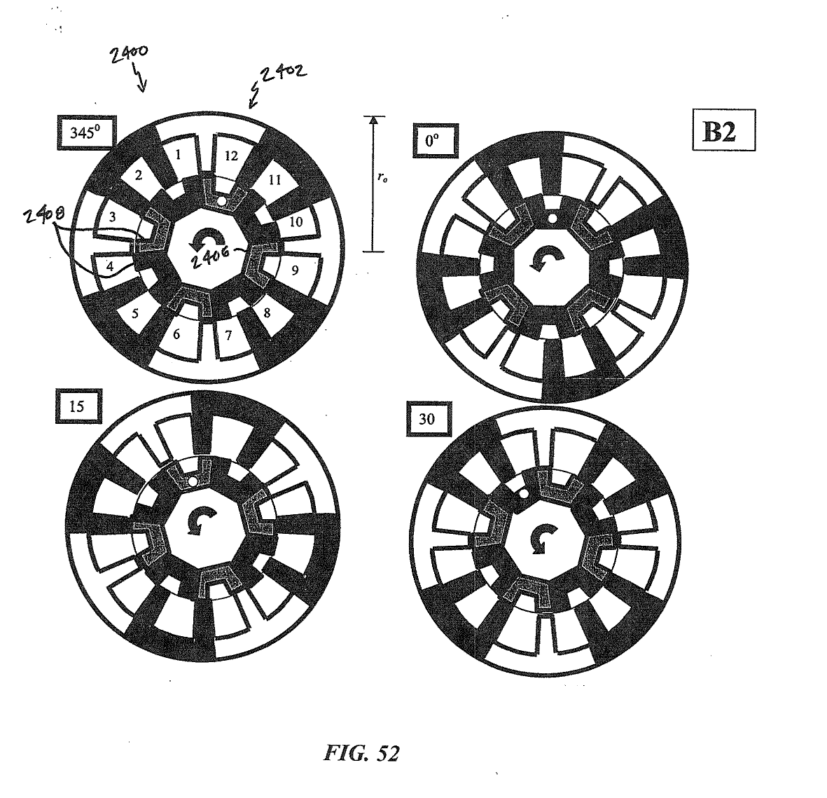

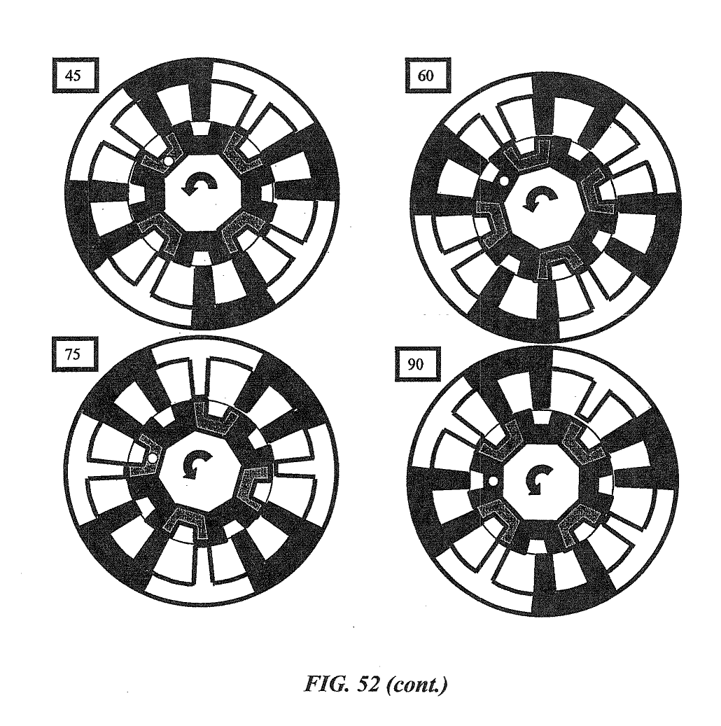

FIG. 50 illustrates a geometry of a 12/8 U-shaped blade/U-shaped core configuration, e.g., as shown in FIG. 48. In such configuration, the rotor and stator width c may be defined as:

$$c = \frac{2 π r}{24} \qquad ( 71 )$$

FIG. 51 illustrates a “unit cell” for a U-shaped stator pair 2300 for use in a U-shaped blade/U-shaped core rotor/stator configuration, e.g., as shown in FIG. 48. The unit cell includes the wire bundle (coil) needed to provide the magnetomotive force. The area of the core A_{c} relative to the surface area of the rotor Aᵣ at radius r follows:

$$\frac{{A}_{c}}{{A}_{r}} = \frac{ce}{4 c ( e + c )} = \frac{e}{4 ( e + c )} = \frac{e \frac{1}{c}}{4 ( e + c ) \frac{1}{c}} = \frac{( e / c )}{4 ( e / c + 1 )} \qquad ( 72 )$$

The core area A_{c} can be calculated as:

$${A}_{c} = ( \frac{{A}_{c}}{{A}_{r}} ) {A}_{r} = ( \frac{( e / c )}{4 ( e / c + 1 )} ) 2 π {rL}^{*} \qquad ( 73 )$$

where
r=radius of rotor (m)
L*=length of unit cell (m)
   Substituting Equation 73 into Equation 61 gives the torque density:

$$\frac{{T}_{ave}}{V} = \frac{{r}_{f} {n}_{pairs} {θ}_{on}}{π {r}_{o}^{2} {L}^{*}} \frac{g}{{μ}_{o}} {( \frac{{B}_{c , max}}{p} )}^{2} \frac{( \frac{( e / c )}{4 ( e / c + 1 )} ) 2 π {rL}^{*}}{c} \qquad ( 74 )$$

For this geometry, r=r_{f} (where r_{f} is the effective radius at which the torque is applied)

$$\frac{{T}_{ave}}{V} = {n}_{pairs} {θ}_{on} \frac{{r}^{2}}{{r}_{o}^{2}} \frac{g}{{μ}_{o}} {( \frac{{B}_{c , max}}{p} )}^{2} \frac{1}{c} \frac{( e / c )}{2 ( e / c + 1 )} \qquad ( 75 )$$

where p is:

$$p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} = \frac{\frac{2 g}{{μ}_{o}}}{( \frac{\frac{2 π {r}_{o}}{{n}_{stators}} + 2 d}{{μ}_{c}} + \frac{2 g}{{μ}_{o}} + \frac{\frac{2 π r}{{n}_{stators}}}{{μ}_{b}} )} \qquad ( 75 a )$$

As shown in the unit cell (FIG. 51):

r₀=r+d+c (76)

From Equation 44, an expression for d follows:

$$d = \frac{{A}_{w}}{0.5 c} = \frac{1}{0.5 c} \frac{{B}_{c , max}}{\hat{i} P} \frac{1}{p} \frac{2 g}{{μ}_{o}} \qquad ( 77 )$$

The parameter e depends upon the length and the number of stator sets provided along the axis indicated by arrow A.

As discussed above, FIG. 49 indicates that half the time, no torque is applied to the rotor, which in some embodiments or applications may cause the rotor to “cog.” Thus, multiple staggered stator sets may be provided to eliminate the periods of no-torque. For example, as shown in FIG. 51, a first set of U-shaped stators (extending around a perimeter of the motor) including U-shaped stator 2300 may be complemented by a second set of U-shaped stators including U-shaped stator 2310 offset rotationally offset from the first set of U-shaped stators about the first axis of rotation of the rotor. The second stator set may be rotationally offset from the first stator set by any suitable degree. For example, where the first stators are arranged around a perimeter at intervals of x degrees, the second stator set may be rotationally offset from the first stator set about the axis of rotation by x/2 degrees. Similarly, where three stator sets are used, each second stator set may be rotationally offset from each other by x/3 degrees. And so on. It should be understood that these are only example configurations, and any suitable number of stator sets and degree offset of each stator set may be used according to the application and desired performance.

In the example configuration shown in FIG. 51 including two staggered stator sets, the motor length must be divided into two parts; i.e.

L*=½L (78)

As shown in the unit cell (FIG. 51):

e=L*−2(0.5c) (79)

Rotor/Stator Configuration Option B2: U-Shaped Blade/U-Shaped Core with Double Number of Rotors and Stators

FIG. 52 illustrates rotor/stator configuration. Option B2, which is a U-shaped blade/U-shaped core configuration, according to certain embodiments. Option B2 is similar to the 12/8 configuration of Option B1, but with double the number of rotor blades and stator pairs as Option B1. The rotor/stator configuration 2400 of FIG. 52 includes a stator 2402 with 12 U-shaped stator pairs 1-12 and a rotor 2406 with eight U-shaped blades 2408.

In the example embodiment shown in FIG. 52, each U-shaped stator pair shares one of its stator legs with the adjacent U-shaped stator pair to the right, and shares its other stator leg with the adjacent U-shaped stator pair to the left. Thus, each of the 12 stator legs of stator 2402 is shared by two U-shaped stator pairs. A wire coil may be formed around each of the 12 stator legs. The wire coil around each leg may be used for energizing each of the two U-shaped stator pairs that shares that leg. For example, the around the leg shared by U-shaped stator pairs 2 and 3 shown in FIG. 52 includes a wire coil that may be energized (a) along with the coil on adjacent stator leg to the left in order to energize U-shaped stator pair 2 (as shown in the snapshot at 345 degrees rotation), and (a) along with the coil on the adjacent stator leg to the right in order to energize U-shaped stator pair 3 (as shown in the snapshot at 15 degrees rotation).

Opposite stator pairs 1-12 are energized sequentially (currently energized stators are indicated with dark shading) and the relevant U-shaped blades 2408 complete the magnetic circuits. The configuration of FIG. 52 generally allows more stator pairs to be energized at a given time, as compared with certain other configurations. For example, while some other configurations are limited to two stator pairs being energized at a time, the configuration of FIG. 52 allows more than two stator pairs to be energized at a time. In an example operation of the configuration of FIG. 52, two groups or opposite stator pairs (i.e., a total of four U-shaped stators) may be energized at a time, as opposed to one pair of opposite stator pairs (i.e., a total of two U-shaped stators) energized at a time in Option B1. FIG. 52 illustrates eight positions of rotor 2406 at 15 degree increments to show the rotation of rotor 2406.

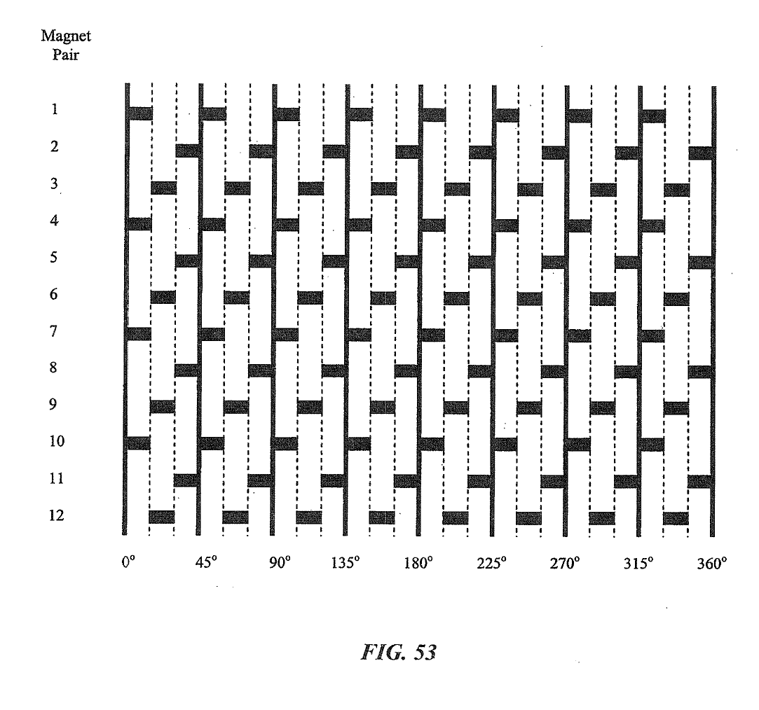

FIG. 53 corresponds to FIG. 52 and illustrates the sequence that each of the 12 U-shaped stator pairs 1-12 is fired throughout the 360 degree rotation of rotor 2406. Each stator pair is on for ⅓ of the time (θₒₙ=0.33333) and that there are 12 stator pairs (nₚₐᵢᵣₛ=12). As shown in FIG. 53, four of the stator pairs are firing at any given time; there are no time periods during which none of the stator pairs are firing (as compared to Option B1).

Because the geometry of Option B2 is similar to that of Option B1 (but with double the number of rotors and stators), the rotor and stator width c for Option B2 may be defined with reference to FIG. 50 as:

$$c = \frac{2 π r}{24} \qquad ( 80 )$$

If the number of stator pairs is halved to six, then the denominator is 12. If number of stator pairs is doubled to 24, then the denominator is 48.

As shown in FIG. 53, there are no gaps in torque, so there is no need to double the number of stators along the length; therefore,

L*=L (81)

The other formulas are identical to Option B1.

Rotor/Stator Configuration Option B3: U-Shaped Blade/U-Shaped Core with All Stators Energized/De-Energized Simultaneously

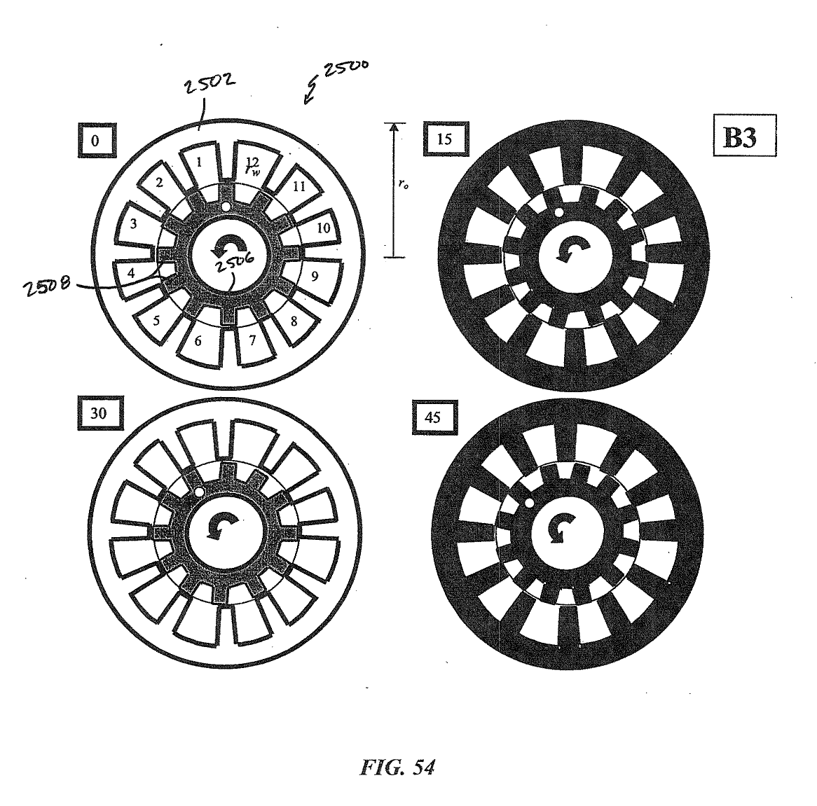

FIG. 54 illustrates rotor/stator configuration Option B3, according to certain embodiments. Option B3 is similar to Option B2, except the number of rotor blades and stator poles pis identical (e.g., 12/12 in the example illustrated embodiment). The rotor/stator configuration 2500 of FIG. 54 includes a stator 2502 with 12 U-shaped stator pairs 1-12 and a rotor 2506 with 12 U-shaped blades 2508. All stator pairs 1-12 are energized and de-energized simultaneously (the energized state is indicated with dark shading) to complete 12 magnetic circuits with the 12 U-shaped blades 2508 (each circuit includes one U-shaped stator and one U-shaped blade). FIG. 54 illustrates four positions of rotor 2506 at 15 degree increments to show the rotation of rotor 2506.

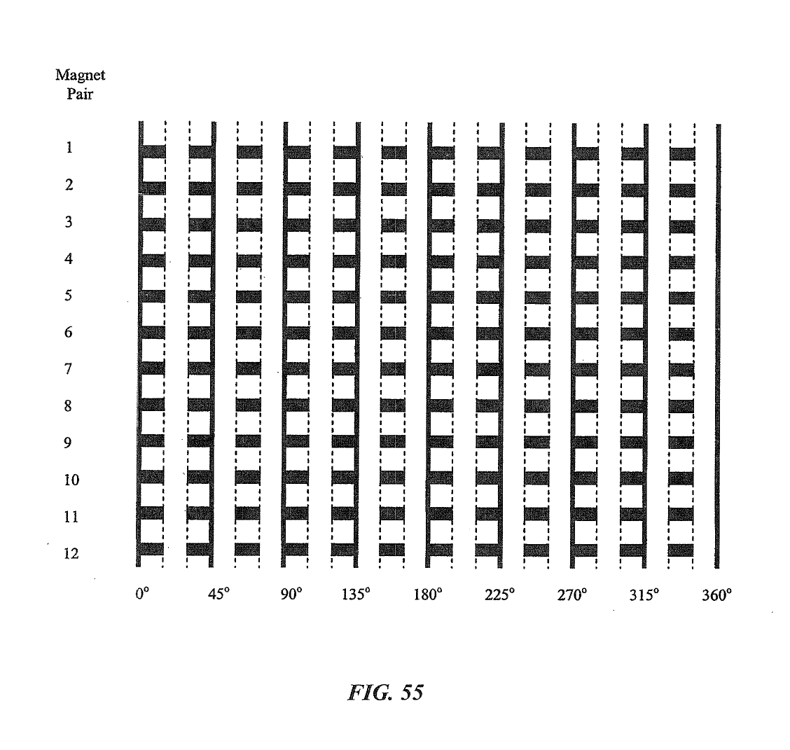

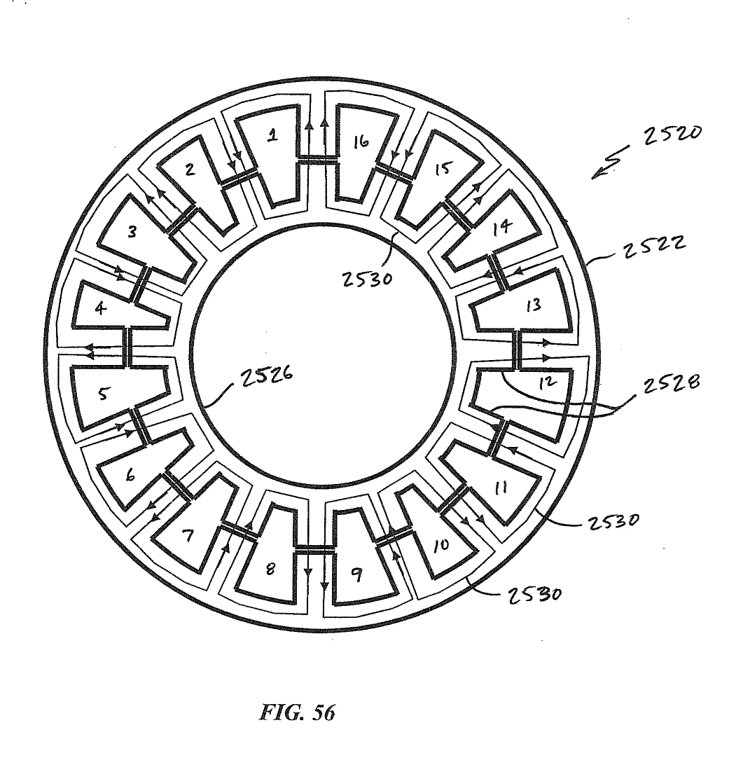

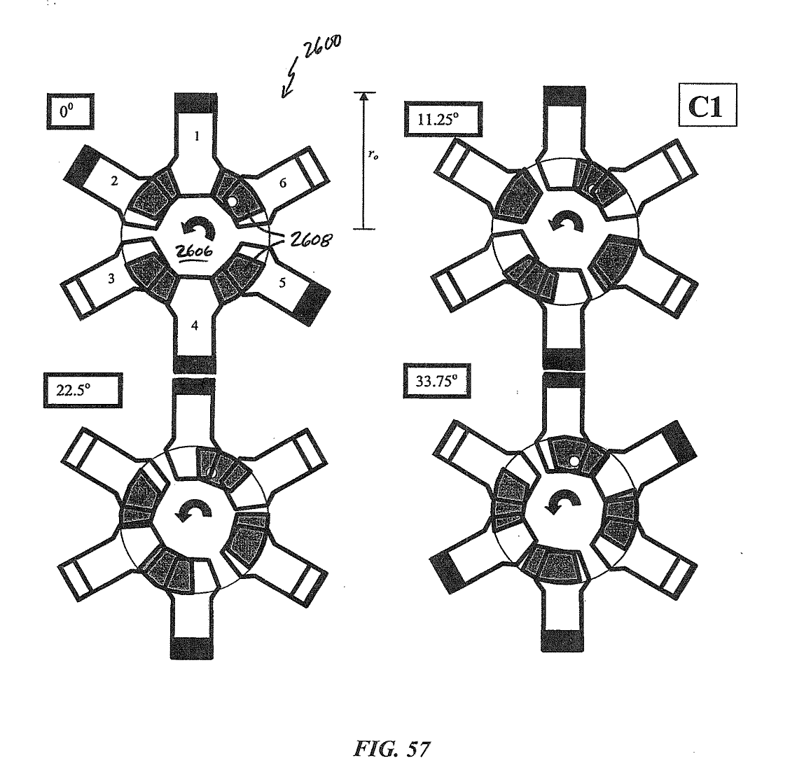

FIG. 55 corresponds to FIG. 54 and illustrates the sequence that each of the 12 U-shaped stator pairs 1-12 is fired throughout the 360 degree rotation of rotor 2506. Each stator pair 1-12 is on for ½ of the time (θₒₙ=0.5) and that there are 12 stator pairs (nₚₐᵢᵣₛ=12).

FIG. 56 illustrates another example rotor/stator configuration 2526 of Option B3, according to certain embodiments. Configuration 2526 is similar to configuration 2520 shown in FIG. 54, except configuration 2526 is a 16/16 configuration (rather than a 12/12 configuration). FIG. 56 illustrates the arrangement of the 16 U-shaped stator pairs such that the all 16 stator pairs can be energized at the same time. Each U-shaped stator pair forms a magnetic circuit with a corresponding U-shaped blade 2528. The flux paths for each of the 16 magnetic circuits are indicated at 2530.

Referring back to the 12/12 configuration shown in FIG. 54, the rotor and stator width c for Option B2 may be defined with reference to FIG. 50 as:

$$c = \frac{2 π r}{24} \qquad ( 82 )$$

If the number of stator pairs is halved to six, then the denominator is 12. If number of stator pairs is doubled to 24, then the denominator is 48. If number of stator pairs is 16 (e.g., the configuration shown in FIG. 56), then the denominator is 32.

As shown in FIG. 55, there are gaps in torque in the Option B3 configurations, and thus for modeling the system, two stators are present along the length L, as compared to one in Option B1; therefore,

L*=½L (83)

The other formulas are identical to Option B1.

### Rotor/Stator Configuration Option C1: Flat Blade/U-Shaped Core

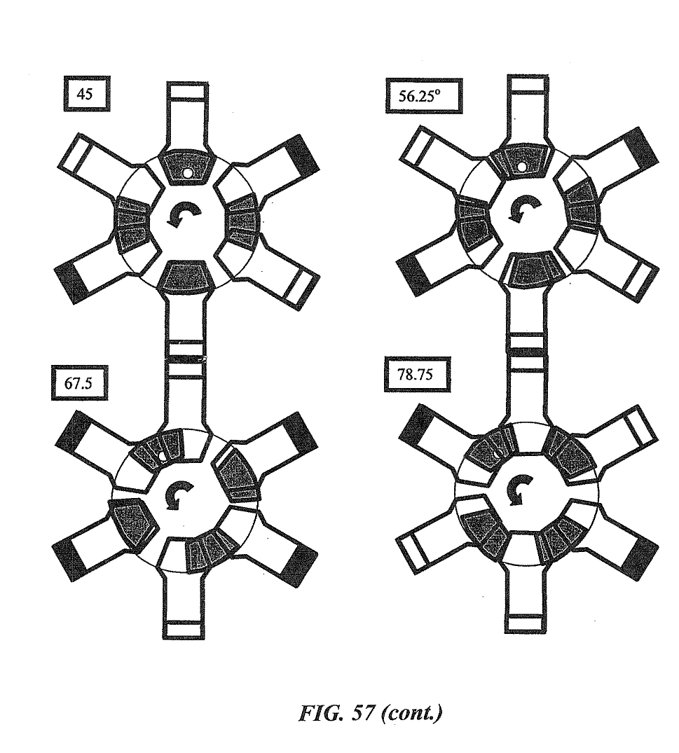

FIG. 57 illustrates rotor/stator configuration Option C1, which is a flat blade/U-shaped core configuration, according to certain embodiments. The illustrated example is a 6/4 configuration. The rotor/stator configuration 2600 includes six U-shaped stator pairs 1-6 and a rotor 2606 with four flat blades 2608. Each U-shaped stator pair includes two legs, and the flat rotor blades 2608 pass through the gap formed between the stator legs, e.g., as shown and discussed above regarding FIGS. 5-13 and 26A. Opposite stator pairs 1-6 are energized sequentially (currently energized stators are indicated with dark shading) and the relevant flat blades 2608 complete the magnetic circuits.

FIG. 57 illustrates eight positions of rotor 2606 at 11.25 degree increments to show the rotation of rotor 2606. In some embodiments, each U-shaped stator pair 1-6 is turned on (i.e., energized) when there is a slight overlap between (a) the leading edge of a flat rotor blade 2608 coming into alignment with that particular stator and (b) the two legs of the particular stator. In some embodiments, each U-shaped stator pair 1-6 is turned off (i.e., de-energized) when the flat blade 2608 is fully aligned between the two legs of the stator (i.e., full closure). As shown, one or two sets of stator pairs 1-6 (i.e., a total of two or four U-shaped stators) are energized at any given time.

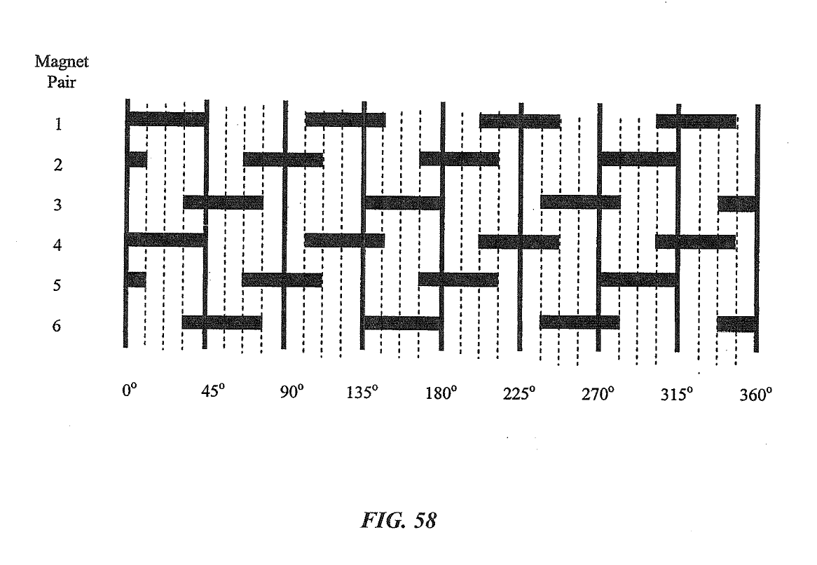

FIG. 58 corresponds to FIG. 57 and illustrates the sequence that each of stator pairs 1-6 is energized throughout the 360 degree rotation of rotor 2606. As shown, one or two sets of stator pairs 1-6 (i.e., a total of 2 or 4 U-shaped stators) are energized at any given time. Each stator pair is on for 4/9 of the time (θₒₙ=0.444) and that there are six stator pairs (nₚₐᵢᵣₛ=6). Notice that there is overlap as the pairs are fired, which will lead to smooth rotation.

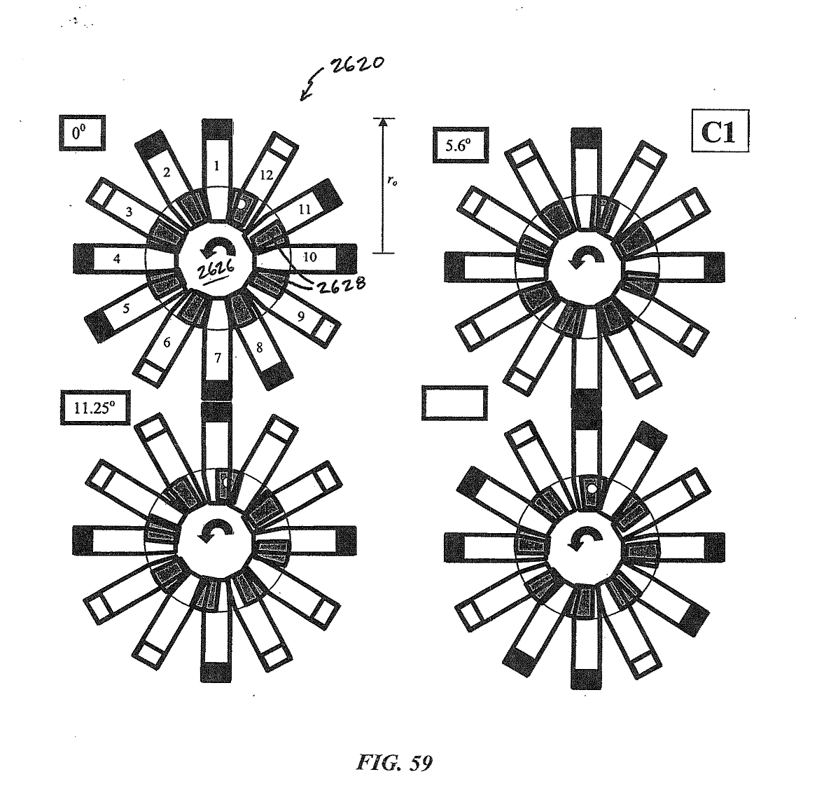

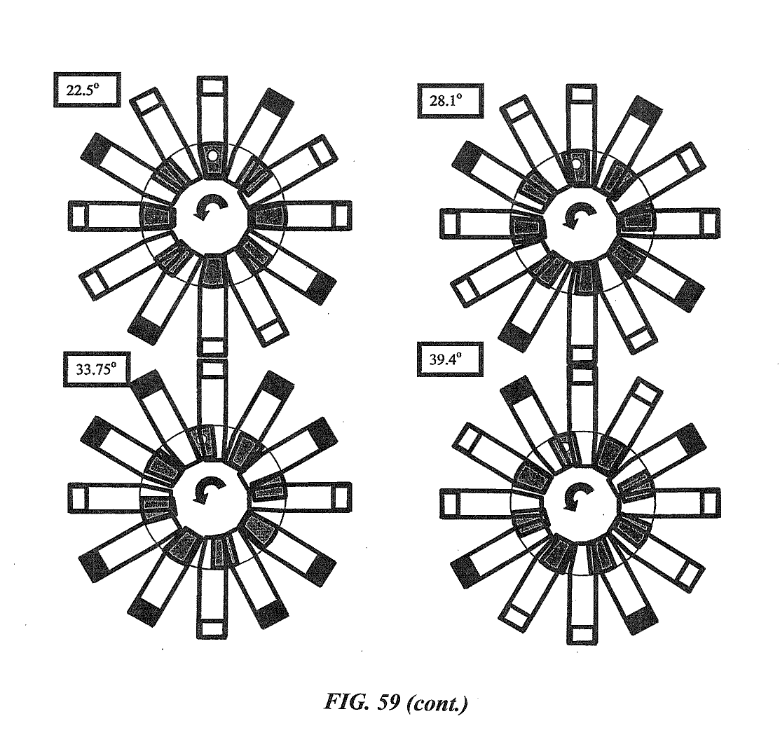

FIG. 59 illustrates another example rotor/stator configuration of Option C1, according to certain embodiments. This example includes a 12/8 configuration 2620 including 12 U-shaped stator pairs 1-12 and a rotor 2626 with eight flat blades 2628. Each U-shaped stator pair includes two legs, and the flat rotor blades 2628 pass through the gap formed between the stator legs, e.g., as shown and discussed above regarding FIGS. 5-13 and 26A. Opposite stator pairs 1-12 are energized sequentially (currently energized stators are indicated with dark shading) and the relevant flat blades 2628 complete the magnetic circuits.

FIG. 59 illustrates eight positions of rotor 2626 at 5.625 degree increments to show the rotation of rotor 2626. In some embodiments, each U-shaped stator pair 1-12 is turned on (i.e., energized) when there is a slight overlap between (a) the leading edge of a flat rotor blade 2628 coming into alignment with that particular stator and (b) the two legs of the particular stator. In some embodiments, each U-shaped stator pair 1-12 is turned off (i.e., de-energized) when the flat blade 2628 is fully aligned between the two legs of the stator (i.e., full closure). As shown, two or four sets of stator pairs 1-12 (i.e., a total of four or eight U-shaped stators) are energized at any given time.

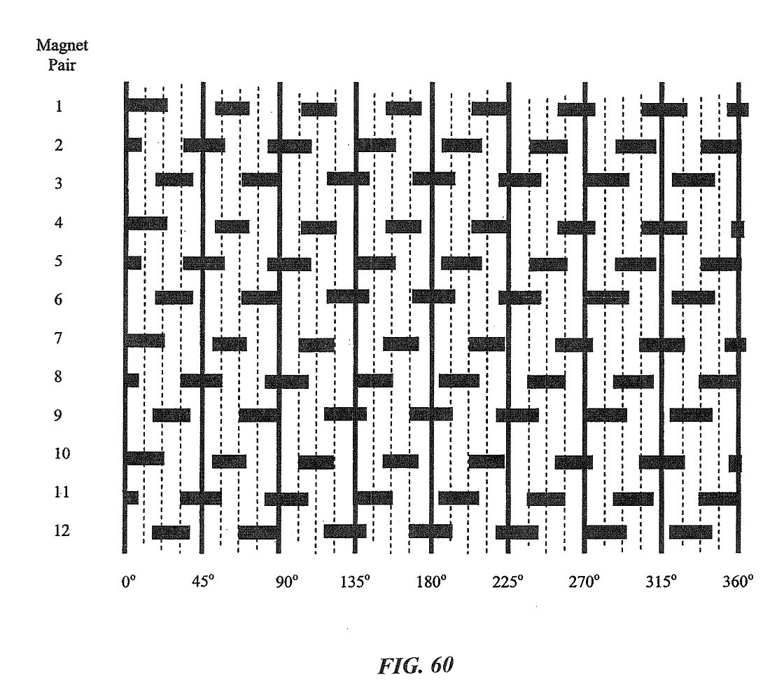

FIG. 60 corresponds to FIG. 58 and illustrates the sequence that each of stator pairs 1-12 is energized throughout the 360 degree rotation of rotor 2626. As shown, two or four sets of stator pairs 1-12 (i.e., a total of 4 or 8 U-shaped stators) are energized at any given time. Each stator pair is on for 4/9 of the time (θₒₙ=0.444) and that there are 12 stator pairs (nₚₐᵢᵣₛ=12). Thus, it can be seen that the fraction of time on (θₒₙ=0.444) for a rotor/stator configuration of Option C1 is the same regardless of the number of stator pairs. This is in sharp contrast to the traditional switched reluctance motor in which the fraction of time on decreases as the number of stator pairs increases.

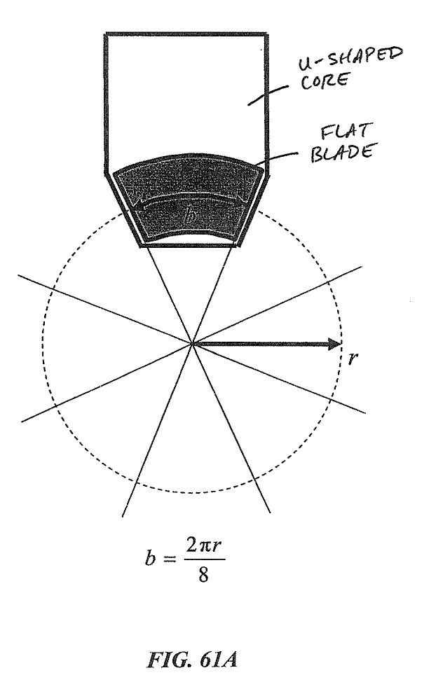

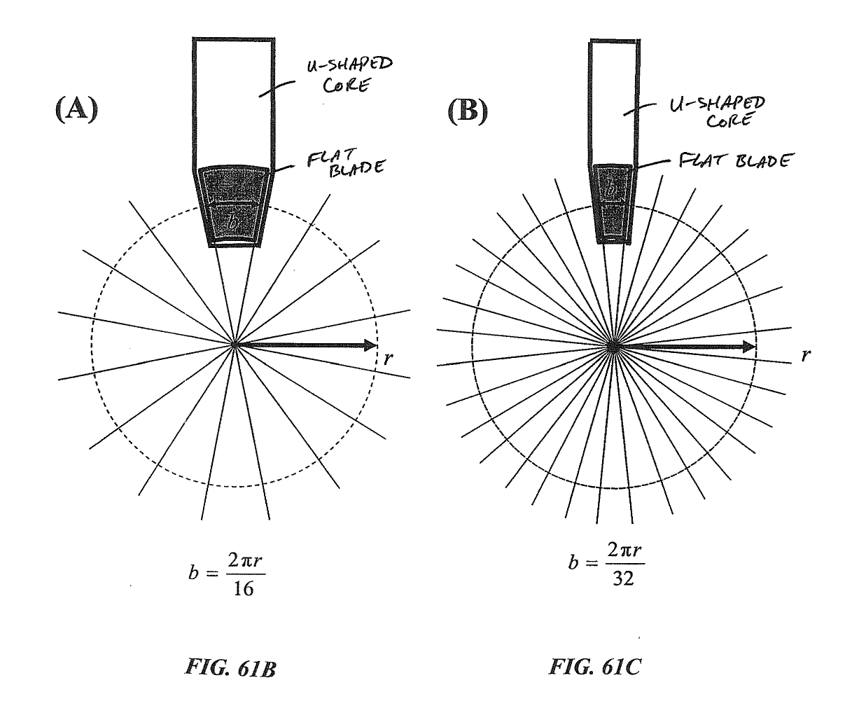

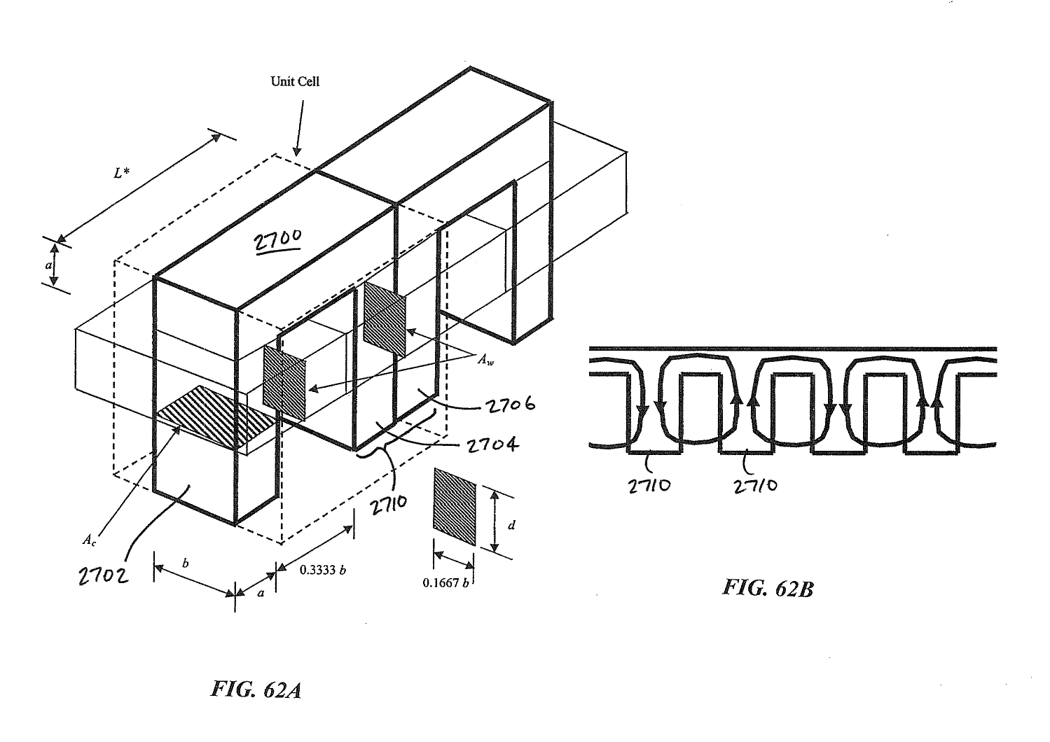

FIGS. 61A-61C illustrate the stator width b for various configurations of the flat blade/U-shaped core of Option C1. As shown in FIG. 61A, for the 6/4 configuration, b is:

$$b = \frac{2 π r}{8} \qquad ( 84 )$$

with a denominator of 8. The denominator for b is 16 for a 12/8 configuration (see FIG. 61B), and 32 for a 24/16 configuration (see FIG. 61C).

FIG. 62A illustrates a “unit cell” for a U-shaped stator 2700 for use in a flat blade/U-shaped core rotor/stator configuration of Option C1. The unit cell includes the wire bundle (coil) needed to provide the magnetomotive force. Notice that a single unit cell including a pair of stator legs 2702 and 2704 services a single flat blade. As the flat blade passes between the magnetic legs 2702 and 2704, there is an attractive force that acts to pull the magnetic legs 2702 and 2704 inward towards the blade. Thus, by mechanically coupling sets of stator pairs together as shown in FIG. 62A, a series of “magnetic legs” 2710 formed from two abutting stator legs (e.g., legs 2704 and 2706) may be created, with the magnetic flux flowing in the same direction through such abutting stator leg pairs, as shown in FIG. 62B. To form a “magnetic leg” 2710, two stator legs (e.g., legs 2704 and 2706) may be abutted and then the coils may be wrapped around the pair of legs. The forces acting on a common magnetic leg 2710 to pull the leg 2710 toward the flat blades on either side of the leg 2710 will act in opposite directions so the net force acting on the magnetic leg 2710 is zero or substantially zero. A net force of zero eliminates movement of the magnetic leg 2710 and thus may eliminate or reduce a source of vibration and noise.

Neglecting edge effects, the area of the core Aᵣ relative to the surface area of the rotor A_{c} at radius r follows:

$$\begin{matrix}\frac{{A}_{c}}{{A}_{r}} = \frac{ab}{( 2 a + 0.333 b ) ( b + 2 ( 0.16667 b ) )} \\ = \frac{ab}{1.33333 b ( 2 a + 0.3333 b )} \\ = \frac{a}{1.33333 ( 2 a + 0.3333 b )} \\ = \frac{a \frac{1}{b}}{1.3333 ( 2 a + 0.3333 b ) \frac{1}{b}} \\ = \frac{\frac{a}{b}}{1.3333 ( 2 a / b + 0.3333 )}\end{matrix} \qquad ( 85 )$$

The core area A_{c} can be calculated as:

$${A}_{c} = ( \frac{{A}_{c}}{{A}_{r}} ) {A}_{r} = ( \frac{\frac{a}{b}}{1.3333 ( 2 a / b + 0.3333 )} ) 2 π {rL}^{*} \qquad ( 86 )$$

where
r=radius of rotor (m)
L*=length of unit cell (m)
   =2a+0.3333 b
      Equation 86 may be substituted into Equation 38:

$$\frac{{T}_{ave}}{V} = \frac{{r}_{f} {n}_{pairs} {θ}_{on}}{π {r}_{0}^{2} {L}^{*}} \frac{g}{{μ}_{o}} {( \frac{{B}_{c , max}}{p} )}^{2} \frac{( \frac{a / b}{1.3333 ( 2 a / b + 0.3333 )} ) 2 π {rL}^{*}}{b} ( \frac{{A}_{g}^{o}}{{A}_{c}} ) = {n}_{pairs} {θ}_{on} \frac{{rr}_{f}}{{r}_{o}^{2}} \frac{g}{{μ}_{o}} {( \frac{{B}_{c , max}}{p} )}^{2} \frac{1}{b} ( \frac{1.5 a / b}{( 2 a / b + 0.3333 )} ) ( \frac{{A}_{g}^{o}}{{A}_{c}} ) \qquad ( 87 )$$

This equation allows the independent specification of A_{g}^{o}/A_{c} and a/b, where p is

$$p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} = \frac{\frac{2 g}{{μ}_{o}}}{( \frac{2 ( r - {r}_{f} ) + 2 d + {L}^{*}}{{μ}_{c}} + \frac{2 g}{{μ}_{o}} + \frac{0.33333 b}{{μ}_{b}} )} \qquad ( 87 a )$$

The value for a is

a=(a/b)b (88)

From the unit cell (FIG. 62):

L*=2a+0.3333b (89)

The radius where the force is applied, r_{f}, is:

$${r}_{f} = r - \frac{{A}_{g}^{o}}{{A}_{c}} \frac{1}{2} a \qquad ( 90 )$$

and rₒ is:

rₒ=r+d+a (91)

From Equation 44, an expression for d follows:

$$d = \frac{{A}_{w}}{0.166667 b} = \frac{1}{0.166667 b} \frac{{B}_{c , max}}{\hat{i} P} \frac{1}{p} \frac{2 g}{{μ}_{o}} \qquad ( 92 )$$

Rotor/Stator Configuration Option C2: Flat Blade/U-Shaped. Core with Reduced Core Width

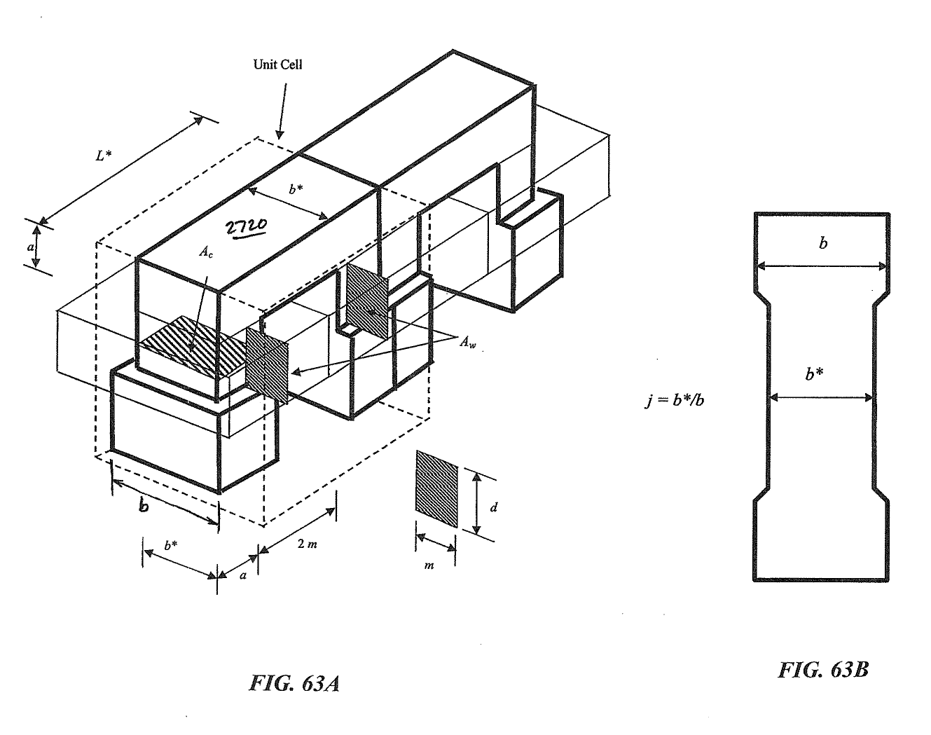

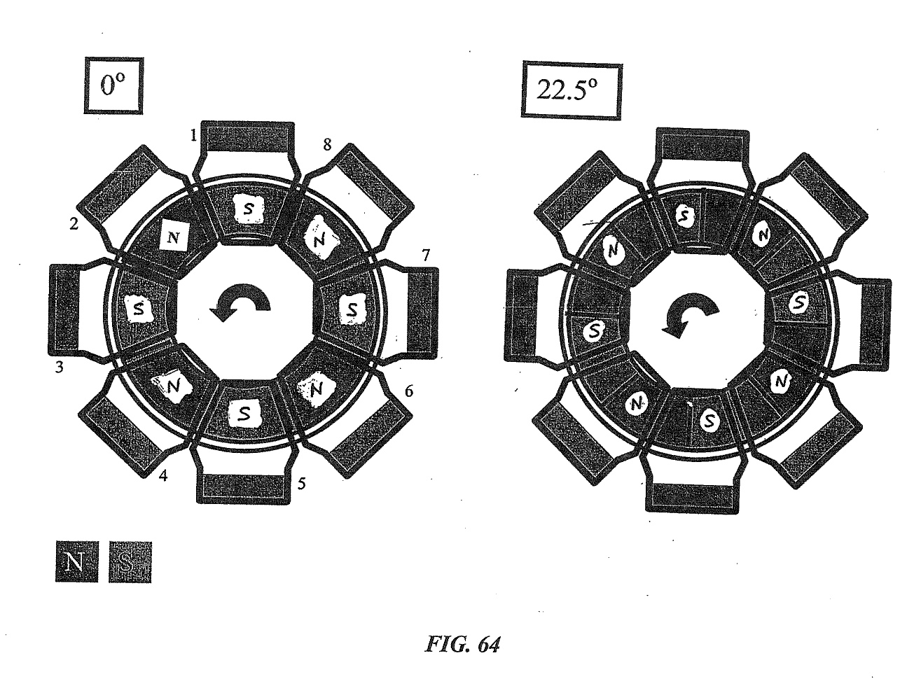

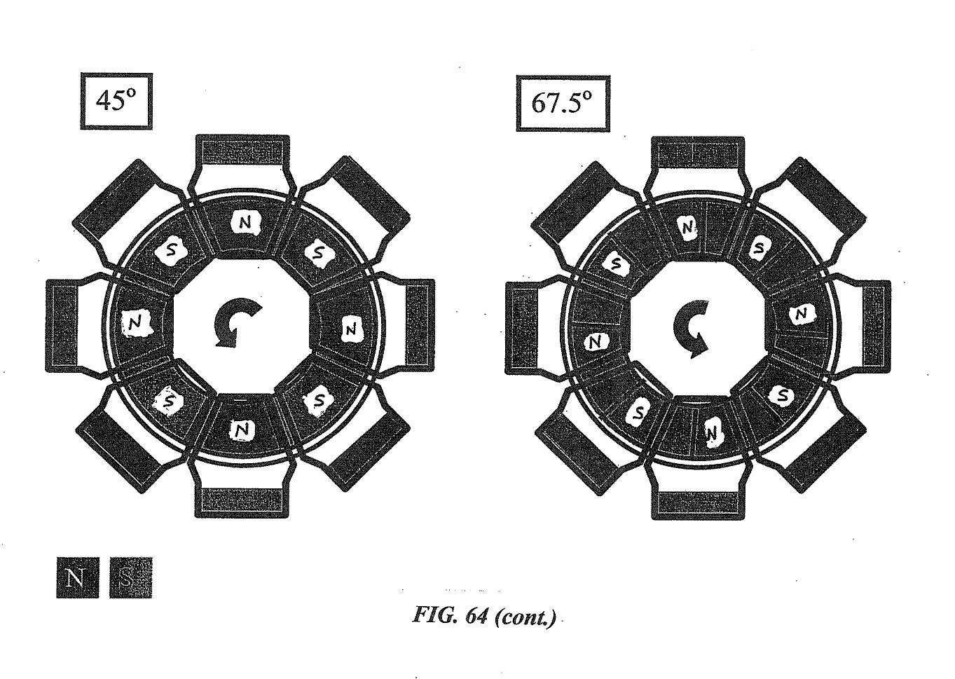

FIGS. 63A and 63B illustrate a configuration Option C2, which is similar to configuration Option C1, except the width of the core is narrowed to b*, according to certain embodiments. FIG. 63A illustrates a “unit cell” for a U-shaped stator pair 2720 of configuration Option C2, and FIG. 63B illustrates a cross-section of the U-shaped stator pair 2720 if the U-shaped stator pair 2720 were laid-out flat.

The ratio j shown in FIG. 63B is defined as follows:

$$j ≡ \frac{{b}^{*}}{b} \qquad ( 93 )$$

FIGS. 61A-61C shows that the stator width b for configuration Option C2 is:

$$b = \frac{2 π r}{8} \qquad ( 94 )$$

with a denominator of 8 for the 6/4 configuration, 16 for a 12/8 configuration, and 32 for a 24/16 configuration. (Note: this is the same as Option C1.)

The width of the wire bundle (coil) is m:

$$m = \frac{1}{6} b + \frac{1}{2} ( b - {b}^{*} ) = \frac{1}{6} b + \frac{1}{2} ( b - jb ) = \frac{1}{6} b + \frac{1}{2} b ( 1 - j ) = [ \frac{1}{6} + \frac{1}{2} ( 1 - j ) ] b \qquad ( 95 )$$

Neglecting edge effects, the area of the core A_{c} relative to the surface area of the rotor Aᵣ at radius r follows:

$$\begin{matrix}\frac{{A}_{c}}{{A}_{r}} = \frac{{ab}^{*}}{[ {b}^{*} + 2 m ] [ 2 a + 2 m ]} \\ = \frac{ajb}{[ jb + 2 m ] [ 2 a + 2 m ]} \\ = \frac{ajb}{[ jb + 2 ( \frac{1}{6} + \frac{1}{2} ( 1 - j ) ) b ] [ 2 a + 2 ( \frac{1}{6} + \frac{1}{2} ( 1 - j ) ) b ]} \\ = \frac{ajb}{[ j + 2 ( \frac{1}{6} + \frac{1}{2} ( 1 - j ) ) b ] [ 2 a + 2 ( \frac{1}{6} + \frac{1}{2} ( 1 - j ) ) b ]} \\ = \frac{aj}{1.3333 [ 2 a + ( 1.3333 - j ) b ]} \\ = \frac{aj \frac{1}{b}}{1.3333 [ 2 a + ( 1.3333 - j ) b ] \frac{1}{b}} \\ = \frac{ja / b}{1.3333 [ 2 a / b + 1.3333 - j ]}\end{matrix} \qquad ( 96 )$$

The core area A_{c} can be calculated as:

$${A}_{c} = ( \frac{{A}_{c}}{{A}_{r}} ) {A}_{r} = ( \frac{ja / b}{1.3333 ( 2 a / b + 1.3333 - j )} ) 2 π {rL}^{*} \qquad ( 97 )$$

where
r=radius of rotor (m)
L*=length of unit cell (m)
   =2a+2m
      Equation 97 may be substituted into Equation 38:

$$\frac{{T}_{ave}}{V} = \frac{{r}_{f} {n}_{pairs} {θ}_{on}}{π {r}_{0}^{2} {L}^{*}} \frac{g}{{μ}_{o}} {( \frac{{B}_{c , max}}{p} )}^{2} \frac{( \frac{ja / b}{1.3333 ( 2 a / b + 1.3333 - j )} ) 2 π {rL}^{*}}{b} ( \frac{{A}_{g}^{o}}{{A}_{c}} ) = {n}_{pairs} {θ}_{on} \frac{{rr}_{f}}{{r}_{o}^{2}} \frac{g}{{μ}_{o}} {( \frac{{B}_{c , max}}{p} )}^{2} \frac{1}{b} ( \frac{1.5 j a / b}{2 a / b + 1.3333 - j} ) ( \frac{{A}_{g}^{o}}{{A}_{c}} ) \qquad ( 98 )$$

This equation allows the independent specification of j, A_{g}^{o}/A_{c} and a/b where p is:

$$p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} = \frac{\frac{2 g}{{μ}_{o}}}{( \frac{2 ( r - {r}_{f} ) + 2 d + {L}^{*}}{{μ}_{c}} + \frac{2 g}{{μ}_{o}} + \frac{2 m}{{μ}_{b}} )} \qquad ( 98 a )$$

The value for a is:

a=(a/b)b (99)

From the unit cell (FIG. 63):

L*=2a+2m (100)

The radius where the force is applied is:

$${r}_{f} = r - \frac{{A}_{g}^{o}}{{A}_{c}} \frac{1}{2} aj \qquad ( 101 )$$

The relationship for rₒ is:

r₀=r+d+a (102)

From Equation 44, an expression for d follows:

$$d = \frac{{A}_{w}}{m} = \frac{1}{m} \frac{{B}_{c , max}}{\hat{i} P} \frac{1}{p} \frac{2 g}{{μ}_{o}} \qquad ( 103 )$$

Rotor/Stator Configuration Option D: Flat Blade/U-Shaped Core with Permanent Magnet Blades

FIG. 64 illustrates rotor/stator configuration Option D, which is a flat blade/U-shaped core configuration 2800 including permanent magnet blades, according to certain embodiments. Option D is generally similar to Option C2, except that permanent magnet flat blades are placed on the rotor in Option D. Thus, a motor formed in accordance with Option D may be referred to as a permanent magnet motor (PMM).

In the example embodiment shown in FIG. 64, the rotor/stator configuration 2800 includes a stator 2802 with eight U-shaped stator pairs 1-8 and a rotor 2806 with six flat permanent magnet blades 2808. Each U-shaped stator pair includes two legs, and the flat permanent magnet blades 2808 pass through the gap formed between the stator legs, e.g., as shown and discussed above regarding FIGS. 5-13 and 26A.

As shown in FIG. 64, the permanent magnet blades 2808 may be positioned around the perimeter of rotor 2806 in alternating arrangement of north (N) and south (S) magnets. At any given time, half of the stator pairs (every other stator pair along the perimeter of stator 2802) are energized with a north (N) polarity, and the other half of the stator pairs are energized with a south (S) polarity. In this manner, the permanent magnet blades 2808 are both pushed and pulled into alignment with the nearest stator pair having the opposite charge, thus causing rotor 2806 to rotate. As rotor 2806 continues to rotate, the polarity of all eight stator pairs is switched simultaneously, back and forth between north (N) and south (S) polarity. FIG. 64 illustrates eight positions of rotor 2806 at 22.5 degree increments to show the rotation of rotor 2806.

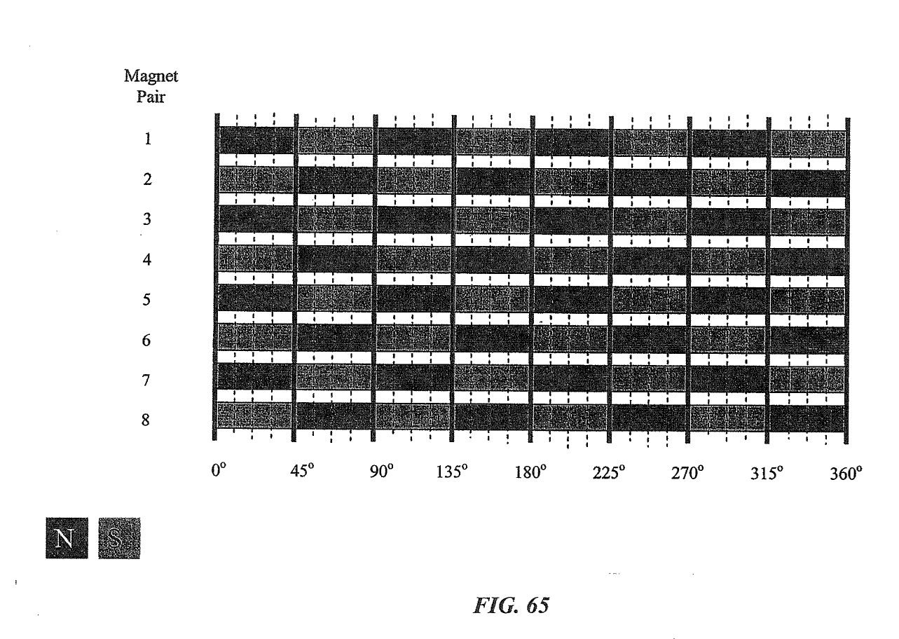

FIG. 65 corresponds to FIG. 57 and the sequence that each of stator pairs 1-8 is energized throughout the 360 degree rotation of rotor 2806. Each stator pair is energized all the time (θₒₙ=1.0), but the magnetic field switches directions.

In some embodiments, the blade magnets need not be particularly strong because an area ratio A_{g}^{o}/A_{c} greater than 1 may be used, which concentrates the flux density in the core. For example, as shown in FIGS. 31 and 32, at an area ratio of 3, the flux density in the blade is about ⅓ that of the flux density in the core. Thus, due to the area ratio advantage, high torque may be generated using relatively low strength magnets for blades 2808. Thus, relatively low strength (and thus relatively inexpensive) magnets (e.g., Alnico magnets) may be used to generate high torque. This class of magnets has the added advantage of very high thermal stability.

With configuration Option D, an equal number of stators and blades can be employed. For example, FIG. 64 shows an 8/8 configuration with nₚₐᵢᵣₛ=8. FIG. 61 shows that the stator width b is:

$$b = \frac{2 π r}{8} \qquad ( 104 )$$

with a denominator of 8 for the 6/6 configuration, 16 for a 16/16 configuration, and 32 for a 32/32 configuration.

Because the stators are adjacent to each other, if multiple stator sets are used in a particular machine, they may be configured as shown in FIG. 63. In particular, the stator legs from one stator set may be abutted directly against the stator legs from an adjacent stator set, and wire coils may be wrapped around the abutted leg pairs. The ratio j is defined as before:

$$j ≡ \frac{{b}^{*}}{b} \qquad ( 105 )$$

The width of the wire bundle is in:

$$m = \frac{1}{2} ( b - {b}^{*} ) = \frac{1}{2} ( b - jb ) = \frac{1}{2} ( 1 - j ) b \qquad ( 106 )$$

Neglecting edge effects, the area of the core A_{c} relative to the surface area of the rotor Aᵣ at radius r follows:

$$\begin{matrix}\frac{{A}_{c}}{{A}_{r}} = \frac{{ab}^{*}}{[ {b}^{*} + 2 m ] [ 2 a + 2 m ]} \\ = \frac{ajb}{[ jb + 2 m ] [ 2 a + 2 m ]} \\ = \frac{ajb}{[ jb + 2 ( \frac{1}{2} ( 1 - j ) ) b ] [ 2 a + 2 ( \frac{1}{2} ( 1 - j ) ) b ]} \\ = \frac{ajb}{[ j + 1 - j ] b [ 2 a + ( 1 - j ) b ]} \\ = \frac{aj}{2 a + ( 1 - j ) b} \\ = \frac{aj \frac{1}{b}}{[ 2 a + ( 1 - j ) b ] \frac{1}{b}} \\ = \frac{ja / b}{2 a / b + 1 - j}\end{matrix} \qquad ( 107 )$$

The core area A_{c} can be calculated as:

$${A}_{c} = ( \frac{{A}_{c}}{{A}_{r}} ) {A}_{r} = ( \frac{ja / b}{2 a / b + 1 - j} ) 2 π {rL}^{*} \qquad ( 108 )$$

where
r=radius of rotor (m)
L*=length of unit cell (m)
   =2a+2m
      Equation 108 may be substituted into Equation 38:

$$\begin{matrix}\frac{{T}_{ave}}{V} = \frac{{r}_{f} {n}_{pairs} {θ}_{on}}{π {r}_{o}^{2} {L}^{*}} \frac{g}{{μ}_{o}} {( \frac{{B}_{c , max}}{p} )}^{2} \frac{( \frac{ja / b}{2 a / b + 1 - j} ) 2 π {rL}^{*}}{b} ( \frac{{A}_{g}^{o}}{{A}_{c}} ) \\ = {n}_{pairs} {θ}_{on} \frac{{rr}_{f}}{{r}_{o}^{2}} \frac{g}{{μ}_{o}} {( \frac{{B}_{c , max}}{p} )}^{2} \frac{1}{b} ( \frac{2 ja / b}{2 a / b + 1 - j} ) ( \frac{{A}_{g}^{o}}{{A}_{c}} )\end{matrix} \qquad ( 109 )$$

This equation allows the independent specification of, j, A_{g}^{o}/A_{c} and a/b. The relationship for p is identical to Option C2. The value for a is

a=(a/b)b (110)

From the unit cell (FIG. 63):

L*=2a+2m (111)

The radius where the force is applied is:

$${r}_{f} = r - \frac{{A}_{g}^{o}}{{A}_{c}} \frac{1}{2} aj \qquad ( 112 )$$

and rₒ is:

r₀=r+d+a (113)

From Equation 44, an expression for d follows:

$$d = \frac{{A}_{w}}{m} = \frac{1}{m} \frac{{B}_{c , max}}{\hat{i} P} \frac{1}{p} \frac{2 g}{{μ}_{o}} \qquad ( 114 )$$

### Sample Calculations

Provided below are sample calculations for determining the torque density and power density generated by various configuration options discussed above, including configuration Options A, B1, B2, B3, C1, C2, and D. The calculations are based on the “unit cell” methodology explained above such that the different configurations can be fairly compared to each other, generally on a torque-per-physical-volume basis or a power-per-physical-volume basis. In addition, the calculations are based on example dimensions and other physical parameter values. It should be understood that these dimensions and other values are examples only and in no way limit the scope of any embodiments to such dimensions or values.

### Option A: Traditional SRM Rotor/Stator Configuration

$$Number stators = 6$$

$${n}_{pairs} = 3$$

$${θ}_{on} = 0.3333$$

$$L / r = 1.0$$

$$c = \frac{2 π r}{12} = \frac{2 π ( 0.5 m )}{12} = 0.262 m$$

$${L}^{*} = L = 0.5 m$$

$$e = {L}^{*} - 2 ( 0.5 c ) = 0.5 m - 2 ( 0.5 ) ( 0.262 m ) = 0.238 m$$

$$e / c = 0.238 m / 0.262 m = 0.908$$

$${r}_{f} = r = 0.5 m$$

$$p = 0.487 ( guess )$$

$$\begin{matrix}d = \frac{1}{0.5 c} \frac{{B}_{c , max}}{\hat{i} P} \frac{1}{p} \frac{2 g}{{μ}_{o}} \\ = \frac{1}{0.5 ( 0.262 m )} \frac{1.8 Wb / {m}^{2}}{( 5.7 \times {10}^{6} A / {m}^{2} ) ( 0.907 )} \\ ( \frac{1}{0.487} ) \frac{2 ( 0.0005 m )}{4 π \times {10}^{- 7} Wb / A \cdot turn \cdot m} \\ = 0.00434 m\end{matrix}$$

$$\begin{matrix}{r}_{o} = r + d + 0.5 c \\ = 0.5 m + 0.00434 m + 0.5 ( 0.262 m ) \\ = 0.635 m\end{matrix}$$

$$\begin{matrix}p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} \\ = \frac{\frac{2 g}{{μ}_{o}}}{( \frac{π {r}_{o} + 2 d}{{μ}_{c}} + \frac{2 g}{{μ}_{o}} + \frac{2 r}{{μ}_{b}} )} \\ = \frac{\frac{2 ( 0.0005 m )}{4 π \times {10}^{- 7} ( Wb / A \cdot turn \cdot m )}}{( \begin{matrix}\frac{π ( 0.635 m ) + 2 ( 0.00434 m )}{0.0036 Wb / A \cdot turn \cdot m} + \\ \frac{2 ( 0.0005 m )}{4 π \times {10}^{- 7} ( Wb / A \cdot turn \cdot m )} + \frac{2 ( 0.5 m )}{0.0036 Wb / A \cdot turn \cdot m}\end{matrix} )} \\ = 0.488\end{matrix}$$

$$\begin{matrix}\frac{{T}_{ave}}{V} = {n}_{pairs} {θ}_{on} \frac{{r}^{2}}{{r}_{o}^{2}} \frac{g}{{μ}_{o}} {( \frac{{B}_{c , max}}{p} )}^{2} \frac{1}{c} \frac{e / c}{2 ( e / c + 1 )} \\ = 3 ( 0.33333 ) \frac{{( 0.5 m )}^{2}}{{( 0.635 m )}^{2}} \frac{( 0.0005 m )}{4 π \times {10}^{- 7} ( Wb / A \cdot turn \cdot m )} \\ {( \frac{1.8 Wb / {m}^{2}}{0.488} )}^{2} \frac{1}{0.262 m} \frac{0.908}{2 ( 0.908 + 1 )} \\ = 3048 N \cdot m / {m}^{3}\end{matrix}$$

### Option B1: U-Shaped Blade/U-Shaped Core Rotor/Stator Configuration

$$Number stators = 12$$

$${n}_{pairs} = 6$$

$${θ}_{on} = 0.16666$$

$$L / r = 1.0$$

$$c = \frac{2 π r}{24} = \frac{2 π ( 0.5 m )}{24} = 0.131 m$$

$$L = ( L / r ) r = ( 1.0 ) 0.5 m = 0.5 m$$

$${L}^{*} = \frac{1}{2} L = \frac{1}{2} ( 0.5 m ) = 0.25 m$$

$$e = {L}^{*} - 2 ( 0.5 c ) = 0.25 m - 2 ( 0.5 ) ( 0.131 m ) = 0.119 m$$

$$e / c = 0.119 m / 0.131 m = 0.908$$

$${r}_{f} = r = 0.5 m$$

$$p = 0.823 ( guess )$$

$$\begin{matrix}d = \frac{1}{0.5 c} \frac{{B}_{c , max}}{\hat{i} P} \frac{1}{p} \frac{2 g}{{μ}_{o}} \\ = \frac{1}{0.5 ( 0.131 m )} \frac{1.8 Wb / {m}^{2}}{( 5.7 \times {10}^{6} A / {m}^{2} ) ( 0.907 )} \\ ( \frac{1}{0.823} ) \frac{2 ( 0.0005 m )}{4 π \times {10}^{- 7} Wb / A \cdot turn \cdot m} \\ = 0.00514 m\end{matrix}$$

$${r}_{o} = r + d + c = 0.5 m + 0.00514 m + 0.131 m = 0.636 m$$

$$\begin{matrix}p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} \\ = \frac{\frac{2 g}{{μ}_{o}}}{( \frac{\frac{2 π {r}_{o}}{{n}_{stators}} + 2 d}{{μ}_{c}} + \frac{2 g}{{μ}_{o}} + \frac{\frac{2 π r}{{n}_{stators}}}{{μ}_{b}} )} \\ = \frac{\frac{2 ( 0.0005 m )}{4 π \times {10}^{- 7} ( Wb / A \cdot turn \cdot m )}}{( \begin{matrix}\frac{\frac{2 π ( 0.636 m )}{12} + 2 ( 0.00513 m )}{0.0036 Wb / A \cdot turn \cdot m} + \\ \frac{2 ( 0.0005 m )}{4 π \times {10}^{- 7} ( Wb / A \cdot turn \cdot m )} + \frac{\frac{2 π ( 0.5 m )}{12}}{0.0036 Wb / A \cdot turn \cdot m}\end{matrix} )} \\ = 0.826\end{matrix}$$

$$\begin{matrix}\frac{{T}_{ave}}{V} = {n}_{pairs} {θ}_{on} \frac{{r}^{2}}{{r}_{o}^{2}} \frac{g}{{μ}_{o}} {( \frac{{B}_{c , max}}{p} )}^{2} \frac{1}{c} \frac{( e / c )}{2 ( e / c + 1 )} \\ = 6 ( 0.16666 ) \frac{{( 0.5 m )}^{2}}{{( 0.636 m )}^{2}} \frac{( 0.0005 m )}{4 π \times {10}^{- 7} ( Wb / A \cdot turn \cdot m )} \\ {( \frac{1.8 Wb / {m}^{2}}{0.826} )}^{2} \frac{1}{0.131 m} \frac{0.908}{2 ( 0.908 + 1 )} \\ = 2126 N \cdot m / {m}^{3}\end{matrix}$$

Option B2: U-Shaped Blade/U-Shaped Core Rotor/Stator Configuration with Double Number of Rotors and Stators

$$Number stators = 12$$

$${n}_{pairs} = 12$$

$${θ}_{on} = 0.3333$$

$$L / r = 1.0$$

$$c = \frac{2 π r}{24} = \frac{2 π ( 0.5 m )}{24} = 0.131 m$$

$$L = ( L / r ) r = ( 1.0 ) 0.5 m = 0.5 m$$

$${L}^{*} = L = 0.5 m$$

$$e = {L}^{*} - 2 ( 0.5 c ) = 0.5 m - 2 ( 0.5 ) ( 0.131 m ) = 0.369 m$$

$$e / c = 0.369 m / 0.131 m = 2.817$$

$${r}_{f} = r = 0.5 m$$

$$p = 0.823 ( guess )$$

$$\begin{matrix}d = \frac{1}{0.5 c} \frac{{B}_{c , max}}{\hat{i} P} \frac{1}{p} \frac{2 g}{{μ}_{o}} \\ = \frac{1}{0.5 ( 0.131 m )} \frac{1.8 Wb / {m}^{2}}{( 5.7 \times {10}^{6} A / {m}^{2} ) ( 0.907 )} \\ ( \frac{1}{0.823} ) \frac{2 ( 0.0005 m )}{4 π \times {10}^{- 7} Wb / A \cdot turn \cdot m} \\ = 0.00514 m\end{matrix}$$

$${r}_{o} = r + d + c = 0.5 m + 0.00514 m + 0.131 m = 0.636 m$$

$$\begin{matrix}p ≡ \frac{\frac{2 g}{{μ}_{o}}}{( \frac{{l}_{c}}{{μ}_{c}} + \frac{2 g}{{μ}_{o}} + \frac{w}{{μ}_{b}} )} \\ = \frac{\frac{2 g}{{μ}_{o}}}{( \frac{\frac{2 π {r}_{o}}{{n}_{stators}} + 2 d}{{μ}_{c}} + \frac{2 g}{{μ}_{o}} + \frac{\frac{2 π r}{{n}_{stators}}}{{μ}_{b}} )} \\ = \frac{( \frac{2 ( 0.0005 m )}{4 π \times {10}^{- 7} ( Wb / A \cdot turn \cdot m )} )}{( \begin{matrix}\frac{\frac{2 π ( 0.636 m )}{12} + 2 ( 0.00513 m )}{0.0036 Wb / A \cdot turn \cdot m} + \\ \frac{2 ( 0.0005 m )}{4 π \times {10}^{- 7} ( Wb / A \cdot turn \cdot m )} + \frac{\frac{2 π ( 0.5 m )}{12}}{0.0036 Wb / A \cdot turn \cdot m}\end{matrix} )} \\ = 0.826\end{matrix}$$

$$\begin{matrix}\frac{{T}_{ave}}{V} = {n}_{pairs} {θ}_{on} \frac{{r}^{2}}{{r}_{o}^{2}} \frac{g}{{μ}_{o}} {( \frac{{B}_{c , max}}{p} )}^{2} \frac{1}{c} \frac{( e / c )}{2 ( e / c + 1 )} \\ = 12 ( 0.3333 ) \frac{{( 0.5 m )}^{2}}{{( 0.636 m )}^{2}} \frac{( 0.0005 m )}{4 π \times {10}^{- 7} ( Wb / A \cdot turn \cdot m )} \\ {( \frac{1.8 Wb / {m}^{2}}{0.826} )}^{2} \frac{1}{0.131 m} \frac{2.817}{2 ( 2.817 + 1 )} \\ = 13 , 182 N \cdot m / {m}^{3}\end{matrix}$$

Option B3: U-Shaped. Blade/U-Shaped Core Rotor/Stator Configuration with All Stators Energized/De-energized Simultaneously

$$Number stators = 12$$

$${n}_{pairs} = 12$$

$${θ}_{on} = 0.5$$

$$L / r = 1.0$$

$$c = \frac{2 π r}{24} = \frac{2 π ( 0.5 m )}{24} = 0.131 m$$

$$L = ( L / r ) r = ( 1.0 ) 0.5 m = 0.5 m$$

$${L}^{*} = \frac{1}{2} L = \frac{1}{2} ( 0.5 m ) = 0.25 m$$

$$e = {L}^{*} - 2 ( 0.5 c ) = 0.25 m - 2 ( 0.5 ) ( 0.131 m ) = 0.119 m$$

$$e / c = 0.119 m / 0.131 m = 0.908$$

$${r}_{f} = r = 0.5 m$$

$$p = 0.823 ( guess )$$

$$\begin{matrix}d = \frac{1}{0.5 c} \frac{{B}_{c , max}}{\hat{i} P} \frac{1}{p} \frac{2 g}{{μ}_{o}} \\ = \frac{1}{0.5 ( 0.131 m )} \frac{1.8 Wb / {m}^{2}}{( 5.7 \times {10}^{6} A / {m}^{2} ) ( 0.907 )} \\ ( \frac{1}{0.823} ) \frac{2 ( 0.0005 m )}{4 π \times {10}^{- 7} Wb / A \cdot turn \cdot m} \\ = 0.00514 m\end{matrix}$$

$${r}_{o} = r + d + c = 0.5 m + 0.00514 m + 0.131 m = 0.636 m$$

$$\begin{matrix}p = \frac{\frac{2 g}{{μ}_{o}}}{( \frac{{l}_{c}}{{μ}_{c}} + \frac{2 g}{{μ}_{o}} + \frac{w}{{μ}_{b}} )} \\ = \frac{\frac{2 g}{{μ}_{o}}}{( \frac{\frac{2 π {r}_{o}}{{n}_{stators}} + 2 d}{{μ}_{c}} + \frac{2 g}{{μ}_{o}} + \frac{\frac{2 π r}{{n}_{stators}}}{{μ}_{b}} )} \\ = \frac{\frac{2 ( 0.0005 m )}{4 π \times {10}^{- 7} ( Wb / A \cdot turn \cdot m )}}{( \begin{matrix}\frac{\frac{2 π ( 0.636 m )}{12} + 2 ( 0.00513 m )}{0.0036 Wb / A \cdot turn \cdot m} + \\ \frac{2 ( 0.0005 m )}{4 π \times {10}^{- 7} ( Wb / A \cdot turn \cdot m )} + \frac{\frac{2 π ( 0.5 m )}{12}}{0.0036 Wb / A \cdot turn \cdot m}\end{matrix} )} \\ = 0.826\end{matrix}$$

$$\begin{matrix}\frac{{T}_{ave}}{V} = {n}_{pairs} {θ}_{on} \frac{{r}^{2}}{{r}_{o}^{2}} \frac{g}{{μ}_{o}} {( \frac{{B}_{c , max}}{p} )}^{2} \frac{1}{c} \frac{( e / c )}{2 ( e / c + 1 )} \\ = 12 ( 0.5 ) \frac{{( 0.5 m )}^{2}}{{( 0.636 m )}^{2}} \frac{( 0.0005 m )}{4 π \times {10}^{- 7} ( Wb / A \cdot turn \cdot m )} \\ {( \frac{1.8 Wb / {m}^{2}}{0.826} )}^{2} \frac{1}{0.131 m} \frac{0.908}{2 ( 0.908 + 1 )} \\ = 12 , 761 N \cdot m / {m}^{3}\end{matrix}$$

### Option C1: Flat Blade/U-Shaped Core Rotor/Stator Configuration

$$Number stators = 24$$

$${n}_{pairs} = 24$$

$${θ}_{on} = 0.4444$$

$$L / r = 4.0$$

$$a / b = 0.5$$

$${A}_{g}^{o} / {A}_{c} = 3$$

$$b = \frac{2 π r}{32} = \frac{2 π r ( 0.5 m )}{32} = 0.0982 m$$

$$a = ( a / b ) b = 0.5 ( 0.0982 m ) = 0.0491 m$$

$${L}^{*} = 2 a + 0.333 b = 2 ( 0.0491 m ) + 0.3333 ( 0.0982 m ) = 0.131 m$$

$${r}_{f} = r - \frac{{A}_{g}^{o}}{{A}_{c}} \frac{1}{2} a = 0.5 m - 3 \frac{1}{2} ( 0.0491 m ) = 0.426 m$$

$$p = 0.895 ( guess )$$

$$\begin{matrix}d = \frac{1}{0.166667 b} \frac{{B}_{c , max}}{\hat{i} P} \frac{1}{p} \frac{2 g}{{μ}_{o}} \\ = \frac{1}{0.166667 ( 0.0982 m )} \frac{1.8 Wb / {m}^{2}}{( 5.7 \times {10}^{6} A / {m}^{2} ) ( 0.907 )} \\ ( \frac{1}{0.895} ) \frac{2 ( 0.0005 m )}{4 π \times {10}^{- 7} Wb / A \cdot turn \cdot m} \\ = 0.0189 m\end{matrix}$$

$${r}_{o} = r + d + a = 0.5 m + 0.0189 m + 0.0491 m = 0.568 m$$

$$\begin{matrix}p = \frac{\frac{2 g}{{μ}_{o}}}{( \frac{{l}_{c}}{{μ}_{c}} + \frac{2 g}{{μ}_{o}} + \frac{w}{{μ}_{b}} )} \\ = \frac{\frac{2 g}{{μ}_{o}}}{( \frac{2 ( r - {r}_{f} ) + 2 d + {L}^{*}}{{μ}_{c}} + \frac{2 g}{{μ}_{o}} + \frac{0.33333 b}{{μ}_{b}} )} \\ = \frac{\frac{2 ( 0.0005 m )}{4 π \times {10}^{- 7} ( Wb / A \cdot turn \cdot m )}}{( \begin{matrix}\frac{2 ( 0.5 - 0.426 m ) + 2 ( 0.0206 m ) + 0.131 m}{0.0036 Wb / A \cdot turn \cdot m} + \\ \frac{2 ( 0.0005 m )}{4 π \times {10}^{- 7} ( Wb / A \cdot turn \cdot m )} + \frac{0.33333 ( 0.0982 m )}{0.0072 Wb / A \cdot turn \cdot m}\end{matrix} )} \\ = 0.895\end{matrix}$$

$$\begin{matrix}\frac{{T}_{ave}}{V} = {n}_{pairs} {θ}_{on} \frac{{rr}_{f}}{{r}_{o}^{2}} \frac{g}{{μ}_{o}} {( \frac{{B}_{c , max}}{p} )}^{2} \frac{1}{b} ( \frac{1.5 a / b}{2 a / b + 0.3333} ) ( \frac{{A}_{g}^{o}}{{A}_{c}} ) \\ = 24 ( 0.44444 ) \frac{( 0.5 m ) ( 0.426 m )}{{( 0.568 m )}^{2}} \\ \frac{0.0005 m}{4 π \times {10}^{- 7} ( Wb / A \cdot turn \cdot m )} {( \frac{1.8 Wb / {m}^{2}}{0.895} )}^{2} \frac{1}{0.0982 m} \\ ( \frac{1.5 ( 0.5 )}{( 2 ( 0.5 ) + 0.3333 )} ) ( 3 ) \\ = 194 , 571 N \cdot m / {m}^{3}\end{matrix}$$

Option C2: Flat Blade/U-Shaped Core Rotor/Stator Configuration with Reduced Core Width

$$Number stators = 24$$

$${n}_{pairs} = 24$$

$${θ}_{on} = 0.4444$$

$$L / r = 4.0$$

$$a / b = 0.5$$

$$j = 0.9$$

$${A}_{g}^{o} / {A}_{c} = 3$$

$$b = \frac{2 π r}{32} = \frac{2 π r ( 0.5 m )}{32} = 0.0982 m$$

$$a = ( a / b ) b = 0.5 ( 0.0982 m ) = 0.0491 m$$

$$\begin{matrix}m = ( 0.16667 + 0.5 ( 1 - j ) ) b \\ = ( 0.16667 + 0.5 ( 1 - 0.9 ) ) 0.0982 m \\ = 0.0213 m\end{matrix}$$

$${L}^{*} = 2 a + 2 m = 2 ( 0.0491 m ) + 2 ( 0.0213 m ) = 0.141 m$$

$${r}_{f} = r - \frac{{A}_{g}^{o}}{{A}_{c}} \frac{1}{2} aj = 0.5 m - 3 \frac{1}{2} ( 0.0491 m ) 0.9 = 0.434 m$$

$$p = 0.90 ( guess )$$

$$\begin{matrix}d = \frac{1}{m} \frac{{B}_{c , max}}{\hat{i} P} \frac{1}{p} \frac{2 g}{{μ}_{o}} \\ = \frac{1}{0.0213 m} \frac{1.8 Wb / {m}^{2}}{( 5.7 \times {10}^{6} A / {m}^{2} ) ( 0.907 )} \\ ( \frac{1}{0.90} ) \frac{2 ( 0.0005 m )}{4 π \times {10}^{- 7} Wb / A \cdot turn \cdot m} \\ = 0.0145 m\end{matrix}$$

$${r}_{o} = r + d + a = ( 0.5 m ) + ( 0.0145 m ) + ( 0.0491 m ) = 0.564 m$$

$$\begin{matrix}p = \frac{\frac{2 g}{{μ}_{o}}}{( \frac{2 ( r - {r}_{f} ) + 2 d + {L}^{*}}{{μ}_{c}} + \frac{2 g}{{μ}_{o}} + \frac{2 m}{{μ}_{b}} )} \\ = \frac{\frac{2 ( 0.0005 m )}{4 π \times {10}^{- 7} ( Wb / A \cdot turn \cdot m )}}{( \begin{matrix}\frac{2 ( 0.5 - 0.434 m ) + 2 ( 0.0151 m ) + 0.141 m}{0.0036 Wb / A \cdot turn \cdot m} + \\ \frac{2 ( 0.0005 m )}{4 π \times {10}^{- 7} ( Wb / A \cdot turn \cdot m )} + \frac{2 ( 0.0213 m )}{0.0072 Wb / A \cdot turn \cdot m}\end{matrix} )} \\ = 0.898\end{matrix}$$

$$\begin{matrix}\frac{{T}_{ave}}{V} = {n}_{pairs} {θ}_{on} \frac{{rr}_{f}}{{r}_{o}^{2}} \frac{g}{{μ}_{o}} {( \frac{{B}_{c , max}}{p} )}^{2} \frac{1}{b} ( \frac{1.5 ja / b}{2 a / b + 1.3333 - j} ) ( \frac{{A}_{g}^{o}}{{A}_{c}} ) \\ = 24 ( 0.44444 ) \frac{( 0.5 m ) ( 0.434 m )}{{( 0.564 m )}^{2}} \frac{0.0005 m}{4 π \times {10}^{- 7} ( Wb / A \cdot turn \cdot m )} \\ {( \frac{1.8 Wb / {m}^{2}}{0.898} )}^{2} \frac{1}{0.0982 m} ( \frac{1.5 ( 0.9 ) ( 0.5 )}{( 2 ( 0.5 ) + 1.3333 - 0.9 )} ) ( 3 ) \\ = 167 , 359 N \cdot m / {m}^{3}\end{matrix}$$

Option D: Flat Blade/U-Shaped Core Rotor/Stator Configuration with Permanent Magnet Blades

$$Number stators = 32$$

$${n}_{pairs} = 32$$

$${θ}_{on} = 1.0$$

$$L / {r}_{o} = 4.0$$

$$a / b = 0.5$$

$$j = 0.9$$

$${A}_{g}^{o} / {A}_{c} = 3$$

$$b = \frac{2 π r}{32} = \frac{2 π ( 0.5 m )}{32} = 0.0982 m$$

$$a = ( a / b ) b = 0.5 ( 0.0982 m ) = 0.0491 m$$

$$m = 0.5 ( 1 - j ) b = 0.5 ( 1 - 0.9 ) 0.0982 m = 0.0491 m$$

$${L}^{*} = 2 a + 2 m = 2 ( 0.0491 m ) + 2 ( 0.0491 m ) = 0.108 m$$

$${r}_{f} = r - \frac{{A}_{g}^{o}}{{A}_{c}} \frac{1}{2} aj = 0.5 m - 3 \frac{1}{2} ( 0.0491 m ) 0.9 = 0.434 m$$

$$p = 0.90 ( guess )$$

$$\begin{matrix}d = \frac{1}{m} \frac{{B}_{c , max}}{\hat{i} P} \frac{1}{p} \frac{2 g}{{μ}_{o}} \\ = \frac{1}{0.00491 m} \frac{1.8 Wb / {m}^{2}}{( 5.7 \times {10}^{6} A / {m}^{2} ) ( 0.907 )} \\ ( \frac{1}{0.90} ) \frac{2 ( 0.0005 m )}{4 π \times {10}^{- 7} Wb / A \cdot turn \cdot m} \\ = 0.0627 m\end{matrix}$$

$${r}_{o} = r + d + a = ( 0.5 m ) + ( 0.0627 m ) + ( 0.0491 m ) = 0.612 m$$

$$\begin{matrix}p = \frac{\frac{2 g}{{μ}_{o}}}{( \frac{2 ( r - {r}_{f} ) + 2 d + {L}^{*}}{{μ}_{c}} + \frac{2 g}{{μ}_{o}} + \frac{2 m}{{μ}_{b}} )} \\ = \frac{\frac{2 ( 0.0005 m )}{4 π \times {10}^{- 7} ( Wb / A \cdot turn \cdot m )}}{( \begin{matrix}\frac{2 ( 0.5 - 0.434 m ) + 2 ( 0.0627 m ) + 0.108 m}{0.0036 Wb / A \cdot turn \cdot m} + \\ \frac{2 ( 0.0005 m )}{4 π \times {10}^{- 7} ( Wb / A \cdot turn \cdot m )} + \frac{2 ( 0.00491 m )}{0.0072 Wb / A \cdot turn \cdot m}\end{matrix} )} \\ = 0.886\end{matrix}$$

$$\begin{matrix}\frac{{T}_{ave}}{V} = {n}_{pairs} {θ}_{on} \frac{{rr}_{f}}{{r}_{o}^{2}} \frac{g}{{μ}_{o}} {( \frac{{B}_{c , max}}{p} )}^{2} \frac{1}{b} ( \frac{1.5 ja / b}{2 a / b + 1.3333 - j} ) ( \frac{{A}_{g}^{o}}{{A}_{c}} ) \\ = 32 ( 1.0 ) \frac{( 0.5 m ) ( 0.434 m )}{{( 0.612 m )}^{2}} \frac{0.0005 m}{4 π \times {10}^{- 7} ( Wb / A \cdot turn \cdot m )} \\ {( \frac{1.8 Wb / {m}^{2}}{0.886} )}^{2} \frac{1}{0.0982 m} ( \frac{1.5 ( 0.9 ) ( 0.5 )}{( 2 ( 0.5 ) + 1.3333 - 0.9 )} ) ( 3 ) \\ = 437 , 839 N \cdot m / {m}^{3}\end{matrix}$$

Tables 1 and 2 summarize the torque density and power density, respectively, resulting from the parametric evaluation of the seven different configurations options. By examining Tables 1 and 2, the following conclusions may be made:
As the aspect ratio L/r increases, the torque and power density increases. This occurs because the unproductive wire wrap at the ends becomes a smaller percentage of the entire device.
As the number of stators increases, the torque and power density increases. This results because the maximum flux density of the core is limited to saturation. Arriving at the maximum flux density over a shorter angular displacement causes the torque to rise.
Option B3>Option B2>Option B1 in terms of power density and torque density. The differences are primarily due to the difference in θₒₙ between these options.
Option A has the advantage of a much larger core area A_{c} than Options B1-B3. This advantage is helpful with a smaller number of stators where Option A is always better than Options B in terms of power density and torque density. With a large number of stators, Options B2 and B3 can overcome Option A.
Compared to Option B3, Options C1 and C2 are more torque and power dense because their area ratio A_{g}^{o}/A_{c} is greater than 1.
In Option A, the product of nₚₐᵢᵣₛθₒₙ=1 regardless of the number of stators; therefore, as the number of stators increases, must decrease. In contrast, with Options C and D, θₒₙ is constant regardless of the number of stators. This advantage dominates at large numbers of stators.
There is an optimal a/b for Options C1 and C2.
There is an optimal j (−0.90) for Option. D. For Option C2, the optimal j is 1.
The permanent magnet (Option D) has the highest torque density because θₒₙ=1 and there are more stator pairs.

TABLE 1
Parametric evaluation of torque density for various motor options.

| Opt | A_{g}^{o}/Ac | L/r | a/b | j | Torque Density (N · m/m³) | | |
|---|---|---|---|---|---|---|---|
| | | | | | 6 Stators | 12 Stators | 24 Stators |
| A | 1 | 1 | — | — | 3,050 | 10,900 | 27,300 |
| | | 4 | | | 5,560 | 13,800 | 30,400 |
| B1 | | 1 | | | impossible | 2,130 | 13,400 |
| | | 4 | | | 833 | 3,880 | 17,000 |
| B2 | | 1 | | | 2,150 | 13,200 | 63,200 |
| | | 4 | | | 3,920 | 16,700 | 70,400 |
| B3 | | 1 | | | impossible | 12,800 | 80,600 |
| | | 4 | | | 5,000 | 23,300 | 102,000 |
| C1 | 3 | >4 | 0.2 | 1 | 8,800 | 38,700 | 158,000 |
| | | | 0.5 | | 6,160 | 41,400 | 195,000 |
| | | | 1.0 | | impossible | 26,500 | 180,000 |
| C2 | | | 0.5 | 0.98 | 6,130 | 40,400 | 189,000 |
| | | | | 0.95 | 6,060 | 38,800 | 181,000 |
| | | | | 0.90 | 5,920 | 36,300 | 167,000 |
| | | | | | 8 Stators | 16 Stators | 32 Stators |
| D | | | | 0.95 | 15,500 | 97,700 | 417,000 |
| | | | | 0.90 | 15,700 | 97,500 | 438,000 |
| | | | | 0.85 | 15,400 | 92,900 | 422,000 |

r = 0.5 m
î = 5.7 × 10⁶ A/m²
μ = 0.0036 Wb/(A · turn · m) @ 1.8 Wb/m²
μ = 0.0072 Wb/(A · turn · m) @ 0.6 Wb/m²
g = 0.0005 m
P = 0.907

TABLE 2
Parametric evaluation of power density for various motor options.

| Opt | A_{g}^{o}/Ac | L/r | a/b | j | Power Density (MW/m³) @ 60 Hz | | |
|---|---|---|---|---|---|---|---|
| | | | | | 6 Stators | 12 Stators | 24 Stators |
| A | 1 | 1 | — | — | 1.14 | 4.11 | 10.3 |
| | | 4 | | | 2.10 | 5.20 | 11.5 |
| B1 | | 1 | | | impossible | 0.803 | 5.05 |
| | | 4 | | | 0.314 | 1.46 | 6.41 |
| B2 | | 1 | | | 0.811 | 4.98 | 23.8 |
| | | 4 | | | 1.48 | 6.30 | 26.5 |
| B3 | | 1 | | | impossible | 4.83 | 30.4 |
| | | 4 | | | 1.88 | 8.78 | 38.5 |
| C1 | 3 | >4 | 0.2 | 1 | 3.32 | 14.6 | 59.6 |
| | | | 0.5 | | 2.32 | 15.6 | 73.5 |
| | | | 1.0 | | impossible | 9.99 | 67.9 |
| C2 | | | 0.5 | 0.98 | 2.31 | 15.2 | 71.3 |
| | | | | 0.95 | 2.28 | 14.6 | 68.2 |
| | | | | 0.90 | 2.23 | 13.7 | 63.0 |
| | | | | | 8 Stators | 16 Stators | 32 Stators |
| D | | | | 0.95 | 5.84 | 36.8 | 157 |
| | | | | 0.90 | 5.92 | 36.8 | 165 |
| | | | | 0.85 | 5.81 | 35.0 | 159 |

r = 0.5 m
î = 5.7 × 10⁶ A/m²
μ = 0.0036 Wb/(A · turn · m) @ 1.8 Wb/m²
μ = 0.0072 Wb/(A · turn · m) @ 0.6 Wb/m²
g = 0.0005 m
P = 0.907

The above description has focused on applying this technology to an electric motor in which electrical energy is converted to rotating shaft power. The concepts may be equally well applied to generators in which rotating shaft power is converted to electrical energy.

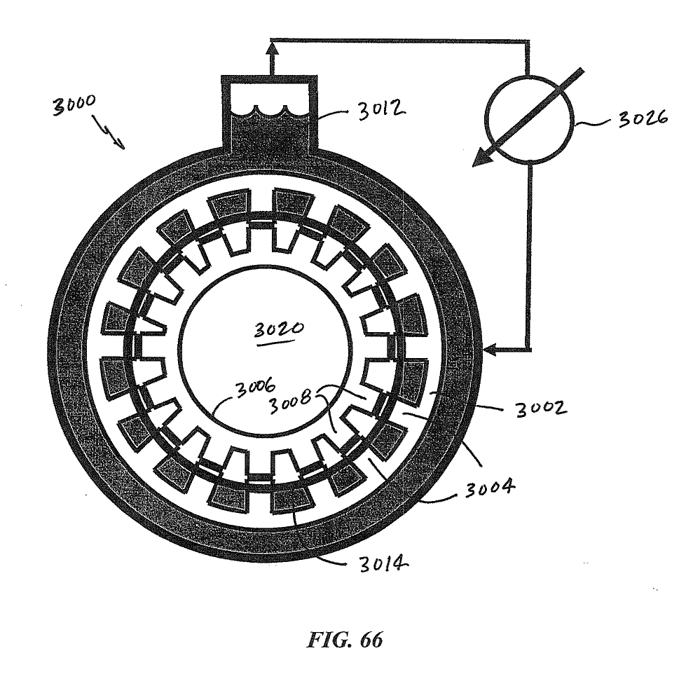

FIG. 66 illustrates an example system for cooling a rotor/stator configuration 3000 (e.g., a switched reluctance motor or a permanent magnet motor), according to certain embodiments. Rotor/stator configuration 3000 may have any configuration disclosed herein (e.g., any of Options A-D) or any other known rotor/stator configuration. Rotor/stator configuration 3000 may include a stator 3002 including a number of stator poles 3004, and a rotor 3006 including a number of rotor poles 3008.

A housing 3010 may be provided for housing a cooling fluid. An end portion of each stator pole leg (or stator pole for conventional SRM configurations) 3004 may extend or pierce through a housing wall 3014 of housing 3010. The interface between each stator pole 3004 and housing wall 3014 may be sealed in any suitable manner to prevent cooling fluid 3012 from escaping housing 3010.

Housing wall 3014 may serve to isolate gases, indicated at 3020, that may have a composition and/or pressure different than the surrounding atmosphere. For example, housing wall 3014 may be used to contain gases that are being compressed or expanded using a gerotor compressor/expander, e.g., as described in any of the following United States Patents and Patent Application Publications: Publication No. 2003/0228237; Publication No. 2003/0215345; Publication No. 2003/0106301; U.S. Pat. No. 6,336,317; and U.S. Pat. No. 6,530,211.

Because thermal energy is typically generated from electrical resistance in the wire bundles, and hysteresis losses in the core, stator 3002 may become overheated. To prevent this possibility, stator poles 3004 may be immersed in a cooling fluid 3012 (e.g., gas and/or liquid), as shown in FIG. 66. Cooling fluid 3012 may comprises an gas and/or liquid suitable for providing heat transfer. In some embodiments, the cooling fluid 3012 may be a heat transfer fluid that is (a) non-electrical-conducting, (b) volatile, and/or (c) compatible with the coatings on the coil wires (i.e., non-dissolving). In some embodiments, cooling fluid 3012 may comprise a known refrigerant.

The thermal energy produced by operation of the device may cause the volatile fluid 3012 to change phase from a liquid to a vapor, which phase change removes thermal energy in the form of latent heat. Because the liquid is boiling, the heat transfer coefficients may be very high, and may thus prevent overheating of stator 3002. In some embodiments, the vapors can be condensed in a heat exchanger 3026, which converts the vapors back into a liquid. In essence, the system is a heat pipe, which is one of the most efficient means for removing heat from systems.

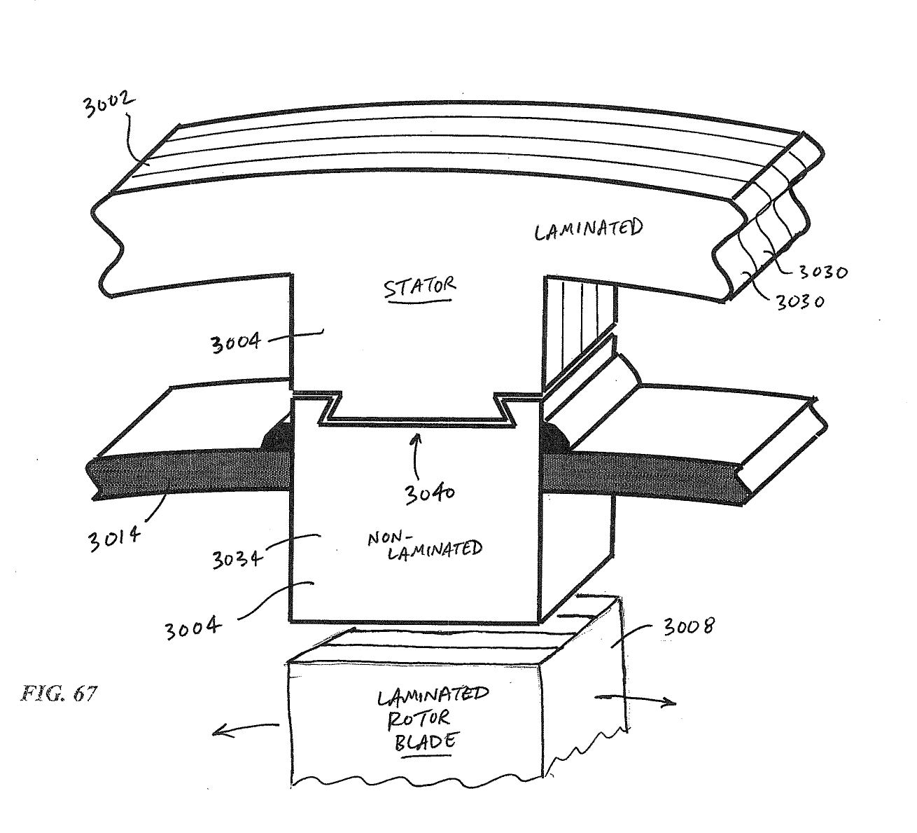

FIG. 67 is a cut away view of a portion of the system of FIG. 66, illustrating a portion of stator 3002 having a stator pole 3004 extending through housing wall 3014, according to certain embodiments. Stator 3002 may have a laminar construction including a number of laminar metal plates 3030. The laminations allow for the efficient conduction of magnetic flux, while limiting electrical eddy currents that lower the efficiency of the system. If the laminar metal of stator 3002 were allowed to pierce through housing wall 3014, the laminate coatings may provide a path through which the gases and/or liquids contained by housing wall 3014 may leak. Thus, as shown in FIG. 67, the portion of the stator pole 3004 that pierces through housing wall 3014 may be constructed on non-laminar material. This non-laminar component of stator pole 3004 is indicated at 3034. In addition, the joint between the non-laminar portion 3034 of stator pole 3004 and housing wall 3014 may be sealed in any suitable manner. For example, the non-laminar portion of stator pole 3004 may be welded to housing wall 3014, which may be formed from a non-magnetic material, e.g., stainless steel.

In addition, the laminar and non-laminar portions of stator pole 3004 may be intimately joined together in any suitable manner to eliminate air gaps that would resist the magnetic flux between the two stator pole components. For example, the two stator pole components may be mechanically joined, e.g., using a dovetail joint 3040 shown in FIG. 67, welded, brazed, or otherwise joined.

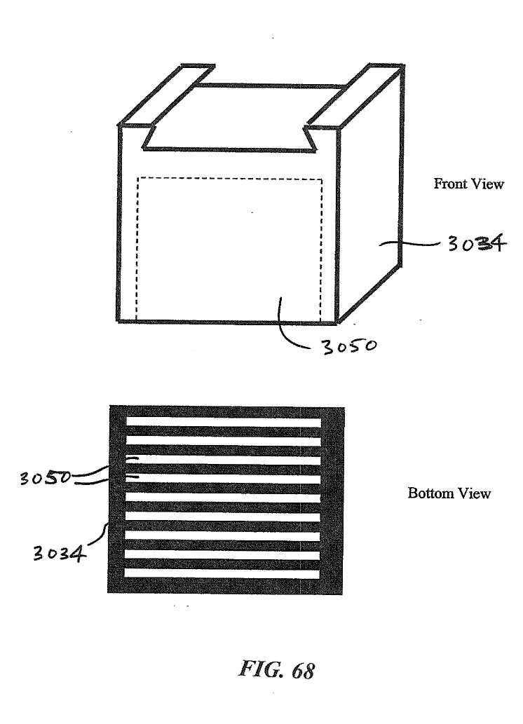

In addition, in some embodiments, as shown in FIG. 68, thin slots 3050 may be formed in the non-laminar component 3034. The slotted portion of component 3034 is indicated in the Front View by the dashed lines. The slots 3050 in non-laminar component 3034 may be aligned in the same direction as the laminations in the laminar portion of stator pole 3004, and may serve the same purpose as the laminations (e.g., to reduce eddy currents). The slot orientation shown in FIG. 68 may be used in various rotor/stator configurations, including, for example, conventional SRM configurations (e.g., configuration Option A) and U-shaped blade/U-shaped core configurations (e.g., configuration Options B1-B3).

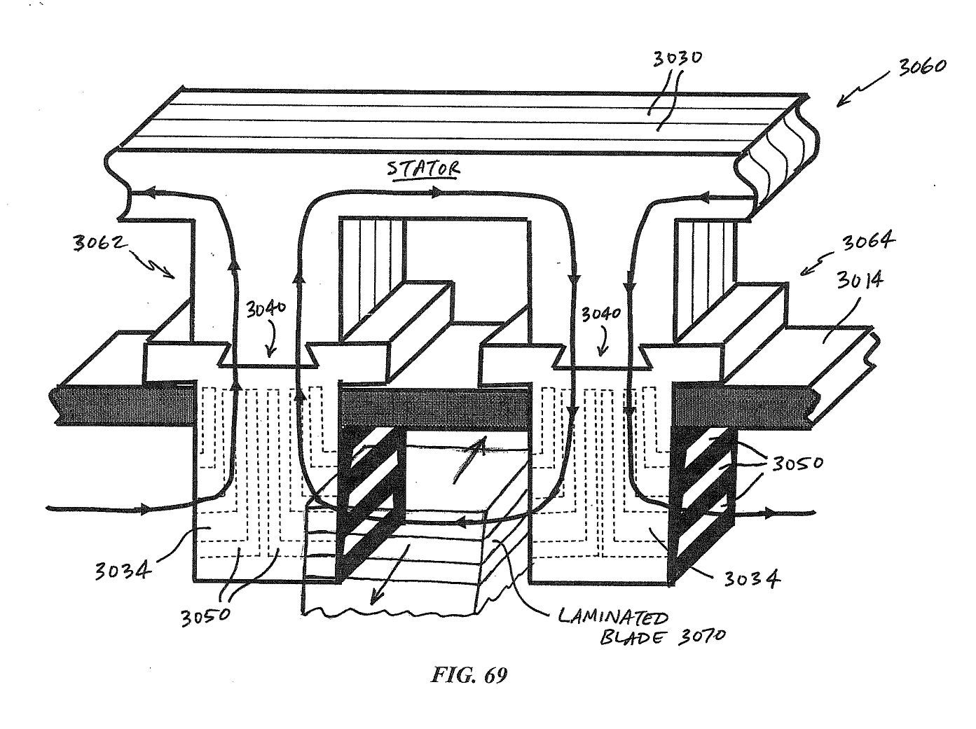

FIG. 69 illustrates an example configuration of a U-shaped stator pair 3060 having two partially-laminar legs 3062 and 3064 extending through housing wall 3014, according to certain embodiments. U-shaped stator pair 3060 is generally laminar, except each leg 3062 and 3064 may include a non-laminar portion 3034 extending through housing wall 3014, e.g., to reduce the possibility of leaks across housing wall 3014, as discussed above regarding FIG. 67. Non-laminar portions 3034 may be connected to laminar portions of stator pair 3060, and to housing wall 3014 in any suitable manner, e.g., as discussed above regarding FIG. 67.

In this configuration, a flat blade 3070 passes between stator legs 3062 and 3064, as discussed above regarding FIGS. 5-13 and 26A. Flat blade 3070 may be laminar in the orientation shown in FIG. 69. Thus, in order to provide a continuous magnetic flux path, non-laminar portions 3034 stator legs 3062 and 3064 may include slots 3050 oriented as shown in FIG. 69. For example, slots 3050 may turn or curve in order to align with both (a) the laminar portions of stator legs 3062 and 3064 and (b) the laminations of flat blade 3070. This slot orientation may be used in various rotor/stator configurations, including, for example, various flat blade/U-shaped core configurations (e.g., configuration Options C1, C2, and D).

The short-flux-path configurations described with reference to the various embodiments herein may be implemented for various SRM motors and/or generators applications by changing the number of stator and rotor poles, sizes, and geometries. Similar configuration may also be utilized for axial-field and linear motors. Several embodiments described herein (e.g., configuration Option D discussed above) may additionally be used for permanent magnet AC machines where the rotor contains alternating permanent magnet poles. Additionally, the embodiments described above may be turned inside out and used as an interior stator SRM or BLDC machines, with the rotor on the outside. These in turn can be used as motor, generators, or both.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. An electric machine, comprising:
a stator having a stator pole including a first leg and a second leg, and a gap defined between the first and second legs; and
a rotor including a rotor pole, the rotor configured to rotate relative to the stator such that the rotor pole rotates through the gap defined between the first and second legs of the stator pole;
wherein the stator pole includes a laminar stator pole structure including multiple lamination layers.

2. An electric machine according to claim 1, wherein:
the shape of the stator pole defines a bend; and
the multiple lamination layers of the laminar stator pole structure extend around the bend defined by the stator pole.

3. An electric machine according to claim 1, wherein:
the rotor rotates relative to the stator generally in a first plane; and
the rotor pole includes a laminar rotor pole structure including lamination layers formed in planes perpendicular to the first plane.

4. An electric machine according to claim 1, wherein:
the rotor pole includes a laminar rotor pole structure including multiple lamination layers; and
the lamination layers of the laminar rotor pole structure are aligned generally parallel with the lamination layers of a first portion of the laminar stator pole structure when the laminar rotor pole structure passes nearby the first portion of the laminar stator pole structure during rotation of the rotor.

5. An electric machine according to claim 1, wherein:
the laminar stator pole structure includes a leg portion and end portion; and
the end portion of the laminar stator pole structure is cut at a non-perpendicular angle such that an exposed area of the end portion is greater than a perpendicular cross-sectional area of the leg portion of the laminar stator pole structure.

6. An electric machine according to claim 1, wherein the laminar stator pole structure is formed by:
wrapping a layer of material around a mandrel multiple times to form a continuous multi-layered structure; and
cutting out a portion of the continuous multi-layered structure to define two legs and a gap between the two legs.

7. An electric machine according to claim 6, wherein the laminar stator pole structure is formed by cutting out a portion of the continuous multi-layered structure at a non-right angle relative to the continuous multi-layered structure proximate the cutting location.

8. An electric machine according to claim 1, wherein:
the stator pole is generally U-shaped including a first leg and a second leg;
the laminar stator pole structure extends along the length of the U-shaped stator pole from an end portion of the first leg to an end portion of the second leg;
proximate an end portion of the first leg, the laminar stator pole structure turns inward toward the end portion of the second leg; and
proximate an end portion of the second leg, the laminar stator pole structure turns inward toward the end portion of the first leg.

9. An electric machine, comprising:
a housing;
a stator having a stator pole including a first leg and a second leg; and
a rotor including a rotor pole, the rotor configured to rotate relative to the stator;
wherein at least one of the stator and the rotor is adjustably coupled to the housing to allow a distance between the stator pole and the rotor pole to be adjusted.

10. An electric machine according to claim 9, wherein the rotor pole comprises a blade configured to rotates through a gap defined between the first and second legs of the stator pole.

11. An electric machine according to claim 9, wherein:
the rotor pole comprises a blade configured to rotates through a gap defined between the first and second legs of the stator pole; and
at least one of the stator and the rotor is adjustably coupled to the housing to allow an area of overlap between the rotor blade and the first and second legs of the stator pole to be adjusted.

12. An electric machine according to claim 9, wherein the stator is adjustably coupled to the housing such that the stator may be adjusted in an axial direction toward or away from a point about which the rotor rotates.

13. An electric machine according to claim 9, wherein:
the stator pole includes a laminar stator pole structure including multiple lamination layers; and
the rotor pole includes a laminar rotor pole structure including multiple lamination layers.

14. An electric machine according to claim 13, wherein:
the rotor rotates relative to the stator generally in a first plane; and
the laminar rotor pole structure includes lamination layers formed in planes perpendicular to the first plane.

15. An electric machine according to claim 13, wherein the lamination layers of the laminar rotor pole structure are aligned generally parallel with the lamination layers of a first portion of the laminar stator pole structure when the laminar rotor pole structure passes nearby the first portion of the laminar stator pole structure during rotation of the rotor.

16. An electric machine, comprising:
a first stator having a first perimeter and a plurality of first stator poles arranged around the first perimeter, each first stator pole including a first leg and a second leg;
a first rotor configured to rotate relative to the first stator around a first axis;
a second stator having a second perimeter and a plurality of second stator poles arranged around the second perimeter, each second stator pole including a first leg and a second leg; and
a second rotor configured to rotate relative to the second stator around the first axis;
wherein the second stator is rotationally offset from the first stator about the first axis such that the second stator poles are offset from the first stator poles.

17. An electric machine according to claim 16, wherein:
the plurality of first stator poles of the first stators are arranged around the first perimeter at intervals of x degrees; and
the second stator is rotationally offset from the first stator about the first axis by x/2 degrees.

18. An electric machine according to claim 16, wherein:
the first rotor includes a plurality of first rotor blades, each first rotor blade including two legs; and
the second rotor includes a plurality of second rotor blades, each second rotor blade including two legs.

19. An electric machine according to claim 16, wherein:
each first stator poles and each second stator pole may be in an energized state or a de-energized state at any given time;
at a particular time instant during the operation of the electric machine, all of the first stator poles are in a de-energized state; and
at the particular time instant, at least one of the second stator poles is in an energized state.

20. An electric machine according to claim 16, wherein:
each first stator poles and each second stator pole may be in an energized state or a de-energized state at any given time;
during first predetermined time intervals:
all of the first stator poles are in a de-energized state; and
at least one of the second stator poles is in an energized state; and
during second predetermined time intervals:
all of the second stator poles are in a de-energized state; and
at least one of the first stator poles is in an energized state.

21. An electric machine, comprising:
a stator having a plurality of stator pairs arranged around a stator perimeter, each stator pair including two legs; and
a rotor having a plurality of rotor blades arranged around a rotor perimeter, each rotor blade including two legs;
wherein the rotor rotates relative to the stator; and
wherein at least three stator pairs are energized simultaneously to generate magnetic circuits with at least three corresponding rotor blades.

22. An electric machine according to claim 21, wherein:
each stator pair is generally U-shaped; and
each rotor blade pair is generally U-shaped.

23. An electric machine according to claim 21, wherein the stator includes at least 12 stator pairs arranged around the stator perimeter.

24. An electric machine according to claim 21, wherein a first stator pair shares a particular leg with an adjacent second stator pair such that the particular leg is used as one of the two legs of the first stator pair and also as one of the two legs of the second stator pair.

25. An electric machine according to claim 21, wherein:
the stator includes a shared leg that is shared between two adjacent stator pairs; and
a wire coil associated with the shared leg is used for energizing the adjacent stator pairs at different times.

26. An electric machine according to claim 21, wherein at least four stator pairs are energized at every instance during a 360 degree rotation of the rotor.

27. An electric machine, comprising:
a stator having a plurality of stator pairs arranged around a stator perimeter, each stator pair including two legs; and
a rotor having a plurality of rotor blades arranged around a rotor perimeter, each rotor blade including two legs;
wherein all of the plurality of stator pairs are energized simultaneously and de-energized simultaneously, in an repeating manner, in order to cause the rotor to rotate relative to the stator.

28. An electric machine according to claim 27, wherein:
each stator pair is generally U-shaped; and
each rotor blade pair is generally U-shaped.

29. An electric machine according to claim 27, wherein the stator includes a plurality of shared legs that are shared between adjacent stator pairs around the stator perimeter.

30. An electric machine according to claim 27, wherein the rotor includes a plurality of shared legs that are shared between adjacent rotor blades around the rotor perimeter.

31. An electric machine according to claim 27, wherein the number of stator pairs is equal to the number of rotor blades.

32. An electric machine according to claim 27, wherein:
the stator comprises an annular portion and a plurality of shared legs extending from the annular portion and spaced equidistant from each other; and
a wire coil is disposed on each of the plurality of shared legs.

33. An electric machine, comprising:
a stator having a plurality of stator pairs, each stator pair including two legs defining a gap between the two legs; and
a rotor having a plurality of rotor blades including a permanent magnet;
wherein the rotor is configured to rotate relative to the stator such that the rotor blade rotate through the gaps between the two legs of each stator pair.

34. An electric machine according to claim 33, wherein the electric machine comprises a permanent magnet motor (PMM).

35. An electric machine according to claim 33, wherein the number of stator pairs is equal to the number of rotor blades.

36. An electric machine according to claim 33, wherein:
each rotor blades includes a permanent magnet having a north or south polarity; and
the plurality of rotor blades are arranged around a rotor perimeter such that the permanent magnets are arranged in an alternating manner between north and south polarity.

37. An electric machine according to claim 33, wherein:
during a first time interval, a first half of the stator pairs are energized with a north polarity and a second half of the stator pairs are energized with a south polarity;
during a second time interval, the first half of the stator pairs are energized with a south polarity and a second half of the stator pairs are energized with a north polarity; and
the first and second time intervals repeat in an alternating manner during operation of the electric machine.

38. An electric machine according to claim 33, wherein the plurality of rotor blades are positioned substantially immediately adjacent each other around a perimeter of the rotor.

39. An electric machine, comprising:
a stator including a stator pole; and
a rotor including a rotor pole, the rotor configured to rotate relative to the stator; and
a housing configured to house a fluid for cooling the stator, the housing including a housing wall;
wherein a first portion of the stator pole projects through the housing wall.

40. An electric machine according to claim 39, wherein the housing wall resists fluid transfer between a stator portion of the electric machine and a rotor portion of the electric machine.

41. An electric machine according to claim 39, wherein an interface between the first portion of stator pole and the housing wall is sealed to resist fluid transfer across the housing wall.

42. An electric machine according to claim 39, wherein:
the stator pole includes a first leg and a second leg; and
each of the first and second legs of the stator pole project through the housing wall.

43. An electric machine according to claim 39, wherein:
a second portion of the stator pole not projecting through the housing wall has a laminar construction having a plurality of layers; and
the first portion of the stator pole projecting through the housing wall has a non-laminar construction.

44. An electric machine according to claim 43, wherein the first portion of the stator pole is coupled to the second portion of the stator pole by at least one of a dovetail joint, a weld, or a braze.

45. An electric machine according to claim 43, further comprising one or more slots formed in the non-laminar first portion of the stator pole projecting through the housing, the slots configured to align with the layers of the laminar second portion of the stator pole.

46. An electric machine according to claim 45, wherein at least one of the slots is non-linear.

47. An electric machine according to claim 45, wherein:
heat generated by the stator boils the fluid in the housing from a liquid to a gas; and
the electric machine further comprises a compressor configured to transfer the gas back to liquid and return the liquid toward the stator.

48. An electric machine, comprising:
a stator having a stator pole; and
a rotor including a rotor pole, the rotor configured to rotate relative to the stator; and
a plurality of slots formed in the stator or the rotor, the plurality of slots configured to reduce eddy currents during operation of the electric machine.

49. An electric machine according to claim 48, wherein the plurality of slots are aligned in parallel.

50. An electric machine according to claim 48, wherein the plurality of slots are arranged to align with multiple layers of an adjacent laminar structure of the stator or the rotor.

51. An electric machine according to claim 48, wherein at least one of the plurality of slots defines a curved or bent path.

52. An electric machine according to claim 48, wherein:
the stator pole includes two legs defining a gap between the two legs;
the rotor pole rotates through the gap between the two legs of the stator pole;
the rotor pole includes a laminar rotor pole structure including multiple layers; and
the plurality of slots are formed in the two legs of the stator pole such that they align with the layers of the laminar rotor pole structure as the rotor pole rotates through the gap between the two legs of the stator pole.

53. An electric machine according to claim 48, wherein:
the stator pole includes two legs defining a gap between the two legs;
the rotor pole rotates through the gap between the two legs of the stator pole; and
the two legs of the stator pole includes a laminar structure including multiple layers; and
the plurality of slots are formed in the rotor pole such that they align with the layers of the laminar structure of the stator pole legs as the rotor pole rotates through the gap between the stator pole legs.
